(19) United States
(12) Patent Application Publication
(10) Pub. No.: US 2026/0226289 A1
(43) Pub. Date: Aug. 6, 2026

(54) OPTICAL ARTICLE, UNDERLAYER FORMING COMPOSITION, AND SURFACE TREATMENT SET

(71) Applicant: AGC Inc., Tokyo (JP)

(72) Inventors: Kumiko SUWA, Tokyo (JP); Yosuke TAKEDA, Tokyo (JP); Shimpei MORITA, Tokyo (JP); Ryohei YAMAGUCHI, Tokyo (JP); Daisuke KOBAYASHI, Tokyo (JP)

(73) Assignee: AGC Inc., Tokyo (JP)

(21) Appl. No.: 19/630,721

(22) Filed: Mar. 27, 2026

Related U.S. Application Data
(63) Continuation of application No. PCT/JP2024/035855, filed on Oct. 7, 2024.

(30) Foreign Application Priority Data
Oct. 6, 2023 (JP) 2023-174763

(51) Int. Cl. C09D 5/16; C03C 17/30; C09D 183/06; C09D 183/16

(52) U.S. Cl. CPC C09D 5/1675; C03C 17/30; C09D 5/1693; C09D 183/06; C09D 183/16; C03C 2217/78; C03C 2218/11

(57) ABSTRACT

An optical article that includes a base, an underlayer, and a surface treatment layer arranged in this order, wherein the underlayer is a layer formed with use of an underlayer forming composition that contains a silane compound other than silica, and the surface treatment layer is a layer formed with use of a surface treatment agent that contains a compound having a chain group and a reactive silyl group.

### CROSS-REFERENCE TO RELATED APPLICATION

This application is a Continuation of International Application No. PCT/JP2024/035855, filed Oct. 7, 2024, which claims priority to Japanese Patent Application No. 2023-174763 filed Oct. 6, 2023. Each of the above applications is hereby expressly incorporated by reference, in its entirety, into the present application.

### TECHNICAL FIELD

The present disclosure relates to an optical article, an underlayer forming composition, and a surface treatment set.

### BACKGROUND ART

In order to improve appearance or performances including visibility, there is a demand in recent years for a technique of making the surface of an article less likely to catch fingerprint, or easy to clean dirt. As specific methods, there is a known method of treating the surface of article, with use of a surface treatment agent.

For example, Patent Document 1 describes an article that includes a base, and a layer formed of a composition that contains a siloxane group-containing silane compound, formed on the base.

### PRIOR ART DOCUMENT

### Patent Document

Patent Document 1: WO 2023/017830 A

### SUMMARY OF THE INVENTION

### Technical Problem

There is a demand for improving liquid repellency of a surface treatment layer formed with use of the surface treatment agent.

The present disclosure has been made in view of such circumstances, in which a problem to be solved by an embodiment of the present invention relates to providing an optical article having a surface treatment layer that excels in abrasion resistance.

Another problem to be solved by an embodiment of the present invention relates to providing an underlayer forming composition used for forming an underlayer, in an optical article having a surface treatment layer that excels in abrasion resistance.

Still another problem to be solved by an embodiment of the present invention relates to providing a surface treatment set that includes an underlayer forming composition used for forming an underlayer, and a surface treatment agent used for forming a surface treatment layer, in an optical article having a surface treatment layer that excels in abrasion resistance.

### Solution to Problem

The present disclosure includes the following aspects.

<1>

An optical article that includes a base, an underlayer, and a surface treatment layer arranged in this order,
wherein the underlayer is a layer formed of an underlayer forming composition that contains a silane compound other than silica, and
the surface treatment layer is a layer formed of a surface treatment agent that contains a compound having a chain group and a reactive silyl group.
   <2>

The optical article according to <1>, wherein the compound having a chain group and a reactive silyl group is a compound having a chain organo(poly)siloxane residue and a reactive silyl group.

<3>

The optical article according to <1> or <2>, wherein the silane compound contains at least one compound A selected from the group consisting of a compound represented by the following formula (1A¹), and a compound having a structure represented by the following formula (1A²):

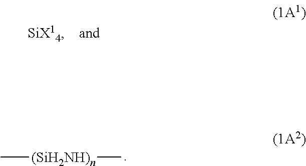

In formula (1A¹), each X¹ independently represents an alkoxy group, an isocyanato group, a halogen atom, a carboxy group, or a hydroxy group.

In formula (1A²), n represents an integer with which the compound will have a number average molecular weight of from 3,000 to 100,000.

<4>

The optical article according to <3>, wherein the silane compound further contains
at least one compound selected from the group consisting of a compound represented by the following formula (2B¹), a compound represented by formula (2B²) below, a compound represented by the following formula (2C¹), a compound represented by the following formula (2C²), and a compound having a structure represented by the following formula (2D):

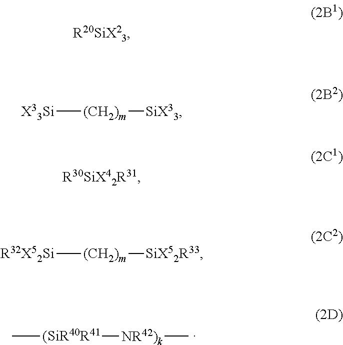

In Formulae (2B¹), (2B²), (2C¹), (2C²), and (2D
each of R²⁰, R³⁰, R³¹, R³², R³³, R⁴⁰, and R⁴¹ independently represents an alkyl group;
each R⁴² independently represents a hydrogen atom or an alkyl group;
each of X², X³, X⁴, and X⁵ independently represents an alkoxy group, an isocyanato group, a halogen atom, a carboxy group, or a hydroxy group; and
each m independently represents an integer of 1 or larger.

In formula (2D), k represents an integer with which the compound will have a number average molecular weight of from 3,000 to 100,000.

<5>

The optical article according to <4>, wherein the silane compound contains the compound A, and at least one compound B selected from the group consisting of the compound represented by formula (2B¹), and the compound represented by formula (2B²), and
the compound B has a ratio of a number of carbon atoms contained in the alkyl group or in an alkylene chain, with respect to a number of silicon atoms, of 1 or less.
   <6>

The optical article according to <5>, wherein a ratio of the number of carbon atoms contained in the alkyl group or in the alkylene chain in the compound B, with respect to a total number of silicon atoms in the compound A and the compound B, is from 0.005 to 0.1.

<7>

The optical article according to any one of <1> to <6>, wherein the base is glass.

<8>

The optical article according to any one of <1> to <7>, being a display or a touch panel.

<9>

An underlayer forming composition that contains a silane compound other than silica, the composition being used for forming an underlayer, in an optical article that includes a base, the underlayer, and a surface treatment layer that contains a compound having a chain group and a reactive silyl group, arranged in this order.

<10>

The underlayer forming composition according to <9>, wherein the compound having a chain group and a reactive silyl group is a compound having a chain organo(poly)siloxane residue and a reactive silyl group.

<11>

The underlayer forming composition according to <9> or <10>, wherein the silane compound contains at least one compound A selected from the group consisting of a compound represented by the following formula (1A¹), and a compound having a structure represented by the following formula (1A²):

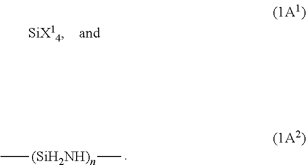

In formula (1A¹), each X¹ independently represents an alkoxy group, an isocyanato group, a halogen atom, a carboxy group, or a hydroxy group.

In formula (1A²), n represents an integer with which the compound will have a number average molecular weight of from 3,000 to 100,000.

<12>

The underlayer forming composition according to <11>, wherein the silane compound further contains at least one compound selected from the group consisting of a compound represented by the following formula (2B¹), a compound represented by the following formula (2B²), a compound represented by the following formula (2C¹), a compound represented by the following formula (2C²), and a compound having a structure represented by the following formula (2D):

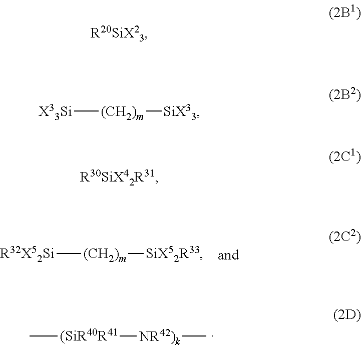

In Formulae (2B¹), (2B²), (2C¹), (2C²), and (2D)
each of R²⁰, R³⁰, R³¹, R³², R³³, R⁴⁰, and R⁴¹ independently represents an alkyl group;
each R⁴² independently represents a hydrogen atom or an alkyl group;
each of X², X³, X⁴, and X⁵ independently represents an alkoxy group, an isocyanato group, a halogen atom, a carboxy group, or a hydroxy group; and
each m independently represents an integer of 1 or larger.

In formula (2D), k represents an integer with which the compound will have an average molar mass of from 3,000 to 100,000.

<13>

The underlayer forming composition according to <12>, wherein the silane compound contains the compound A, and at least one compound B selected from the group consisting of the compound represented by formula (2B¹), and the compound represented by formula (2B²) below, and
the compound B has a ratio of a number of carbon atoms contained in the alkyl group or in an alkylene chain, with respect to a number of silicon atoms, of 1 or less.
   <14>

The underlayer forming composition according to <13>, wherein a ratio of the number of carbon atoms contained in the alkyl group or in the alkylene chain in the compound B, with respect to a total number of silicon atoms in the compound A and the compound B, is from 0.005 to 0.1.

<15>

A surface treatment set, that includes an underlayer forming composition used for forming an underlayer, and a surface treatment agent used for forming a surface treatment layer, in an optical article having a base, the underlayer, and the surface treatment layer arranged in this order,
the underlayer forming composition contains a silane compound other than silica, and
the surface treatment agent contains a compound having a chain group and a reactive silyl group.
   <16>

The surface treatment set according to <15>, wherein the compound having a chain group and a reactive silyl group is a compound having a chain organo(poly)siloxane residue and a reactive silyl group.

<17>

The surface treatment set according to <15> or <16>, wherein the silane compound contains at least one compound A selected from the group consisting of a compound represented by the following formula (1A¹), and a compound having a structure represented by the following formula (1A²):

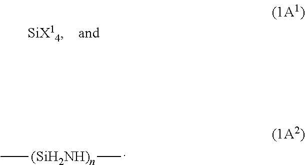

In formula (1A¹), each X¹ independently represents an alkoxy group, an isocyanato group, a halogen atom, a carboxy group, or a hydroxy group.

In formula (1A²), n represents an integer with which the compound will have an average molar mass of from 3,000 to 100,000.

<18>

The surface treatment set according to <17>, wherein the silane compound further contains at least one compound selected from the group consisting of a compound represented by the following formula (2B¹), a compound represented by the following formula (2B²), a compound represented by the following formula (2C¹), a compound represented by the following formula (2C²), and a compound having a structure represented by the following formula (2D):

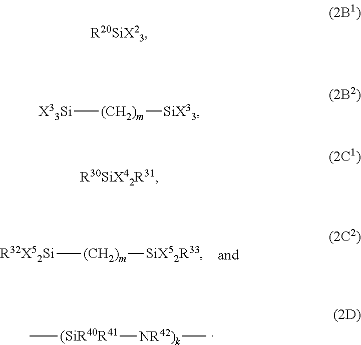

In Formulae (2B¹), (2B²), (2C¹), (2C²), and (2D )
each of R²⁰, R³⁰, R³¹, R³², R³³, R⁴⁰, and R⁴¹ independently represents an alkyl group;
each R⁴² independently represents a hydrogen atom or an alkyl group;
each of X², X³, X⁴, and X⁵ independently represents an alkoxy group, an isocyanato group, a halogen atom, a carboxy group, or a hydroxy group; and
each m independently represents an integer of 1 or larger.

In formula (2D), k represents an integer with which the compound will have an average molar mass of from 3,000 to 100,000.

<19>

The surface treatment set according to <18>, wherein the silane compound contains the compound A, and at least one compound B selected from the group consisting of the compound represented by formula (2B¹), and the compound represented by formula (2B²), and
the compound B has a ratio of a number of carbon atoms contained in the alkyl group or in an alkylene chain, with respect to a number of silicon atoms, of 1 or less.
   <20>>

The surface treatment set according to <19>, wherein a ratio of the number of carbon atoms contained in the alkyl group or in the alkylene chain in the compound B, with respect to a total number of silicon atoms in the compound A and the compound B, is from 0.005 to 0.1.

### Advantageous Effects of Invention

According to an embodiment of the present invention, there is provided an optical article having a surface treatment layer that excels in abrasion resistance.

According to an embodiment of the present invention, there is provided an underlayer forming composition used for forming an underlayer, in an optical article having a surface treatment layer that excels in abrasion resistance.

According to an embodiment of the present invention, there is provided a surface treatment set that includes an underlayer forming composition used for forming an underlayer, and a surface treatment agent used for forming a surface treatment layer, in an optical article having the surface treatment layer that excels in abrasion resistance.

### DESCRIPTION OF EMBODIMENTS

In the present disclosure, each numerical range indicated with use of “to” includes numerical values described before and after “to”, as a minimum value and a maximum value, respectively.

With respect to the numerical ranges described stepwise in the present disclosure, the upper limit value or the lower limit value described in one numerical range may be replaced with the upper limit value or the lower limit value of another numerical range described stepwise. With respect to the numerical ranges described in the present specification, the upper limit value or the lower limit value of such numerical ranges may be replaced with values described in Examples.

In the present disclosure, the “surface treatment layer” refers to a layer formed by surface treatment, on a surface of the base.

In the present disclosure, any compound or group, when represented by a specific formula (X), may be referred to as a compound (X) or a compound X, or, group (X) or group X, respectively.

In the present disclosure, the organo(poly)siloxane residue refers to organosiloxane residue, or organopolysiloxane residue.

In the present disclosure, “Me” occasionally refers to a methyl group, and “Et” occasionally refers to an ethyl group.

### [Optical Article]

The optical article of the present disclosure has the base, the underlayer, and the surface treatment layer arranged in this order, wherein the underlayer is a layer formed with use of the underlayer forming composition that contains a silane compound other than silica, and the surface treatment layer is a layer formed of the surface treatment agent that contains the compound having a chain group and a reactive silyl group.

In one aspect, the optical article of the present disclosure preferably has the base, the underlayer, and the surface treatment layer arranged in this order, wherein the underlayer is a layer formed of the underlayer forming composition that contains a silane compound other than silica, and the surface treatment layer is a layer formed of the surface treatment agent that contains the compound having a chain organo(poly)siloxane residue and a reactive silyl group.

Hereinafter, the compound having a chain group and a reactive silyl group is also referred to as “specific silane compound”, and among which, the compound having a chain organo(poly)siloxane residue and a reactive silyl group is also referred to as “specific silane compound A”. In the present disclosure, the description regarding the specific silane compound also applies to a case where the “specific silane compound” is replaced with the “specific silane compound A”, as long as no contradiction arises.

The optical article of the present disclosure has the surface treatment layer that excels in abrasion resistance.

The reason why such effect is obtainable is presumably, but not definitely, as follows.

The reactive silyl group contained in the surface treatment layer reacts with the silane compound contained in the underlayer, to enhance adhesion between the surface treatment layer and the underlayer, and this presumably improves the abrasion resistance.

On the other hand, there is no description found in Patent Document 1, regarding the underlayer forming composition that contains the silane compound other than silica.

Hereinafter, the individual structures of the optical article of the present disclosure will be described in detail.

The optical article of the present disclosure has the base, the underlayer, and the surface treatment layer, arranged in this order.

Preferred examples of the optical article include those regarding display and the like, as well as a wide variety of optical articles.

Examples of the optical article include displays such as cathode ray tube (CRT; personal computer monitor, for example), liquid crystal display, plasma display, organic EL display, inorganic thin film EL dot matrix display, rear projection-type display, vacuum fluorescent display (VFD), and field emission display (FED); protective plate for these displays; and these displays and protective plate having an antireflection film formed on the surfaces thereof.

Examples of the optical article of the present disclosure include car navigation, mobile phone, smartphone, digital camera, digital video camera, PDA, portable audio player, car audio, game machine, spectacle lens, camera lens, lens filter, sunglasses, medical instrument such as a stomach camera, copy machine, PC, display (liquid crystal display, organic EL display, plasma display, and touch panel display, for example), touch panel, protective film, and antireflection film.

Examples of the optical article of the present disclosure include front protective plate, antireflection plate, polarizing plate, and anti-glare plate for displays such as PDP, LCD and so forth; disc face of optical disc such as Blu-ray (registered trademark) disc, DVD disc, CD-R, or MO; optical fiber; and display face of clock.

In particular, display or touch panel is preferred for the optical article of the present disclosure.

### <Base>

Type of the base is not particularly limited, for example, a base required to have water repellency is exemplified. Examples of the base include, base possibly used in contact with other article (stylus, for example) or human finger; base possibly operated while being held by human fingers; and base possibly placed on other article (stage, for example).

Examples of material for the base include metal, resin, glass, sapphire, ceramic, semiconductor, stone, fiber, nonwoven fabric, paper, wood, fur, natural leather, artificial leather, chinaware, and composite materials thereof. The glass may be chemically strengthened.

For optical use, the material of the base is preferably glass or transparent resin.

Shape of the base may be plate or film.

The base is preferably any of those for touch panel, display, and spectacle lens, wherein touch panel base is particularly preferred. Material of the touch panel base is preferably glass or transparent resin.

For optical use, the material of the base is more preferably glass. The glass may be chemically strengthened.

The base may have one surface or both surfaces subjected to surface treatment such as corona discharge treatment, plasma treatment, or plasma graft polymerization treatment. The base subjected to the surface treatment will have improved adhesion with the underlayer, whereby the surface treatment layer will have improved abrasion resistance. The base is therefore preferably subjected to the surface treatment, on the surface on the side in contact with the underlayer.

### <Underlayer>

The underlayer is a layer formed of the underlayer forming composition that contains the silane compound other than silica.

Hereinafter, components contained in the underlayer forming composition will be described.

### (Silane Compound)

The silane compound other than silica (also simply referred to as “silane compound”, hereinafter) is not particularly limited, as long as it is not silica, and is a silicon atom-containing compound.

The silane compound may be organic silane or inorganic silane (but exclusive of silica).

The silane compound may be a low molecular weight compound having a molecular weight of smaller than 1,000, or may be a high molecular weight compound having a number average molecular weight of 1,000 or larger.

In particular, the silane compound preferably contains at least one compound A selected from the group consisting of a compound represented by formula (1A¹) below, and a compound having a structure represented by formula (1A²) below:

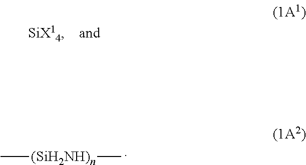

In formula (1A¹), each X¹ independently represents alkoxy group, isocyanato group, halogen atom, carboxy group, or hydroxy group.

In formula (1A²), n represents an integer with which the compound will have a number average molecular weight of from 3,000 to 100,000.

The compound A is highly reactive, and improves, if present in the underlayer forming composition, adhesion between the base and the underlayer, and between the underlayer and the surface treatment layer, thereby improving the abrasion resistance of the surface treatment layer.

In formula (1A¹), the number of carbon atoms in the alkoxy group represented by X¹ is preferably 1 to 4, and more preferably from 1 to 2.

Examples of the alkoxy group include methoxy group and ethoxy group.

Examples of the halogen atom represented by X¹ in formula (1A¹) include fluorine atom, chlorine atom, bromine atom, and iodine atom. Chlorine atom is preferred.

From the viewpoint of the balance between the stability and hydrolyzability of the compound represented by formula (1A¹), X¹ preferably represents an alkoxy group or an isocyanato group.

Examples of the compound represented by formula (1A¹) include tetramethoxysilane, tetraethoxysilane, tetraisocyanatosilane, tetrachlorosilane, and tetrabromosilane.

In the present disclosure, the number average molecular weight is a polystyrene equivalent molecular weight measured by gel permeation chromatography (GPC) with use of tetrahydrofuran as an eluent, according to an analytical curve prepared with use of polystyrene polymers having known molecular weights.

The compound that contains a structure represented by formula (1A²) has a number average molecular weight of from 3,000 to 100,000, and improves, if present in the underlayer forming composition, adhesion between the base and the underlayer, and between the underlayer and the surface treatment layer, thereby improving the abrasion resistance of the surface treatment layer. This is presumably because the silane compound produced from the compound having a structure represented by formula (1A²) excels in balance between the reaction point and the film-forming property, thus promoting a reaction with the reactive silyl group contained in the surface treatment layer, and improving the adhesion between the surface treatment layer and the underlayer.

The underlayer forming composition, if containing the compound represented by formula (1A¹), may contain a hydrolyzate or a hydrolysis-condensation product of the compound represented by formula (1A¹).

The hydrolyzate of the compound represented by formula (1A¹) means a compound in which some or all of the hydrolyzable groups in the compound represented by formula (1A¹) have been hydrolyzed.

The hydrolysis-condensation product of the compound represented by formula (1A¹) means a compound produced by condensation of the hydrolyzate of the compound represented by formula (1A¹), or a compound produced by condensation of the hydrolyzate of the compound represented by formula (1A¹) with other compound.

The underlayer forming composition, if containing the compound including a structure represented by formula (1A²), may contain a hydrolyzate or a hydrolysis-condensation product of the compound including a structure represented by formula (1A²).

The definition of the hydrolyzate and the hydrolysis-condensation product is as described above.

The compound represented by formula (1A¹), and the compound that contains the structure represented by formula (1A²) are labile to hydrolysis in the underlayer forming composition, whose molecular structures in the underlayer forming composition are therefore hardly identified. Hence in the present disclosure, the underlayer forming composition that contains the compound A may alternatively be interpreted as an “underlayer forming composition prepared with use of the compound A”.

In a case where the underlayer forming composition contains the compound A, the surface treatment agent used for forming the surface treatment layer preferably contains a compound, in which the number of Si atoms contained in the chain group is smaller than the number of non-Si atoms that constitute the main chain of the chain group.

In a particular case where the compound A is a compound represented by formula (1A¹) (preferably, tetraethoxysilane), the surface treatment agent preferably contains a compound, in which the number of Si atoms contained in the chain group is smaller than the number of non-Si atoms that constitute the main chain of the chain group.

The main chain of the chain group means a relatively longest binding chain in the compound.

The non-Si atom means atom other than Si atom.

By thus combining the silane compound contained in the underlayer forming composition, with the surface treatment agent used for forming the surface treatment layer, the abrasion resistance of the surface treatment layer will be improved. This enables reduction in the amount addition of any component (compound B, for example) other than the compound A in the underlayer. The underlayer may contain only the compound A.

It is preferred that the silane compound further contains at least one species selected from the group consisting of a compound represented by formula (2B¹) below, a compound represented by formula (2B²) below, a compound represented by formula (2C¹) below, a compound represented by formula (2C²) below, and a compound having a structure represented by formula (2D) below:

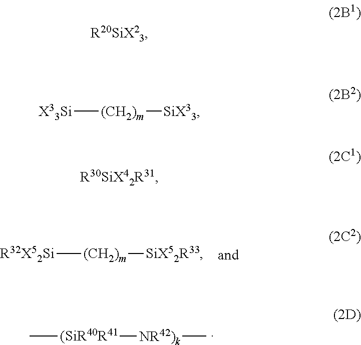

In formulae (2B¹), (2B²), (2C¹), and (2C²),
each of R²⁰, R³⁰, R³¹, R³², R³³, R⁴⁰, and R⁴¹ independently represents an alkyl group;
each R⁴² independently represents a hydrogen atom or an alkyl group;
each of X², X³, X⁴, and X⁵ independently represents alkoxy group, isocyanato group, halogen atom, carboxy group, or hydroxy group; and
each m independently represents an integer of 1 or larger.

In formula (2D), k represents an integer with which the compound will have a number average molecular weight of from 3,000 to 100,000.

The underlayer forming composition that contains, in addition to the compound A, at least one species selected from the group consisting of the compound represented by formula (2B¹), the compound represented by formula (2B²), the compound represented by formula (2C¹), the compound represented by formula (2C²), and the compound having a structure represented by formula (2D), will improve the durability. This is presumably because binding between the reactive silyl group contained in the surface treatment layer, and the silane compound produced from the compound A is further promoted, thereby improving the adhesion between the surface treatment layer and the underlayer.

In formulae (2B¹), (2B²), (2C¹), (2C²), and (2D), the alkyl group represented by R²⁰, R³⁰, R³¹, R³², R³³, R⁴⁰, R⁴¹, and R⁴² may be a linear alkyl group, branched alkyl group, or cycloalkyl group. The alkyl group is preferably a linear alkyl group. The number of carbon atoms in the alkyl group is preferably 1 to 4, and more preferably 1 to 2.

Preferred aspects of the alkoxy group represented by X², X³, X⁴, and X⁵ are the same as the preferred aspects of the alkoxy group represented by X¹.

Preferred aspects of the halogen atom represented by X², X³, X⁴, and X³ are the same as the preferred aspects of the halogen atom represented by X¹.

In formula (2B²), m preferably represents 1 to 10, more preferably 1 to 6, and still more preferably 1 to 2.

In formula (2C²), m preferably represents 1 to 10, more preferably 1 to 6, and still more preferably 1 to 2.

In formula (2D), R⁴² preferably represents a hydrogen atom.

Examples of the compound represented by formula (2B¹) include methyltrimethoxysilane, methyltrichlorosilane, and methyltriethoxysilane.

Examples of the compound represented by formula (2B²) include bistriethoxysilylmethane, bistrimethoxysilylmethane, bistrichlorosilylmethane, bistrimethoxysilylethane, bistrichlorosilylethane, and bistriethoxysilylethane.

Examples of the compound represented by formula (2C¹) include dimethyldimethoxysilane, dimethyldiethoxysilane, and dichlorodimethylsilane.

Examples of the compound represented by formula (2C²) include bis(methyldichlorosilyl)methane, bis(methyldichlorosilyl)ethane, bis(methyldimethoxysilyl)methane, bis(methyldimethoxysilyl)ethane, bis(methyldiethoxysilyl)methane, and bis(methyldiethoxysilyl)ethane.

Examples of the compound having a structure represented by formula (2D) include DURAZANE 1033 from Merck KGaA, and POLY (1,1-DIMETHYLSILAZANE) telomer from Gelest, Inc.

The compound that contains a structure represented by formula (2D) has a number average molecular weight of from 3,000 to 100,000, and improves, if present in the underlayer forming composition, the adhesion between the base and the underlayer, and between the underlayer and the surface treatment layer, thereby improving the abrasion resistance of the surface treatment layer.

The underlayer forming composition, if containing the compound represented by formula (2B¹), may contain a hydrolyzate or a hydrolysis-condensation product of the compound represented by formula (2B¹).

Similarly, the underlayer forming composition may contain a hydrolyzate or a hydrolysis-condensation product of the compound represented by formula (2B²), the compound represented by formula (2C¹), the compound represented by formula (2C²), and the compound that contains a structure represented by formula (2D).

The compound represented by formula (2B¹), the compound represented by formula (2B²), the compound represented by formula (2C¹), the compound represented by formula (2C²), and the compound having a structure represented by formula (2D) are labile to hydrolysis in the underlayer forming composition, whose molecular structures in the underlayer forming composition are therefore hardly identified.

Therefore, in the present disclosure, the underlayer forming composition that contains the compound represented by formula (2B¹), the compound represented by formula (2B²), the compound represented by formula (2C¹), the compound represented by formula (2C²), and the compound that contains the structure represented by formula (2D) may alternatively be interpreted as an “underlayer forming composition prepared with use of the compound represented by formula (2B¹), the compound represented by formula (2B²), the compound represented by formula (2C¹), the compound represented by formula (2C²), and the compound that contains the structure represented by formula (2D)”.

In a case where the underlayer forming composition contains at least one species selected from the group consisting of the compound represented by formula (2B¹), the compound represented by formula (2B²), the compound represented by formula (2C¹), the compound represented by formula (2C²), and the compound that contains the structure represented by formula (2D), the surface treatment agent used for forming the surface treatment layer preferably contains a compound, in which the number of Si atoms contained in the chain group is larger than the number of non-Si atoms that constitute the main chain of the chain group.

In a particular case where the underlayer forming composition contains the compound B, the surface treatment agent preferably contains a compound, in which the number of Si atoms contained in the chain group is larger than the number of non-Si atoms that constitute the main chain of the chain group.

By thus combining the silane compound contained in the underlayer forming composition, with the surface treatment agent used for forming the surface treatment layer, the abrasion resistance of the surface treatment layer will be improved.

In a case where the underlayer forming composition contains at least one species selected from the group consisting of the compound represented by formula (2B¹), the compound represented by formula (2B²), the compound represented by formula (2C¹), the compound represented by formula (2C²), and the compound that contains the structure represented by formula (2D), it is preferred that the underlayer forming composition also contains the compound A. The compound A is preferably a compound represented by formula (1A¹), and more preferably tetraethoxysilane.

From the viewpoint of further improving the abrasion resistance of the surface treatment layer, the silane compound preferably contains the compound A, as well as, at least one compound B selected from the group consisting of the compound represented by formula (2B¹), and the compound represented by formula (2B²), wherein the compound B has a ratio of the number of carbon atoms contained in the alkyl group or in an alkylene chain, with respect to the number of silicon atoms, of 1 or less.

Combination of the compound A and the compound B further improves the adhesion between the surface treatment layer and the underlayer, whereby the abrasion resistance is further enhanced.

If the compound B has a ratio (also referred to as “ratio A”, hereinafter) of the number of carbon atoms contained in the alkyl group or the alkylene chain, to the number of silicon atoms, being 1 or less, the adhesion between the surface treatment layer and the underlayer further improves, whereby the abrasion resistance is further enhanced.

The ratio A is preferably 5 or smaller, more preferably 3 or smaller, and still more preferably 2 or smaller. The lower limit value of the ratio A is not particularly limited, and is 0.1 or 0.3, for example.

For example, each of methyltrimethoxysilane and methyltriethoxysilane has a ratio A of 1.
Bis(triethoxysilyl)ethane has a ratio A of 1.
Bis(triethoxysilyl)methane has a ratio A of 0.5.

In a case where the silane compound contains the compound A and the compound B, the ratio of the number of carbon atoms contained in the alkyl group or in the alkylene chain in the compound B, with respect to the total number of silicon atoms in the compound A and the compound B, is preferably from 0.005 to 0.1.

If the compound B has a ratio (also referred to as “ratio B”, hereinafter) of the number of carbon atoms contained in the alkyl group or the alkylene chain, to the total number of silicon atoms in the compound A and the compound B, being from 0.005 to 0.1, the adhesion between the surface treatment layer and the underlayer further improves, whereby the abrasion resistance is further enhanced.

The ratio B is preferably from 0.005 to 0.1, and more preferably from 0.01 to 0.1.

In a particular case where the compound B is methyltrimethoxysilane, the ratio B is preferably from 0.01 to 0.05.

In a case where the compound B is bistriethoxysilylmethane, the ratio B is preferably from 0.03 to 0.08.

In a case where the compound B is bistriethoxysilylethane, the ratio B is preferably from 0.03 to 0.07.

The content of the silane compound, with respect to the total amount of the underlayer forming composition, is preferably from 0.01 to 20 mass %, and more preferably from 0.1 to 10 mass %.

Types and contents of the silane compound contained in the underlayer forming composition can be analyzed by thermal desorption spectrometry (TDS), time-of-flight secondary ion mass spectrometry (TOF-SIMS), X-ray photoelectron spectroscopy (XPS), nuclear magnetic resonance spectroscopy (NMR), or the like.

### (Liquid Medium)

The underlayer forming composition preferably contains a liquid medium, besides the silane compound.

Examples of the liquid medium include those equivalent to the liquid medium that may be contained in the surface treatment agent described later.

The content of the liquid medium, with respect to the total amount of the underlayer forming composition, is preferably from 80 to 99.99 mass %, and more preferably from 90 to 99.9 mass %.

### (Other Components)

The underlayer forming composition may contain other components besides the silane compound, as long as the effects of the present disclosure are not impaired.

The underlayer forming composition may contain a catalyst, in order to promote condensation among hydrolyzates of the underlayer forming composition. The catalyst may be any of acid catalyst, alkali catalyst, amine catalyst, and metal complex catalyst. Examples of the acid catalyst include hydrochloric acid, nitric acid, acetic acid, sulfuric acid, phosphoric acid, sulfonic acid, methanesulfonic acid, and p-toluenesulfonic acid. Examples of the alkali catalyst include sodium hydroxide, potassium hydroxide, and ammonia. Examples of the amine catalyst include methylamine, dimethylamine, trimethylamine, and tetramethylhexanediamine. Examples of the metal complex catalyst include acetylacetonate complexes of Ni, Pt, Pd, Al, and Rh. The underlayer forming composition may contain water necessary for hydrolysis, as a result of use of the catalyst in an aqueous solution. The content of water is preferably from 1 to 50 mass %, with respect to the total amount of Si of the compound A and the compound B. The content of the catalyst is preferably from 0.01 to 5 mass %, with respect to the total amount of Si in the compound A and the compound B.

### (Method of Forming Underlayer)

The underlayer is preferably formed on the base, by wet coating with use of the underlayer forming composition.

Specific examples of the wet coating for forming the underlayer include spin coating, wipe coating, spray coating, squeegee coating, dip coating, die coating, inkjet method, flow coating, roll coating, casting, the Langmuir-Blodgett method, and gravure coating.

The wet coating of the underlayer forming composition is preferably followed by drying of a coated film. Drying temperature of the coated film is preferably 20 to 200° C., and more preferably 80 to 160° C.

### <Surface Treatment Layer>

The surface treatment layer may be formed on a part of the surface of the underlayer, or over the entire surface of the underlayer. The surface treatment layer may spread like a film over the surface of the underlayer, or may be scattered like dots.

In the surface treatment layer, the compound having a chain group and a reactive silyl group is contained, with the reactive silyl group partially or entirely hydrolyzed, and with the silanol group dehydrated and condensed.

The thickness of the surface treatment layer is preferably 1 to 100 nm, and more preferably 1 to 50 nm. With the thickness of the surface treatment layer being 1 nm or more, a sufficient effect of the surface treatment will be obtainable. With the thickness of the surface treatment layer being 100 nm or less, the utilization efficiency will be high. The thickness of the surface treatment layer can be calculated from an oscillation period of an interference pattern of the reflected X-ray, obtainable by X-ray reflectometry with use of an X-ray diffractometer for thin film analysis (Model “ATX-G”, from Rigaku Corporation).

### (Surface Treatment Agent)

The surface treatment layer is a layer formed of the surface treatment agent that contains a compound (specific silane compound) having a chain group and a reactive silyl group.

Hereinafter, the individual components contained in the surface treatment agent will be described in detail.

### <Specific Silane Compound>

The specific silane compound has a chain group and a reactive silyl group. The specific silane compound A has a chain organo(poly)siloxane residue and a reactive silyl group. The composition of the present disclosure may contain only one kind of specific silane compound, or two or more kinds thereof.

### (Chain Group)

The specific silane compound contains a chain group. The chain group may be linear without branching, or may contain branching. The specific silane compound may have, but not necessarily, any other structure such as a cyclic structure, as long as the chain group is contained.

The chain group is not particularly limited as long as it has a chain structure in which two or more atoms are linked, and examples thereof include chain hydrocarbon group; chain organo(poly)siloxane residue; group having at least one species selected from the group consisting of —O—, —S—, —C(═O)NH—, —NHC(═O)—, —N(R^{d})—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and phenylene group, at a terminal or between the carbon-carbon atoms in the chain hydrocarbon group; and combinations thereof. R^{d} represents a hydrogen atom or an alkyl group (preferably having 1 to 10 carbon atoms).

Examples of the chain hydrocarbon group include linear or branched chain hydrocarbon groups having 2 to 100, preferably 5 to 90, and more preferably 10 to 80 carbon atoms. The chain hydrocarbon group is preferably alkylene group, and more preferably alkylene group having the aforementioned number of carbon atoms. From the viewpoint of forming the surface treatment layer that excels in acid resistance, hot water resistance, abrasion resistance, and the like, the chain hydrocarbon group is preferably alkylene group having 13 or more carbon atoms.

The same will apply to the number of carbon atoms of the group having at least one species selected from the group consisting of —O—, —S—, —C(═O)NH—, —NHC(═O)—, —N(R^{d})—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and phenylene group, at a terminal or between the carbon-carbon atoms in the chain hydrocarbon group. R^{d} represents a hydrogen atom or an alkyl group (preferably having 1 to 10 carbon atoms).

In one aspect, the chain group is preferably a chain organo(poly)siloxane residue. Hereinafter, the chain organo(poly)siloxane residue will be described in detail.

### (Chain Organo(Poly)Siloxane Residue)

The specific silane compound may contain one, or two or more chain organo(poly)siloxane residues. In a case where the specific silane compound contains two or more chain organo(poly)siloxane residues, such two or more chain organo(poly)siloxane residues may be the same or different.

Examples of the chain organo(poly)siloxane residue include a chain organo(poly)siloxane residue represented by formula (B1) or (B2) below:

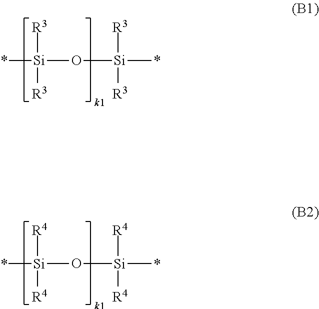

In formula (B1),
each R³ independently represents a hydrocarbon group;
k1 represents a number of 1 or larger; and
* indicates a binding site with a neighboring atom.

In formula (B2),
each R⁴ independently represents a hydrocarbon group or T¹¹-Bᵣ—(SiR³₂—O)ₖ₁—;
each T¹¹ independently represents a monovalent group;
each B independently represents —O— or —C(═O)—;
each r independently represents 0 or 1,
each R³ independently represents a hydrocarbon group;
each k1 independently represents a number of 1 or larger; and
* indicates a binding site with a neighboring atom.

In formulae (B¹) and (B²), examples of the hydrocarbon group represented by R³ include aliphatic hydrocarbon group and aromatic hydrocarbon group. In particular, the hydrocarbon group is preferably aliphatic hydrocarbon group, and more preferably alkyl group. The alkyl group may be any of linear alkyl group, branched alkyl group, or cycloalkyl group. Linear alkyl group is preferred; methyl group, ethyl group, n-propyl group, or n-butyl group is more preferred; and methyl group is still more preferred. The aromatic hydrocarbon group is preferably phenyl group.

In formulae (B¹) and (B²), k1 represents a number of 1 or larger, which is preferably 1 to 600, more preferably 1 to 500, still more preferably 3 to 500, particularly preferably 9 to 50, very preferably 11 to 30, and most preferably 11 to 25.

In formula (B2), each R⁴ independently represents a hydrocarbon group or T¹¹-Bᵣ—(SiR³₂—O)ₖ₁—, wherein a hydrocarbon group is preferred. Details of the hydrocarbon group are the same as those of the hydrocarbon group represented by R³.

Each T¹¹ independently represents a monovalent group, wherein specific aspects thereof are the same as those for T¹¹ in formula (C) described later.

Specific aspects of B and r are the same as those for B and r in formula (C) described later.

### (Reactive Silyl Group)

The number of the reactive silyl groups contained in the specific silane compound is 1 or larger. From the viewpoint of further improving the abrasion resistance of the surface treatment layer, the number is preferably 1 to 18, more preferably 1 to 12, still more preferably 1 to 8, particularly preferably 1 to 6, and very preferably 1 to 4. In one aspect, the number of reactive silyl groups contained in the specific silane compound is preferably 2 to 18, more preferably 2 to 12, still more preferably 2 to 8, and particularly preferably 2 to 6. The number of reactive silyl groups may even be one.

The reactive silyl group means a group having a reactive group bound to Si atom. The reactive group is preferably hydrolyzable group, group having hydrolyzable group, or hydroxy group.

The hydrolyzable group is a group converted by a hydrolysis reaction into hydroxy group. That is, the hydrolyzable silyl group represented by Si-L¹ (L¹ represents a hydrolyzable group) is converted by the hydrolysis reaction into silanol group represented by Si—OH. The silanol groups further react among themselves to form a Si—O—Si bond. The silanol group can also cause dehydration condensation reaction with a silanol group derived from an oxide present on the surface of the base, to form the Si—O—Si bond.

Examples of the hydrolyzable group include alkoxy group, aryloxy group, halogen atom, acyl group, acyloxy group, amino group, —O—N═CR^{r}₂, and isocyanato group (—NCO). The alkoxy group preferably has 1 to 4 carbon atoms.

The aryloxy group preferably has 3 to 10 carbon atoms. Where, the aryl group of the aryloxy group includes heteroaryl group. The halogen atom is preferably a chlorine atom. The acyl group preferably has 1 to 6 carbon atoms. The acyloxy group preferably has 1 to 6 carbon atoms. Each R^{r} independently represents an alkyl group having 1 to 10 carbon atoms.

Examples of the group having a hydrolyzable group include groups having hydrolyzable groups exemplified above. The group having a hydrolyzable group is preferably —O-L^{A}-L^{B}. L^{A} represents an alkylene group, and L^{B} represents a hydrolyzable group. The number of carbon atoms in the alkylene group is preferably 1 to 10. The hydrolyzable group represented by L^{B} is the same as the aforementioned hydrolyzable group. The same applies to the preferred aspects.

The reactive silyl group is preferably a group represented by formula (S1) below:

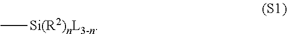

In formula (S1),
each R² independently represents a monovalent hydrocarbon group;
each L independently represents a hydrolyzable group, a group having a hydrolyzable group, or a hydroxy group; and
n represents an integer from 0 to 2.

In a case where there is a plurality of reactive silyl groups in one molecule, such plurality of reactive silyl groups may be the same, or different from each other. Such plurality of reactive silyl groups is preferably the same, from the viewpoint of availability of raw materials, and ease of production of the compound.

Each R² independently represents a monovalent hydrocarbon group, and is preferably a monovalent saturated hydrocarbon group. The number of carbon atoms in R² is preferably 1 to 6, more preferably 1 to 3, and still more preferably 1 to 2.

Each L independently represents a hydrolyzable group, a group having a hydrolyzable group, or a hydroxy group. Details of the hydrolyzable group and the group having a hydrolyzable group are as described above.

In particular, L preferably represents an alkoxy group having 1 to 4 carbon atoms, or a halogen atom, from the viewpoint of ease of production of the compound. From the viewpoint of low outgassing during coating, and excellence of shelf stability of the compound, L preferably represents an alkoxy group having 1 to 4 carbon atoms, and more preferably an ethoxy group or a methoxy group.

n represents an integer from 0 to 2, preferably 0 or 1, and more preferably 0. Presence of a plurality of L makes the surface treatment layer more tightly adherable to the base.

If n represents 1 or smaller, the plurality of L present in one molecule may be the same, or different from each other. From the viewpoint of availability of raw materials, and ease of production of the compound, the plurality of L is preferably the same. If n represents 2, the plurality of R² present in one molecule may be the same, or different from each other. From the viewpoint of availability of raw materials, and ease of production of the compound, the plurality of R² is preferably the same.

From the viewpoint of excellence in the uniformity and durability of the surface treatment layer, the reactive silyl group is preferably an alkoxysilyl group or a trichlorosilyl group. From the viewpoint of handleability of byproduct generated in the reaction with the base, the reactive silyl group is more preferably an alkoxysilyl group. The alkoxysilyl group is preferably a dialkoxysilyl group or a trialkoxysilyl group, and more preferably trialkoxysilyl group.

The reactive silyl group may also be a group represented by formula (S2) below:

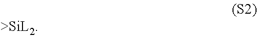

L is the same as L in formula (S1).

The reactive silyl group is also preferably a group represented by formula (S3) below:

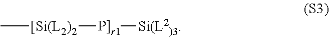

In formula (S3),
each L² independently represents a hydrolyzable group, a group having a hydrolyzable group, hydroxy group, or hydrocarbon group;
each of at least four groups of L² among all L² represents a hydrolyzable group, a group having a hydrolyzable group, or a hydroxy group; and
each P independently represents an oxygen atom, or an organic group having one carbon atom bound to both neighboring Si; and
r1 represents an integer from 1 to 3.

In a case where there is a plurality of groups (S3) in one molecule, such plurality of groups (S3) may be the same, or different from each other. Such plurality of groups (S3) is preferably the same, from the viewpoint of availability of raw materials, and ease of production of the compound.

Each L² independently represents a hydrolyzable group, a group having a hydrolyzable group, hydroxy group, or hydrocarbon group.

Details of the hydrolyzable group and the group having a hydrolyzable group are as described above.

In particular, the hydrolyzable group or the group having a hydrolyzable group in L² is preferably an alkoxy group having 1 to 4 carbon atoms, alkylene oxide-modified alkoxy group, or halogen atom, from the viewpoint of ease of production of the compound. From the viewpoint of low outgassing during coating, and further excellence in shelf stability of the compound, L² preferably represents an alkoxy group having 1 to 4 carbon atoms, and more preferably an ethoxy group or a methoxy group.

Examples of the hydrocarbon group represented by L² include alkyl group, cycloalkyl group, alkenyl group, and allyl group. From the viewpoint of ease of synthesis and the like, saturated hydrocarbon group is preferred, and alkyl group is more preferred. The number of carbon atoms in the hydrocarbon group is preferably from 1 to 6, more preferably from 1 to 3, and still more preferably from 1 to 2.

r1 represents an integer from 1 to 3. From the viewpoint of ease of synthesis, r1 preferably represents 1 or 2, and more preferably 1.

Among the plurality of L² present in one group (S3), each of at least four of them preferably represents a hydrolyzable group, a group having a hydrolyzable group, or a hydroxy group. Accordingly, group (S3) and the base will be more tightly bonded, whereby the surface treatment layer that excels in durability will be obtainable. From this point of view, the number of the hydrolyzable groups, groups having hydrolyzable groups, and hydroxy groups in group (S3) is preferably 4 to 9, more preferably 4 to 7, and still more preferably 4 or 5.

Note that the plurality of L² present in one molecule may be the same, or different from each other. For example, the plurality of L² may be the same hydrolyzable group.

Each P independently represents an oxygen atom, or an organic group having one carbon atom bound to both neighboring Si. The “organic group having one carbon atom bound to both neighboring Si” means that Si atoms are connected, while placing one carbon atom in between. Examples of P include hydrocarbon group, which may be —CH₂—, —C(CH₃)₂—, or the like, for example. From the viewpoint of durability of the surface treatment layer, P preferably represents an oxygen atom, —CH₂—, or —C(CH₃)₂—, which is more preferably oxygen atom or —CH₂—, and still more preferably oxygen atom.

From the viewpoint of excellence in durability of the surface treatment layer, group (S3) is preferably —[Si(OR¹²)₂—O]ᵣ₁—Si(OR¹²)₃. In particular, —Si(OR¹²)₂—O—Si(OR¹²)₃ that applies to r1=1 is preferred. Each R¹² herein independently represents a hydrocarbon group. Examples of the hydrocarbon group include alkyl group, cycloalkyl group, alkenyl group, and allyl group. From the viewpoint of ease of synthesis, saturated hydrocarbon group is preferred, and alkyl group is more preferred. The number of carbon atoms in R¹² is preferably 1 to 6, more preferably 1 to 3, and still more preferably 1 or 2.

Specific examples of group (S3) include Si(OCH₃)₂—O—Si(OCH₃)₃, —Si(OCH₃)₂—CH₂—Si(OCH₃)₃, —Si(OCH₃)₂—C(CH₃)₂—Si(OCH₃)₃, —Si(OCH₂CH₃)₂—O—Si(OCH₃)₃, —Si(OCH₃)₂—O—Si(OCH₂CH₃)₃, —Si(OCH₂CH₃)₂—O—Si(OCH₂CH₃)₃, —Si(OCH₂CH₃)₂—CH₂—Si(OCH₃)₃, —Si(OCH₃)₂—CH₂—Si(OCH₂CH₃)₃, —Si(OCH₂CH₃)₂—CH₂—Si(OCH₂CH₃)₃, —Si(OCH₂CH₃)₂—C(CH₃)₂—Si(OCH₃)₃, —Si(OCH₃)₂—C(CH₃)₂—Si(OCH₂CH₃)₃, —Si(OCH₂CH₃)₂—C(CH₃)₂—Si(OCH₂CH₃)₃, —Si(OH)₂—O—Si(OH)₃, —Si(OH)₂—O—Si(OCH₃)₃, —Si(OCH₃)₂—O—Si(OH)₃, —Si(OH)₂—CH₂—Si(OH)₃, —Si(OH)₂—CH₂—Si(OCH₃)₃, —Si(OCH₃)₂—CH₂—Si(OH)₃, —Si(OH)₂—C(CH₃)₂—Si(OH)₃, —Si(OH)₂—C(CH₃)₂—Si(OCH₃)₃, and —Si(OCH₃)₂—C(CH₃)₂—Si(OH)₃.

The number average molecular weight (Mn) of the specific silane compound is preferably 500 to 20,000, more preferably 600 to 18,000, and still more preferably 700 to 15,000.

With Mn of 500 or larger, the surface treatment layer will more excel in abrasion resistance. With Mn of 20,000 or smaller, the viscosity will be easily adjustable within an appropriate range, and the solubility will be improved, whereby handleability during film formation will be excellent.

The surface treatment agent may contain impurity such as byproduct produced in the production process of the specific silane compound.

The content of the specific silane compound, with respect to the total amount of the surface treatment agent, is preferably from 0.001 to 50 mass %, more preferably from 0.01 to 20 mass %, and still more preferably from 0.1 to 10 mass %. For the surface treatment agent intended for use in wet coating, the content of the specific silane compound, with respect to the total amount of the surface treatment agent, may be from 0.01 to 10 mass %, which may be from 0.02 to 5 mass %, may be from 0.03 to 3 mass %, or may be from 0.05 to 2 mass %.

Examples of the specific silane compound include a compound (also referred to as a “first compound”, hereinafter), having a chain organo(poly)siloxane residue, and a reactive silyl group bound to only one terminal of the chain organo(poly)siloxane residue; and a compound (also referred to as a “second compound”, hereinafter), having a chain organo(poly)siloxane residue, and a reactive silyl group bound to both terminals of the chain organo(poly)siloxane residue.

For the specific silane compound, the first compound may be used singly, the second compound may be used singly, or the first compound and the second compound may be used in combination. In all cases, one kind of the first compound may be used singly or two or more kinds of the first compound may be used in combination, and one kind of the second compound may be used singly or two or more kinds of the second compound may be used in combination.

### [First Compound]

The first compound has a chain organo(poly)siloxane residue, and a reactive silyl group bound to only one terminal of the chain organo(poly)siloxane residue. In the present disclosure, the “reactive silyl group bound to only one terminal of the chain organo(poly)siloxane residue” means a reactive silyl group that is bound to only one terminal of a chain organo(poly)siloxane residue directly, or indirectly while placing other chemical structure in between.

### (Chain Organo(Poly)Siloxane Residue)

The first compound contains the chain organo(poly)siloxane residue. The first compound may have one, or two or more chain organo(poly)siloxane residues. In a case where the first compound contains two or more chain organo(poly)siloxane residues, such two or more chain organo(poly)siloxane residues may be the same or different. In a case where the first compound contains two or more chain organo(poly)siloxane residues, it suffices that there is no chain organo(poly)siloxane residue having a reactive silyl group bound to both terminals, and that at least one chain organo(poly)siloxane residue has a reactive silyl group bound to one terminal thereof.

Details of the chain organo(poly)siloxane residue are as described above in the section regarding the chain organo(poly)siloxane residue contained in the specific silane compound. In particular, the chain organo(poly)siloxane residue is preferably represented by formula (B1) or (B²), and more preferably represented by formula (B1).

### (Reactive Silyl Group)

Details of the reactive silyl group are as described above in the section regarding the reactive silyl group contained in the specific silane compound.

The number of the reactive silyl groups contained in the first compound is 1 or larger, per one terminal of the chain organo(poly)siloxane residue. From the viewpoint of further improving the abrasion resistance of the surface treatment layer, the number, per one terminal of the chain organo(poly)siloxane residue, is preferably 1 to 18, more preferably 1 to 12, still more preferably 1 to 8, particularly preferably 1 to 6, and very preferably 1 to 4. In one aspect, the number of reactive silyl groups contained in the first compound, per one terminal of the chain organo(poly)siloxane residue, is preferably 2 to 18, more preferably 2 to 12, still more preferably 2 to 8, and particularly preferably 2 to 6. The number of reactive silyl groups, per one terminal of the chain organo(poly)siloxane residue, may be one.

### (Compound (C))

In one aspect, the first compound is preferably represented by formula (C) below:

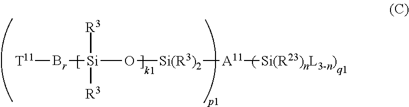

In formula (C),
T¹¹ represents a monovalent group free of reactive silyl group;
each B independently represents —O— or —C(═O)—;
each r independently represents 0 or 1;
each R³ independently represents a hydrocarbon group;
each k1 independently represents a number of 1 or larger;
p1 represents an integer of 1 or larger,
A¹¹ represents a (p1+q1)-valent linking group;
q1 represents an integer of 1 or larger,
each R² independently represents a hydrocarbon group;
each L independently represents a hydrolyzable group, a group having a hydrolyzable group, or a hydroxy group; and
each n independently represents an integer from 0 to 2.

In formula (C), R³ and k1 are the same as R³ and k1 in formula (B1).

R², L, and n are the same as R², L, and n in formula (S1).

In formula (C), T¹ represents a monovalent group.

Examples of T¹¹ include alkyl group, T¹₃M¹-(where, M¹ represents Si, Sn, or Ge, and each T¹ independently represents a hydrocarbon group or a trialkylsilyloxy group; T¹₃M¹-R¹—(where M¹ represents Si, Sn or Ge, each T¹ independently represents a hydrocarbon group or a trialkylsilyloxy group, and R¹ represents an alkylene group); monovalent cyclic polysiloxane residue or monovalent cage-like polysiloxane residue; and combination of the monovalent cyclic polysiloxane residue or the monovalent cage-like polysiloxane residue, with a divalent hydrocarbon group.

The alkyl group represented by TH may be any of linear alkyl group, branched alkyl group, and cycloalkyl group. Linear alkyl group or branched alkyl group is preferred. The number of carbon atoms in the alkyl group may be 1, or 2 or larger. In a case where the alkyl group has two or more carbon atoms, the number of carbon atoms is preferably 2 to 30, more preferably 3 to 28, and still more preferably 4 to 22.

M¹ in T¹₃M¹- and T¹₃M¹-R¹— preferably represents Si.

T¹ in T¹₃M¹- and T¹₃M¹-R¹— preferably represents an alkyl group or a trialkylsilyloxy group, and more preferably a methyl group, butyldimethylsilyloxy group, trimethylsilyloxy group, or triethylsilyloxy group.

R¹ preferably represents an alkylene group having 1 to 20 carbon atoms, more preferably an alkylene group having 1 to 10 carbon atoms, and still more preferably an alkylene group having 1 to 5 carbon atoms. Ethylene group is preferred.

In one aspect, T¹¹ preferably represents an alkyl group or a trialkylsilyl group, and more preferably represents a methyl group or a trimethylsilyl group.

The monovalent cyclic polysiloxane residue is preferably a group represented by formula (T1) below.

In formula (T1),
each R^{T} independently represents a hydrocarbon group or a hydrocarbon group having substituent, and
s represents an integer from 1 to 4.

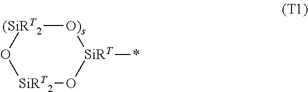

Examples of the hydrocarbon group represented by R^{T} include aliphatic hydrocarbon group and aromatic hydrocarbon group. In particular, the hydrocarbon group is preferably aliphatic hydrocarbon group, and more preferably alkyl group.

The alkyl group, from among the hydrocarbon group represented by R^{T}, may be any of linear alkyl group, branched alkyl group, and cycloalkyl group. Linear alkyl group is preferred. The number of carbon atoms in the alkyl group is preferably 1 to 10, more preferably 1 to 8, and still more preferably 1 to 4. More specifically, the alkyl group is preferably methyl group, ethyl group, n-propyl group, or n-butyl group, wherein methyl group is more preferred.

Examples of the hydrocarbon group, contained in the substituted hydrocarbon group represented by R^{T}, include aliphatic hydrocarbon group and aromatic hydrocarbon group. In particular, the hydrocarbon group is preferably aliphatic hydrocarbon group, and more preferably alkyl group. The alkyl group may be any of linear alkyl group, branched alkyl group, and cycloalkyl group. Linear alkyl group is preferred. The number of carbon atoms in the alkyl group contained in the substituted alkyl group is preferably 1 to 10, more preferably 1 to 8, and still more preferably 2 to 4.

Examples of the substituent, in the substituted hydrocarbon group represented by R^{T}, include halogen atom, hydroxy group, alkoxy group, trialkylsilyl ether group, trialkylsilyl group, amino group, nitro group, cyano group, sulfonyl group, and trifluoromethyl group.

The plurality of R^{T} may be the same or different from each other, and is preferably the same, from the viewpoint of ease of production.

Examples of the monovalent cyclic polysiloxane residue include the groups below:

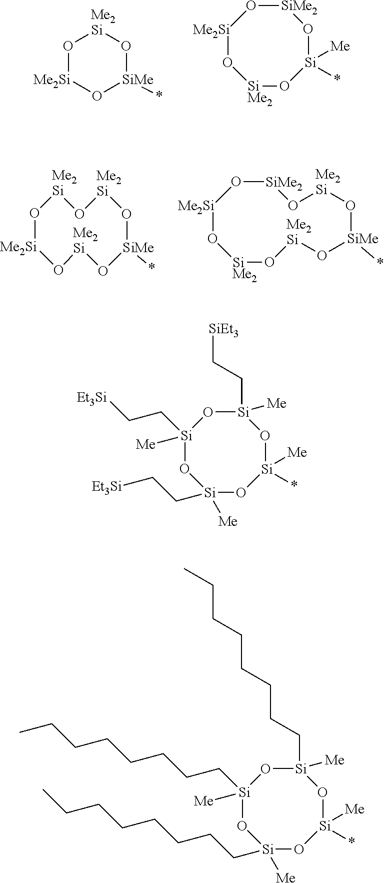

The monovalent cage-like polysiloxane residue is preferably a group represented by formula (T2) below.

In formula (T2),
each R⁵ independently represents a hydrocarbon group or a trialkylsilyloxy group.

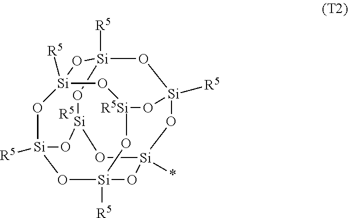

Examples of the hydrocarbon group represented by R⁵ include aliphatic hydrocarbon group and aromatic hydrocarbon group. In particular, the hydrocarbon group is preferably aliphatic hydrocarbon group, and more preferably alkyl group. The alkyl group may be any of linear alkyl group, branched alkyl group, or cycloalkyl group. Linear alkyl group or branched alkyl group is preferred; methyl group, ethyl group, n-propyl group, n-butyl group, or isobutyl group is more preferred; and isobutyl group is still more preferred.

The alkyl group contained in the trialkylsilyloxy group represented by R⁵ may be any of linear alkyl group, branched alkyl group, or cycloalkyl group. Linear alkyl group is preferred; methyl group, ethyl group, n-propyl group, or n-butyl group is more preferred; and methyl group is still more preferred. In a case where R⁵ represents a trialkylsilyloxy group, the three alkylsilyloxy groups may be the same or different from each other, and are preferably the same, from the viewpoint of ease of production.

Examples of the monovalent cage-like polysiloxane residue include the groups below:

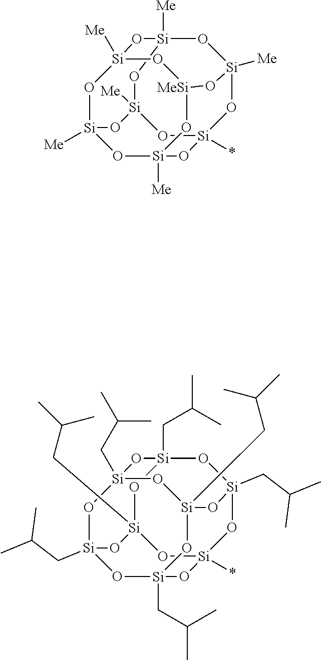

Examples of the divalent hydrocarbon group, in the combination of the monovalent cyclic polysiloxane residue or the monovalent cage-like polysiloxane residue, with the divalent hydrocarbon group, include alkylene group. The number of carbon atoms in the alkylene group is preferably 1 to 20, more preferably 1 to 10, and still more preferably 1 to 5.

In formula (C), each B independently represents —O— or —C(═O)—, wherein —O— is preferred.

In formula (C), p1 represents an integer of 1 or larger, preferably an integer from 1 to 3, more preferably 1 or 2, and still more preferably 1.

If p1 represents 2 or larger, the plurality of T¹¹-Bᵣ—[Si(R³)₂—O]ₖ₁—Si(R³)₂— may be the same or different from each other.

In formula (C), A¹¹ represents a (p1+q1)-valent linking group. Examples of A¹¹ include alkylene group, organo(poly)siloxane residue, polyalkylene oxide group, and combinations thereof; as well as combinations of any of these groups with (p1+1)-valent group and/or a (q1+1)-valent group.

Examples of the alkylene group include alkylene group having 1 to 30 carbon atoms, and preferably alkylene group having 1 to 20 carbon atoms, having but not necessarily at least one species selected from the group consisting of etheric oxygen atom, sulfur atom, —C(═O)NH—, —NHC(═O)—, —N(R^{d})—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and phenylene group.

Examples of the organo(poly)siloxane residue include group represented by the aforementioned formula (B1).

Examples of the polyalkylene oxide group include group represented by formula (XO)ₘ. Each X herein independently represents an alkylene group having 1 to 5 carbon atoms, where m represents an integer of 1 or larger. The number of carbon atoms in X is preferably 1 to 4, and more preferably 2 or 3. m preferably represents 1 to 200, more preferably 1 to 20, and still more preferably 1 to 10.

Examples of A¹¹ include A in formula A(Si(R²)ₙL₃₋ₙ)_{q1} described later.

In formula (C), q1 represents an integer of 1 or larger, which is preferably 1 to 18, more preferably 1 to 12, still more preferably 1 to 8, particularly preferably 1 to 6, and very preferably 1 to 4. In one aspect, q1 preferably represents 2 to 18, more preferably 2 to 12, still more preferably 2 to 8, particularly preferably 2 to 6, and very preferably 2 to 4. q1 may be 1.

If q1 represents an integer of 2 or larger, the plurality of [Si(R²)ₙL₃₋ₙ] may be the same or different from each other.

In one aspect, T¹¹ in formula (C) preferably represents a trialkylsilyl group or an alkyl group, and more preferably represents a trimethylsilyl group or a methyl group.
r preferably represents 0.
R³ preferably represents a methyl group.
k1 preferably represents 1 to 100.
p1 preferably represents 1.

All preferably represents an alkylene group having 1 to 30 carbon atoms, or a group that remains after removal of Si(R²)ₙL₃₋ₙ from group (3-1A) described later, and more preferably represents an alkylene group having 1 to 30 carbon atoms, or a group that remains after removal of Si(R²)ₙL₃₋ₙ from group (3-1A-4) described later.

q1 preferably represents an integer from 1 to 4.

In a case where the underlayer forming composition contains the compound A, combination with the compound represented by formula (C), as the specific silane compound contained in the surface treatment agent, will improve the abrasion resistance of the surface treatment layer.

In a particular case where the compound A is a compound represented by formula (1A¹) (preferably, tetraethoxysilane), combination with the compound represented by formula (C), as the specific silane compound contained in the surface treatment agent, will improve the abrasion resistance of the surface treatment layer.

In formula (C), the number of Si atoms contained in the group represented by [T¹¹-Bᵣ—{Si(R³)₂O}ₖ₁—Si(R³)₂]— (also referred to as “group H_{C}”, hereinafter) is preferably smaller than the number of atoms contained in the main chain of A¹¹.

The ratio of the number of atoms contained in the main chain of A¹¹, to the number of Si atoms contained in group H_{C} is preferably 1.2 or larger, more preferably 2 or larger, and still more preferably 5 or larger.

The upper limit value of the ratio is, for example, 15.

With the ratio being 1.2 or more, the abrasion resistance of the surface treatment layer will further improve.

The number of atoms contained in the main chain of A¹¹ is preferably 11 to 60, more preferably 15 to 40, and still more preferably 15 to 30.

The number of Si atoms contained in group H_{C} is preferably 1 to 100, more preferably 2 to 70, and still more preferably 2 to 30.

In a case where the underlayer forming composition contains at least one species selected from the group consisting of the compound represented by formula (2B¹), the compound represented by formula (2B²), the compound represented by formula (2C¹), the compound represented by formula (2C²), and the compound that contains the structure represented by formula (2D), combination with the compound represented by formula (C), as the specific silane compound contained in the surface treatment agent, will improve the abrasion resistance of the surface treatment layer.

In a particular case where the underlayer forming composition contains the compound B, combination with the compound represented by formula (C), as the specific silane compound contained in the surface treatment agent, will improve the abrasion resistance of the surface treatment layer.

By thus combining the silane compound contained in the underlayer forming composition, with the surface treatment agent used for forming the surface treatment layer, the abrasion resistance of the surface treatment layer will be improved.

In formula (C), the number of Si atoms contained in group H_{C} is preferably larger than the number of atoms contained in the main chain of A¹¹.

The ratio of the number of atoms contained in the main chain of A¹¹, to the number of Si atoms contained in group H_{C} is preferably 0.9 or smaller, more preferably 0.6 or smaller, and still more preferably 0.3 or smaller.

The lower limit value of the ratio is, for example, larger than 0.

With the ratio being 0.9 or less, the abrasion resistance of the surface treatment layer will further improve.

The number of atoms contained in the main chain of A¹¹ is preferably 1 to 30, more preferably 1 to 15, and still more preferably 1 to 10.

The number of Si atoms contained in group H_{C} is preferably 15 to 100, and more preferably 25 to 70.

### (Compound (C2))

In further aspect, the first compound is preferably represented by formula (C2) below:

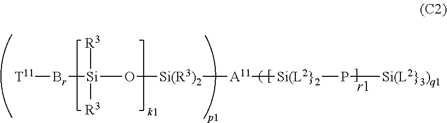

In formula (C2),
each L² independently represents a hydrolyzable group, a group having a hydrolyzable group, a hydroxy group, or a hydrocarbon group;
each of at least four groups of L² among all L² represents a hydrolyzable group, a group having a hydrolyzable group, or a hydroxy group;
each P independently represents an oxygen atom, or an organic group having one carbon atom bound to both neighboring Si; and
r1 represents an integer from 1 to 3.

Definitions of T¹¹, B, r, R³, k1, p1, A¹¹, and q1 are same as those in formula (C).

Specific aspects of T¹¹, B, r, R³, k1, p1, A¹¹, and q1 in formula (C2) are the same as the specific aspects in formula (C).

Specific aspects of L², P, and r1 in formula (C2) are the same as the specific aspects of L², P, and r1 in formula (S3).

In a case where the underlayer forming composition contains the compound A, combination with the compound represented by formula (C2), as the specific silane compound contained in the surface treatment agent, will improve the abrasion resistance of the surface treatment layer.

In a particular case where the compound A is a compound represented by formula (1A¹) (preferably, tetraethoxysilane), combination with the compound represented by formula (C2), as the specific silane compound contained in the surface treatment agent, will improve the abrasion resistance of the surface treatment layer.

In formula (C2), the number of Si atoms contained in group H_{C} is preferably smaller than the number of atoms contained in the main chain of A¹¹.

The ratio of the number of atoms contained in the main chain of A¹¹, to the number of Si atoms contained in group H_{C} is preferably 1.2 or larger, more preferably 2 or larger, and still more preferably 5 or larger.

The upper limit value of the ratio is, for example, 15.

With the ratio being 1.2 or more, the abrasion resistance of the surface treatment layer will further improve.

The number of atoms contained in the main chain of A¹¹ is preferably 11 to 60, more preferably 15 to 40, and still more preferably 15 to 30.

The number of Si atoms contained in group He is preferably 1 to 100, more preferably 2 to 70, and still more preferably 2 to 30.

In a case where the underlayer forming composition contains at least one species selected from the group consisting of the compound represented by formula (2B¹), the compound represented by formula (2B²), the compound represented by formula (2C¹), the compound represented by formula (2C²), and the compound that contains the structure represented by formula (2D), combination with the compound represented by formula (C2), as the specific silane compound contained in the surface treatment agent, will improve the abrasion resistance of the surface treatment layer.

In a particular case where the underlayer forming composition contains the compound B, combination with the compound represented by formula (C2), as the specific silane compound contained in the surface treatment agent, will improve the abrasion resistance of the surface treatment layer.

By thus combining the silane compound contained in the underlayer forming composition, with the surface treatment agent used for forming the surface treatment layer, the abrasion resistance of the surface treatment layer will be improved.

In formula (C2), the number of Si atoms contained in group H_{C} is preferably larger than the number of atoms contained in the main chain of A¹¹.

The ratio of the number of atoms contained in the main chain of A¹¹, to the number of Si atoms contained in group H_{C} is preferably 0.9 or smaller, more preferably 0.6 or smaller, and still more preferably 0.3 or smaller.

The lower limit value of the ratio is, for example, larger than 0.

With the ratio being 0.9 or less, the abrasion resistance of the surface treatment layer will further improve.

The number of atoms contained in the main chain of A¹¹ is preferably 1 to 30, more preferably 1 to 15, and still more preferably 1 to 10.

The number of Si atoms contained in group H_{C} is preferably 15 to 100, and more preferably 25 to 70.

The number average molecular weight (Mn) of the first compound is preferably 500 to 20,000, more preferably 600 to 18,000, and still more preferably 700 to 15,000. In one aspect, Mn of the first compound may also be from 500 to 5,000, and may be from 500 to 3,000.

With Mn being 500 or more, the surface treatment layer will more excel in abrasion resistance. With Mn being 20,000 or less, the viscosity will be easily adjustable within an appropriate range, and the solubility will be improved, whereby handleability during film formation will be excellent.

The surface treatment agent may contain only one kind of the first compound, or two or more kinds thereof.

The surface treatment agent may contain impurity such as byproduct produced in the production process of the first compound.

The content of the first compound, with respect to the total amount of the surface treatment agent, is preferably from 0.001 to 50 mass %, more preferably from 0.01 to 20 mass %, and still more preferably from 0.1 to 10 mass %. For the surface treatment agent intended for use in wet coating, the content of the first compound, with respect to the total amount of the surface treatment agent, may be from 0.01 to 10 mass %, may be from 0.02 to 5 mass %, may be from 0.03 to 3 mass %, or may be from 0.05 to 2 mass %.

The content of the first compound, with respect to the total solid content of the surface treatment agent, is preferably 5 mass % or more and less than 65 mass %, more preferably 10 to 64 mass %, may also be from 20 to 60 mass %, and may be from 30 to 50 mass %.

### [Second Compound]

The second compound has a chain organo(poly)siloxane residue, and reactive silyl groups individually bound to both terminals of the chain organo(poly)siloxane residue. In the present disclosure, the “reactive silyl groups individually bound to both terminals of the chain organo(poly)siloxane residue” means each reactive silyl group is bound to each of both terminals of the chain organo(poly)siloxane residue directly, or indirectly while placing other chemical structure in between.

### (Chain Organo(Poly)Siloxane Residue)

The second compound contains the chain organo(poly)siloxane residue. The second compound may have one, or two or more chain organo(poly)siloxane residues. In a case where the second compound contains two or more chain organo(poly)siloxane residues, such two or more chain organo(poly)siloxane residues may be the same or different. In a case where the second compound contains two or more chain organo(poly)siloxane residues, it suffices that at least one chain organo(poly)siloxane residue has the reactive silyl groups bound to both terminals thereof.

Details of the chain organo(poly)siloxane residue are as described above in the section regarding the chain organo(poly)siloxane residue contained in the specific silane compound. In particular, the chain organo(poly)siloxane residue is preferably represented by formula (B1) or (B2), and more preferably represented by formula (B1).

### (Reactive Silyl Group)

Details of the reactive silyl group are as described above in the section regarding the reactive silyl group contained in the specific silane compound.

The number of the reactive silyl groups contained in the second compound is 1 or larger, per one terminal of the chain organo(poly)siloxane residue. From the viewpoint of further improving the abrasion resistance of the surface treatment layer, the number, per one terminal of the chain organo(poly)siloxane residue, is preferably 1 to 18, more preferably 1 to 12, still more preferably 1 to 8, particularly preferably 1 to 6, and very preferably 1 to 4. In one aspect, the number of reactive silyl groups contained in the second compound, per one terminal of the chain organo(poly)siloxane residue, is preferably 2 to 18, more preferably 2 to 12, still more preferably 2 to 8, and particularly preferably 2 to 6. The number of reactive silyl groups, per one terminal of the chain organo(poly)siloxane residue, may be one.

### (Compound (D))

In one aspect, the second compound is preferably represented by formula (D) below:

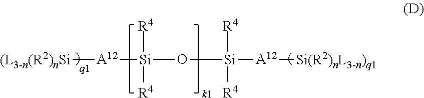

In formula (D),
each R⁴ independently represents a hydrocarbon group or T¹¹-Bᵣ—(SiR³₂—O)ₖ₁—,
each T¹¹ independently represents a monovalent group;
each B independently represents —O— or —C(═O)—;
each r independently represents 0 or 1,
each R³ independently represents a hydrocarbon group;
each k1 independently represents a number of 1 or larger;
each A¹² independently represents a (q1+1)-valent linking group;
each q1 independently represents an integer of 1 or larger;
each R² independently represents a hydrocarbon group;
each L independently represents a hydrolyzable group, a group having a hydrolyzable group, or a hydroxy group; and
each n independently represents an integer from 0 to 2.

In formula (D), R⁴ and k1 are the same as R⁴ and k1 in formula (B2).

R², L, and n are the same as R², L, and n in formula (S1).

Examples of A¹² include alkylene group, organo(poly)siloxane residue, polyalkylene oxide group, and combinations thereof; as well as combinations of any of these groups with (q1+1)-valent group.

Examples of the alkylene group include alkylene group having 1 to 30 carbon atoms, and preferably alkylene group having 1 to 20 carbon atoms, having but not necessarily at least one species selected from the group consisting of etheric oxygen atom, sulfur atom, —C(═O)NH—, —NHC(═O)—, —N(R^{d})—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and phenylene group.

Examples of the organo(poly)siloxane residue include group represented by the aforementioned formula (B1) or (B2).

Examples of the polyalkylene oxide group include group represented by formula (XO)ₘ. Each X herein independently represents an alkylene group having 1 to 5 carbon atoms, and m represents an integer of 1 or larger. The number of carbon atoms in X is preferably 1 to 4, and more preferably 2 or 3. m preferably represents 1 to 100, more preferably 1 to 10, and still more preferably 1 to 5.

Examples of A¹² include (q1+1)-valent group, from among A in formula A(Si(R²)ₙL₃₋ₙ)_{q1} described later.

Each q1 independently represents an integer of 1 or larger, and independently, preferably 1 to 18, more preferably 1 to 12, still more preferably 1 to 8, particularly preferably 1 to 6, and very preferably 1 to 4. In one aspect, q1 preferably represents 2 to 18, more preferably 2 to 12, still more preferably 2 to 8, particularly preferably 2 to 6, and very preferably 2 to 4. q1 may represent 1.

If q1 represents an integer of 2 or larger, the plurality of [Si(R²)ₙL₃₋ₙ] may be the same or different from each other.

In one aspect, R⁴ preferably represents a methyl group.

k1 preferably represents a number from 1 to 100.

A¹² preferably represents an alkylene group having 1 to 30 carbon atoms, or a group that remains after removal of Si(R²)ₙL₃₋ₙ from group (3-1 A) described later, and more preferably represents an alkylene group having 1 to 30 carbon atoms, or a group that remains after removal of Si(R²)ₙL₃₋ₙ from group (3-1A-4) described later.

q1 preferably represents an integer from 1 to 4.

### (Compound (D2))

In further aspect, the second compound is preferably represented by formula (D2) below:

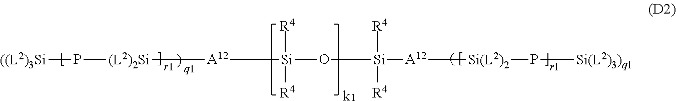

In formula (D2),
each L² independently represents a hydrolyzable group, a group having a hydrolyzable group, a hydroxy group, or a hydrocarbon group;
each of at least four groups of L² among all L² represents a hydrolyzable group, a group having a hydrolyzable group, or a hydroxy group;
each P independently represents an oxygen atom, or an organic group having one carbon atom bound to both neighboring Si; and
each r1 independently represents an integer from 1 to 3.

Definitions of R⁴, k1, A¹², and q1 are same as those in formula (D).

Specific aspects of R⁴, k1, A¹², and q1 in formula (D2) are the same as the specific aspects in formula (D).

Specific aspects of L², P, and r1 in formula (D2) are the same as the specific aspects of L², P, and r1 in formula (S3).

The number average molecular weight (Mn) of the second compound is preferably from 500 to 20,000, more preferably from 600 to 18,000, and still more preferably from 700 to 15,000. In one aspect, Mn of the second compound may also be from 500 to 5,000, and may be from 500 to 3,000 or smaller.

With Mn being 500 or more, the surface treatment layer will more excel in abrasion resistance. With Mn being 20,000 or less, the viscosity will be easily adjustable within an appropriate range, and the solubility will be improved, whereby handleability during film formation will be excellent.

The surface treatment agent may contain only one kind of second compound, or two or more kinds of second compounds.

The surface treatment agent may contain impurity such as byproduct produced in the production process of the second compound.

The content of the second compound, with respect to the total amount of the surface treatment agent, is preferably from 0.001 to 50 mass %, more preferably from 0.01 to 20 mass %, and still more preferably from 0.1 to 10 mass %. For the surface treatment agent intended for use in wet coating, the content of the second compound, with respect to the total amount of the surface treatment agent, may be from 0.01 to 10 mass %, may be from 0.02 to 5 mass %, may be from 0.03 to 3 mass %, and may be from 0.05 to 2 mass %.

The content of the second compound, with respect to the total solid content of the surface treatment agent, is preferably more than 35 mass % and 95 mass % or less, more preferably from 36 to 90 mass %, may also be from 40 to 80 mass %, and may be from 50 to 70 mass %. The content of the second compound may be from 35 to 95 mass %.

### [Compound (E) or (E2)]

In one aspect, the specific silane compound may also be a compound represented by formula (E).

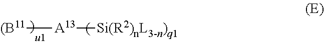

In formula (E),
B¹¹ represents a monovalent group having at least one selected from the group consisting of Si, Ge, and Sn to which a hydroxy group or a hydrolyzable group is not directly bound; or a monovalent group having a branched alkyl group;
u1 represents an integer of 1 or larger;
A¹³ represents a (q1+u1)-valent linking group;
q1 represents an integer of 1 or larger;
each R² independently represents a hydrocarbon group;
each L independently represents a hydrolyzable group, a group having a hydrolyzable group, or a hydroxy group; and
each n independently represents an integer from 0 to 2.

In formula (E), R², L, and n are the same as R², L, and n in formula (S1).

q1 is the same as q1 in formula (C).

B¹¹ represents a monovalent group having at least one selected from the group consisting of Si, Ge, and Sn to which a hydroxy group or a hydrolyzable group is not directly bound; or a monovalent group having a branched alkyl group. The monovalent group having at least one selected from the group consisting of Si, Ge, and Sn to which a hydroxy group or a hydrolyzable group is not directly bound may contain, but not necessarily, Si, Ge, or Sn to which a hydroxy group or a hydrolyzable group is directly bound.

In one aspect, B¹¹ may represent a group having group (a) or group (b).

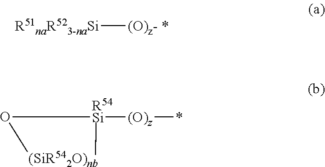

In formula (a),
R⁵¹ is a group represented by —(R⁶¹—SiR⁵³₂)ₘₐ—R⁵³, where each R⁶¹ independently represents an oxygen atom or an alkylene group having 1 to 6 carbon atoms, each R⁵³ independently represents a hydrocarbon group or R^{51′}, wherein R^{51′} has the same meaning as R⁵¹; ma represents an integer from 1 to 5; wherein the number of R^{51′} in R⁵¹ is 20 or smaller;
R⁵² represents a hydrocarbon group;
na represents an integer from 1 to 3,
z represents 0 or 1; and
* indicates a binding site with a neighboring atom.

In formula (b),
each R⁵⁴ independently represents a hydrocarbon group;
nb represents an integer from 1 to 5;
z represents 0 or 1; and
* indicates a binding site with a neighboring atom.

The alkylene group having 1 to 6 carbon atoms in R⁶¹ may be linear or branched. The alkylene group having 1 to 6 carbon atoms is preferably alkylene group having 1 to 4 carbon atoms, and more preferably alkylene group having 2 to 4 carbon atoms.

The hydrocarbon group represented by R⁵³ is preferably an alkyl group or an aryl group. The alkyl group may be linear or branched. The alkyl group is preferably an alkyl group having 1 to 6 carbon atoms, more preferably an alkyl group having 1 to 4 carbon atoms, and still more preferably methyl group, ethyl group, n-propyl group, isopropyl group, or tert-butyl group.

The hydrocarbon group represented by R⁵² is preferably an alkyl group or an aryl group. The alkyl group may be linear or branched. The alkyl group is preferably an alkyl group having 1 to 6 carbon atoms, more preferably an alkyl group having 1 to 4 carbon atoms, and still more preferably methyl group, ethyl group, n-propyl group, isopropyl group, or tert-butyl group.

The hydrocarbon group represented by R⁵⁴ is preferably an alkyl group or an aryl group. The alkyl group may be linear or branched. The alkyl group is preferably an alkyl group having 1 to 6 carbon atoms, more preferably an alkyl group having 1 to 4 carbon atoms, and still more preferably methyl group, ethyl group, n-propyl group, isopropyl group, or tert-butyl group.

nb represents an integer from 1 to 5, and preferably 2 or 3.

Examples of the group having group (a) or group (b) include group (a) or group (b) alone, and a group composed of group (a) or group (b) to which a chain group is bound.

Examples of the chain group include chain hydrocarbon group; chain organo(poly)siloxane residue; group having at least one species selected from the group consisting of —O—, —S—, —C(═O)NH—, —NHC(═O)—, —N(R^{d})—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and phenylene group, at a terminal, or between the carbon-carbon atoms in the chain hydrocarbon group; and combinations thereof. R^{d} represents a hydrogen atom or an alkyl group (preferably having 1 to 10 carbon atoms).

Examples of the chain hydrocarbon group include linear or branched chain hydrocarbon groups having 2 to 100, preferably 5 to 90, and more preferably 10 to 80 carbon atoms. The chain hydrocarbon group is preferably alkylene group. From the viewpoint of forming the surface treatment layer that excels in acid resistance, hot water resistance, abrasion resistance, and the like, the chain hydrocarbon group is preferably alkylene group having 13 or more carbon atoms.

The same will apply to the number of carbon atoms of the group having at least one species selected from the group consisting of —O—, —S—, —C(═O)NH—, —NHC(═O)—, —N(R^{d})—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and phenylene group, at a terminal or between the carbon-carbon atoms in the chain hydrocarbon group. R^{d} represents a hydrogen atom or an alkyl group (preferably having 1 to 10 carbon atoms).

Examples of the chain organo(poly)siloxane residue include the examples described above as the chain organo(poly)siloxane residue in the specific silane compound.

In one aspect, B¹¹ may represent a group having group (c):

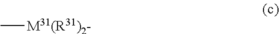

In formula (c),
M³¹ represents Sn or Ge, and
each R³¹ independently represents a hydrocarbon group or a trialkylsilyloxy group.

M³¹ represents Sn or Ge. Ge has an atomic size larger than that of Sn, and can form the surface treatment layer having more lowered surface free energy and more excellent removability of fingerprint. M³¹ therefore preferably represents Ge.

R³¹ represents a hydrocarbon group or a trialkylsilyloxy group.

Examples of the hydrocarbon group include alkyl group, cycloalkyl group, alkenyl group, and allyl group. From the viewpoint of ease of synthesis or the like, saturated hydrocarbon group is preferred, and alkyl group is more preferred. The number of carbon atoms in R³¹ is preferably 1 to 6, and more preferably 1 to 3. In particular, —CH₃ or —CH₂CH₃ is preferred.

The trialkylsilyloxy group is preferably a group represented by —O—SiR⁴⁰₃. Where, each R⁴⁰ herein independently represents a hydrocarbon group. The hydrocarbon group in R⁴⁰ is preferably an alkyl group or an aryl group, and more preferably an alkyl group. The number of carbon atoms in R⁴⁰ is preferably 1 to 6, more preferably 1 to 4, and still more preferably 1 to 2. Specific examples of the hydrocarbon group in R⁴⁰ include —CH₃, —CH₂CH₃, and —C(CH₃)₃.

Examples of the group having group (c) include group (c) alone, and group composed of group (c) having an organic group bound to one side or both sides of M³¹. Examples of the organic group include monovalent organic group, divalent organic group, and combination thereof. Where, the monovalent organic group is not bound to both terminals.

Examples of the monovalent organic group include hydrocarbon group, trialkylsilyloxy group, or organopolysiloxane group. Group (c) may be M³¹(R³¹)₃—.

Examples of the divalent organic group include chain hydrocarbon group; chain organo(poly)siloxane residue; group having at least one species selected from the group consisting of —O—, —S—, —C(═O)NH—, —NHC(═O)—, —N(R)—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and phenylene group, at a terminal, or between the carbon-carbon atoms in the chain hydrocarbon group; and combinations thereof. R^{d} represents a hydrogen atom or an alkyl group (preferably having 1 to 10 carbon atoms).

Examples of the chain hydrocarbon group include linear or branched chain hydrocarbon groups having 2 to 100, preferably 5 to 90, and more preferably 10 to 80 carbon atoms. Examples of the chain hydrocarbon group include alkyl group and alkylene group. From the viewpoint of forming the surface treatment layer that excels in acid resistance, hot water resistance, abrasion resistance, and the like, the chain hydrocarbon group is preferably alkylene group having 13 or more carbon atoms.

The same will apply to the number of carbon atoms of the group having at least one species selected from the group consisting of —O—, —S—, —C(═O)NH—, —NHC(═O)—, —N(R^{d})—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and phenylene group, at a terminal or between the carbon-carbon atoms in the chain hydrocarbon group. R^{d} represents a hydrogen atom or an alkyl group (preferably having 1 to 10 carbon atoms).

Examples of the chain organo(poly)siloxane residue include the examples described above as the chain organo(poly)siloxane residue in the specific silane compound.

In one aspect, B¹¹ may represent a monovalent group having a branched alkyl group. The branched alkyl group is preferably unsubstituted. The branched alkyl group is preferably a tert-butyl group, or contains a tert-butyl group. The branched alkyl group may contain one branching, or a plurality of branchings. The number of branching in the branched alkyl group may be 1 to 30, may be 1 to 20, may be 1 to 10, or may be 1 to 5.

Examples of the branched alkyl group include a group represented by a formula below:

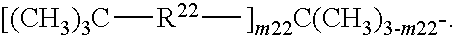

In the formula,
each R²² independently represents an alkylene group having 1 to 6 carbon atoms, and
m22 represents an integer from 0 to 3.

Examples of the monovalent group having a branched alkyl group include group having a chain group bound to a carbon atom at the branching point of the branched alkyl group.

Examples of the chain group include chain hydrocarbon group; chain organo(poly)siloxane residue; group having at least one species selected from the group consisting of —O—, —S—, —C(═O)NH—, —NHC(═O)—, —C(═O)O—, —OC(═O)—, —C(═O)S—, —SC(═O)—, —S(═O)₂NH—, —NHS(═O)₂—, —S(═O)₂O—, —OS(═O)₂—, and phenylene group, at a terminal, or between the carbon-carbon atoms in the chain hydrocarbon group; and combinations thereof.

Examples of the chain hydrocarbon group include linear or branched chain hydrocarbon group having 2 to 100, preferably 5 to 90, and more preferably 10 to 80 carbon atoms. The chain hydrocarbon group is preferably alkylene group. From the viewpoint of forming the surface treatment layer that excels in acid resistance, hot water resistance, abrasion resistance, and the like, the chain hydrocarbon group is preferably alkylene group having 13 or more carbon atoms.

The same will apply to the number of carbon atoms of the group having at least one species selected from the group consisting of —O—, —S—, —C(═O)NH—, —NHC(═O)—, —N(R^{d})—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and phenylene group, at a terminal or between the carbon-carbon atoms in the chain hydrocarbon group. R^{d} represents a hydrogen atom or an alkyl group (preferably having 1 to 10 carbon atoms).

Examples of the chain organo(poly)siloxane residue include the examples described above as the chain organo(poly)siloxane residue in the specific silane compound.

In formula (E), u1 represents an integer of 1 or larger. From the viewpoint of ease of production and the like, u1 preferably represents 1 to 6, and more preferably 1 to 4.

In formula (E), A¹³ represents a (q1+u1)-valent linking group. Examples of A¹³ include the same specific examples as A¹¹ in formula (C).

The compound (E) may be a compound in which B¹¹ represents group (a) or M³¹(R³¹)₃—; u1 represents 1; A¹³ represents an alkylene group having 1 to 30 carbon atoms, and having but not necessarily at least one species selected from the group consisting of —O—, —S—, —C(═O)NH—, —NHC(═O)—, —N(R^{d})—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and phenylene group, between the carbon-carbon atoms; and q1 represents 1.

The compound (E) may also be a compound in which B¹¹ represents group (a) or M³¹(R³¹)₃—; u1 represents 1; A¹³ represents a chain hydrocarbon group having 1 to 30 carbon atoms, and having but not necessarily at least one species selected from the group consisting of —O—, —S—, —C(═O)NH—, —NHC(═O)—, —N(R^{d})—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and phenylene group, between the carbon-carbon atoms; and q1 represents 2 or 3.

R^{d} represents a hydrogen atom or an alkyl group (preferably having 1 to 10 carbon atoms).

Specific examples of the compound (E) include the compounds below. In the formulae below, sa preferably represents 1 to 30, more preferably 4 to 20, and still more preferably 5 to 15.

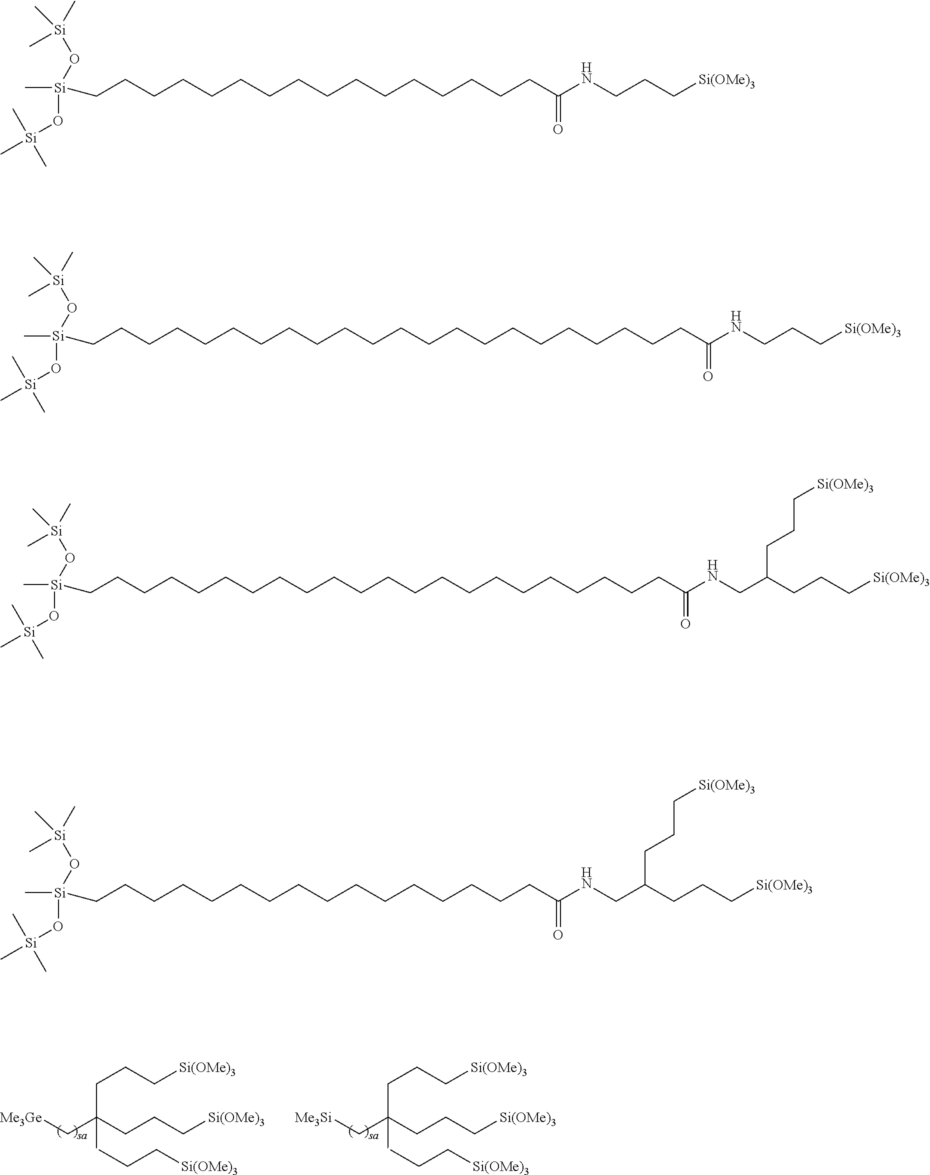

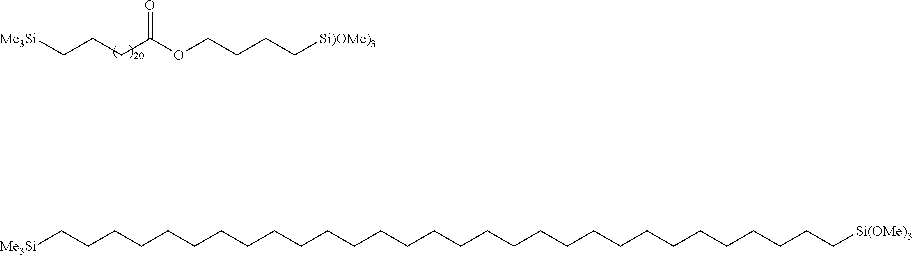

In a case where the underlayer forming composition contains the compound A, combination with the compound represented by formula (E), as the specific silane compound contained in the surface treatment agent, will improve the abrasion resistance of the surface treatment layer.

In a particular case where the compound A is a compound represented by formula (1A¹) (preferably, tetraethoxysilane), combination with the compound represented by formula (E), as the specific silane compound contained in the surface treatment agent, will improve the abrasion resistance of the surface treatment layer.

In formula (E), the number of Si atoms contained in (B¹¹)ᵤ₁ is preferably smaller than the number of atoms contained in the main chain of A¹³.

The ratio of the number of atoms contained in the main chain of A¹³, to the number of Si atoms contained in (B¹¹)ᵤ₁ is preferably 1.2 or larger, more preferably 2 or larger, and still more preferably 5 or larger.

The upper limit value of the ratio is, for example, 50.

With the ratio being 1.2 or more, the abrasion resistance of the surface treatment layer will further improve.

The number of atoms contained in the main chain of A¹³ is preferably 11 to 60, more preferably 15 to 40, and still more preferably 15 to 30.

The number of Si atoms contained in (B¹¹)ᵤ₁ is preferably 1 to 100, more preferably 2 to 70, and still more preferably 2 to 30. The number of Si atoms contained in (B¹¹)ᵤ₁ may also be 0.

In a case where the underlayer forming composition contains at least one species selected from the group consisting of the compound represented by formula (2B¹), the compound represented by formula (2B²), the compound represented by formula (2C¹), the compound represented by formula (2C²), and the compound that contains the structure represented by formula (2D), combination with the compound represented by formula (E), as the specific silane compound contained in the surface treatment agent, will improve the abrasion resistance of the surface treatment layer.

In a particular case where the underlayer forming composition contains the compound B, combination with the compound represented by formula (E), as the specific silane compound contained in the surface treatment agent, will improve the abrasion resistance of the surface treatment layer.

By thus combining the silane compound contained in the underlayer forming composition, with the surface treatment agent used for forming the surface treatment layer, the abrasion resistance of the surface treatment layer will be improved.

In formula (E), the number of Si atoms contained in (B¹¹)ᵤ₁ is preferably larger than the number of atoms contained in the main chain of A¹³.

The ratio of the number of atoms contained in the main chain of A¹³, to the number of Si atoms contained in (B¹¹)ᵤ₁ is preferably 0.9 or smaller, more preferably 0.6 or smaller, and still more preferably 0.3 or smaller.

The lower limit value of the ratio is, for example, larger than 0.

With the ratio being 0.9 or less, the abrasion resistance of the surface treatment layer will further improve.

The number of atoms contained in the main chain of A¹³ is preferably 1 to 30, more preferably 1 to 15, and still more preferably 1 to 10.

The number of Si atoms contained in (B¹¹)ᵤ₁ is preferably 15 to 100, and more preferably 25 to 70.

In one aspect, the specific silane compound may also be a compound represented by formula (E2).

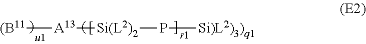

In formula (E2),
each L² independently represents a hydrolyzable group, a group having a hydrolyzable group, a hydroxy group, or a hydrocarbon group;
each of at least four groups of L² among all L² represents a hydrolyzable group, a group having a hydrolyzable group, or a hydroxy group;
each P independently represents an oxygen atom, or an organic group having one carbon atom bound to both neighboring Si; and
each r1 independently represents an integer from 1 to 3.

Definitions of B¹¹, u1, A¹³, and q1 are same as those in formula (B).

Specific aspects of B¹¹, u1, A¹³, and q1 are the same as the specific aspects in formula (E).

Specific aspects of L², P, and r1 are the same as the specific aspects in formula (S3).

In a case where the underlayer forming composition contains the compound A, combination with the compound represented by formula (E2), as the specific silane compound contained in the surface treatment agent, will improve the abrasion resistance of the surface treatment layer.

In a particular case where the compound A is a compound represented by formula (1A¹) (preferably, tetraethoxysilane), combination with the compound represented by formula (E2), as the specific silane compound contained in the surface treatment agent, will improve the abrasion resistance of the surface treatment layer.

In formula (E2), the number of atoms contained in the main chain of A¹³ is preferably larger than the number of Si atoms contained in (B¹¹)ᵤ₁.

The ratio of the number of atoms contained in the main chain of A¹³, to the number of Si atoms contained in (B¹¹)ᵤ₁ is preferably 1.2 or larger, more preferably 2 or larger, and still more preferably 5 or larger.

The upper limit value of the ratio is, for example, 50.

With the ratio being 1.2 or more, the abrasion resistance of the surface treatment layer will further improve.

The number of atoms contained in the main chain of A¹³ is preferably 11 to 60, more preferably 15 to 40, and still more preferably 15 to 30.

The number of Si atoms contained in (B¹¹)ᵤ₁ is preferably 1 to 100, more preferably 2 to 70, and still more preferably 2 to 30. The number of Si atoms contained in (B¹¹)ᵤ₁ may also be 0.

In a case where the underlayer forming composition contains at least one species selected from the group consisting of the compound represented by formula (2B¹), the compound represented by formula (2B²), the compound represented by formula (2C¹), the compound represented by formula (2C²), and the compound that contains the structure represented by formula (2D), combination with the compound represented by formula (E2), as the specific silane compound contained in the surface treatment agent, will improve the abrasion resistance of the surface treatment layer.

In a particular case where the underlayer forming composition contains the compound B, combination with the compound represented by formula (E2), as the specific silane compound contained in the surface treatment agent, will improve the abrasion resistance of the surface treatment layer.

By combining the silane compound contained in the underlayer forming composition and the surface treatment agent used for forming the surface treatment layer as described above, the abrasion resistance of the surface treatment layer is improved.

In formula (E2), the number of Si atoms contained in (B¹¹)ᵤ₁ is preferably larger than the number of atoms contained in the main chain of A¹³.

The ratio of the number of atoms contained in the main chain of A¹³, to the number of Si atoms contained in (B¹¹)ᵤ₁ is preferably 0.9 or smaller, more preferably 0.6 or smaller, and still more preferably 0.3 or smaller.

The lower limit value of the ratio is, for example, larger than 0.

With the ratio being 0.9 or less, the abrasion resistance of the surface treatment layer will further improve.

The number of atoms contained in the main chain of A¹³ is preferably 1 to 30, more preferably 1 to 15, and still more preferably 1 to 10.

The number of Si atoms contained in (B¹¹)ᵤ₁ is preferably 15 to 100, and more preferably 25 to 70.

### [Partial Structures of First Compound, Second Compound, and Compound (E)]

Hereinafter, preferred aspects of A¹¹(Si(R²)ₙL₃₋ₙ)_{q1} in formula (C), A¹²(Si(R²)ₙL₃₋ₙ)_{q1} in formula (D), and A¹³(Si(R²)ₙL₃₋ₙ)_{q1} in formula (E) will be described in detail. Hereinafter, A¹¹(Si(R²)ₙL₃₋ₙ)_{q1} in formula (C), A¹²(Si(R²)ₙL₃₋ₙ)_{q1} in formula (D), and A¹³ (Si(R²)ₙL³⁻ⁿ)_{q1} in formula (E) will collectively be denoted as A(Si(R²)ₙL₃₋ₙ)_{q1}.

Where, A represents a (p1+q1)-valent group for formula (C), A represents a (q1+1)-valent group for formula (D), and A represents a (q1+u1)-valent group for formula (E).

The group represented by A(Si(R²)ₙL₃₋ₙ)_{q1} is preferably group (3-1A) or group (3-1B), and more preferably group (3-1A):

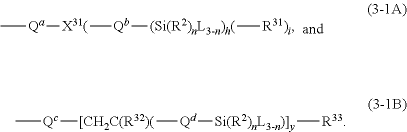

Note definitions of R², L, and n in formulae (3-1A) and (3-1B) are as described above.

In formula (3-1A), Q^{a} represents a single bond or a divalent linking group.

Examples of the divalent linking group include divalent hydrocarbon group, divalent heterocyclic group, —O—, —S—, —SO₂—, —N(R^{d})—, —C(O)—, —Si(Ra)₂—, and group combining two or more of these groups.

The divalent hydrocarbon group may be divalent saturated hydrocarbon group, divalent aromatic hydrocarbon group, alkenylene group, or alkynylene group. The divalent saturated hydrocarbon group may be linear, branched, or cyclic, and is exemplified by alkylene group. The number of carbon atoms in the alkylene group is preferably 1 to 30, more preferably 1 to 20, still more preferably 4 to 20, and particularly preferably 5 to 15. The divalent aromatic hydrocarbon group preferably has 5 to 20 carbon atoms, and is exemplified by phenylene group. Other examples include alkenylene group having 2 to 20 carbon atoms, and alkynylene group having 2 to 20 carbon atoms.

The aforementioned R^{a} represents an alkyl group (preferably having 1 to 10 carbon atoms), or a phenyl group. The aforementioned R^{d} represents a hydrogen atom or an alkyl group (preferably having 1 to 10 carbon atoms).

Examples of the group obtained by combining two or more of them include —OC(O)—, —C(O)O—, —C(O)S—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, alkylene group having —C(O)N(R^{d})—, alkylene group having —N(R^{d})C(O)—, alkylene group having —OC(O)N(R^{d})—, alkylene group having an etheric oxygen atom, alkylene group having —S—, alkylene group having —OC(O)—, alkylene group having —C(O)O—, alkylene group having —C(O)S—, alkylene group having —N(R^{d})—, alkylene group having —N(R^{d})C(O)N(R^{d})—, alkylene group having —SO₂N(R^{d})—, and alkylene group —Si(R^{a})₂-phenylene group-Si(R^{a})₂.

In formula (3-1A), X³¹ represents a single bond, alkylene group, carbon atom, nitrogen atom, silicon atom, 2- to 8-valent organo(poly)siloxane residues, or group having a (h+i+1)-valent ring.

The alkylene group may have —O—, silphenylene skeleton group, divalent organo(poly)siloxane residue, or dialkylsilylene group. The alkylene group may also have a plurality of groups selected from the group consisting of —O—, silphenylene skeleton group, divalent organo(poly)siloxane residue, and dialkylsilylene group.

The number of carbon atoms in the alkylene group represented by X³¹ is preferably 1 to 20, and more preferably 1 to 10.

Examples of the 2- to 8-valent organo(poly)siloxane residues include divalent organo(poly)siloxane residue, and (w2+1)-valent organo(poly)siloxane residue described later.

In a case where X³¹ in formula (3-1A) represents a group having a (h+i+1)-valent ring, Q^{a}, (-Q^{b}-Si(R²)ₙL₃₋ₙ), and R³¹ are directly bound to atoms that constitute the ring. Where, the ring is other than an organopolysiloxane ring.

The ring in X³¹ may be any of monocyclic ring, fused polycyclic ring, bridged ring, spiro ring, and assembled polycyclic ring. Regarding atoms that compose the ring, the ring may also be carbon ring composed only of carbon atoms, or heterocyclic ring composed of hetero atom having a valence of 2 or larger and carbon atoms. The bond between atoms that constitute the ring may be a single bond or a multiple bond. Further, the ring may be an aromatic ring or a non-aromatic ring.

The monocyclic ring is preferably any of 4-membered ring to 8-membered rings, and more preferably 5-membered ring or 6-membered ring. The fused polycyclic ring is preferably the one having fused therein two or more 4-membered to 8-membered rings, and more preferably the one having fused therein two or three rings selected from 5-membered and 6-membered rings, or the one having one or two rings selected from 5-membered and 6-membered rings, fused with one 4-membered ring. The bridged ring is preferably the one having a 5-membered ring or a 6-membered ring as the largest ring, meanwhile the spiro ring is preferably the one composed of two of 4-membered to 6-membered rings. The assembled polycyclic ring is preferably the one having two or three rings selected from 5-membered and 6-membered rings, which are bound via a single bond, 1 to 3 carbon atoms, or one heteroatom having a valence of 2 or 3. In the assembled polycyclic ring, each ring preferably has any of Q^{a}, (-Q^{b}-Si(R²)ₙL₃₋ₙ) or R³¹ (where i=1 or larger) bound thereto.

The hetero atom that constitutes the ring is preferably nitrogen atom, oxygen atom, and sulfur atom, and more preferably nitrogen atom and oxygen atom. The number of heteroatoms that constitute the ring is preferably 3 or smaller. In a case where the number of heteroatoms that constitute the ring is two or larger, these heteroatoms may be different.

The ring for X³¹ is preferably one species selected from the group consisting of 3- to 8-membered aliphatic rings, benzene ring, 3- to 8-membered heterocyclic rings, fused ring having two or three of these rings fused therein, bridged ring having a 5-membered or a 6-membered ring as the largest ring, and assembled polycyclic ring having two or more of these rings, and having one species of linking group selected from single bond, alkylene group having 3 or less carbon atoms, oxygen atom, and sulfur atom, from the viewpoint of ease of production of the compound, and more excellent abrasion resistance of the surface treatment layer.

Preferred rings include benzene ring, 5-membered or 6-membered aliphatic ring, 5-membered or 6-membered heterocycle having nitrogen atom or oxygen atom, and fused ring having 5-membered or 6-membered carbon ring fused with any of 4- to 6-membered heterocycles.

Specific examples of the ring include the rings listed below, 1,3-cyclohexadiene ring, 1,4-cyclohexadiene ring, anthracene ring, cyclopropane ring, decahydronaphthalene ring, norbornene ring, norbornadiene ring, furan ring, pyrrole ring, thiophene ring, pyrazine ring, morpholine ring, aziridine ring, isoquinoline ring, oxazole ring, isoxazole ring, thiazole ring, imidazole ring, pyrazole ring, pyran ring, pyridazine ring, pyrimidine ring, and indene ring. Also rings having an oxo group (═O) are listed below.

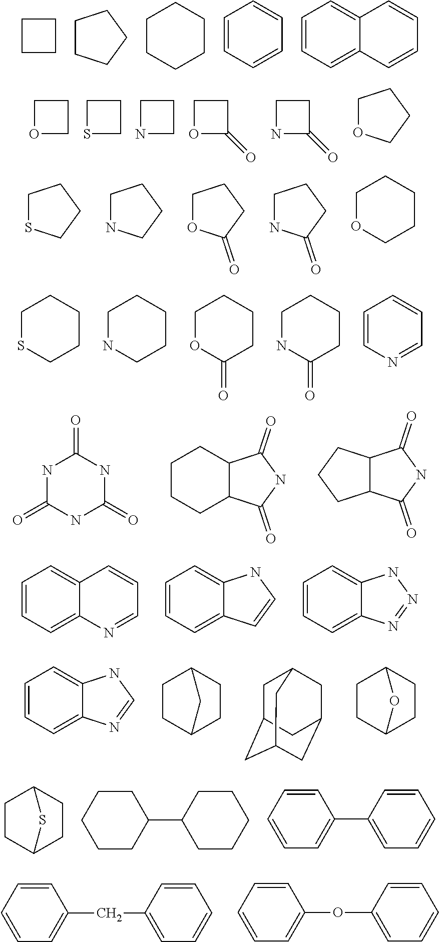

Bond of ring-constituting atom, which does not constitute the ring, in X³¹ is a bond bound to Q^{a}, (-Q^{b}-Si(R²)ₙL₃₋ₙ), or R³¹. Any residual bond, if present, is bound to a hydrogen atom or a substituent. Examples of the substituent include halogen atom, alkyl group (etheric oxygen atom may be contained between the carbon-carbon atoms), cycloalkyl group, alkenyl group, allyl group, alkoxy group, and oxo group (═O).

In a case where one of the carbon atoms that constitute the ring has two bonds bound to Q^{a}, (-Q^{b}-Si(R²)ₙL₃₋ₙ), or R³¹, such Q^{a} and (-Q^{b}-Si(R²)ₙL₃₋ₙ) may be bound to the one carbon atom, or two groups of (-Q^{b}-Si(R²)ₙL₃₋ₙ) may be bound thereto. Q^{a} is preferably bound to a ring member atom different from that having (-Q^{b}-Si(R²)ₙL₃₋ₙ) or R³¹ bound thereto. Each of h groups of (-Q^{b}-Si(R²)ₙL₃₋ₙ) may be bound to different ring member atoms, wherein two groups thereof may be bound to one carbon atom that constitutes the ring. Moreover, there may be two or more carbon atoms that constitute the ring, each having two groups of (-Q^{b}-Si(R²)ₙL₃₋ₙ) bound thereto. Each of i groups of R³¹ may be bound to different ring member atoms, wherein two groups thereof may be bound to one carbon atom that constitutes the ring. Moreover, there may be two or more carbon atoms that constitute the ring, each having two groups of R³¹ bound thereto.

In particular from the viewpoint of improving the abrasion resistance of the surface treatment layer, X³¹ preferably represents a carbon atom, nitrogen atom, silicon atom, 4- to 8-valent organo(poly)siloxane residue, or group having (h+i+1)-valent ring. Carbon atom is more preferred.

In formula (3-1A), Q^{b} represents a single bond or a divalent linking group.

The definition of the divalent linking group is the same as the aforementioned definition regarding Q^{a}.

In particular, Q^{b} preferably represents an alkylene group optionally having an etheric oxygen atom. The number of carbon atoms in the alkylene group is preferably 1 to 30, more preferably 1 to 20, still more preferably 2 to 20, may be 2 to 10, may be 2 to 6, and may be 2 to 5. For example, examples include 2, 3, 8, 9, or 11. The number of carbon atoms may alternatively be 1 to 10.

In formula (3-1A), R³¹ represents a hydrogen atom, a hydroxy group, or an alkyl group.

The number of carbon atoms in the alkyl group is preferably from 1 to 5, more preferably 1 to 3, and still more preferably 1.

If X³¹ represents a single bond or an alkylene group, h represents 1, and i represents 0;
if X³¹ represents a nitrogen atom, h represents an integer of 1 or 2, i represents an integer of 0 or 1, and h+i=2 holds;
if X³¹ represents a carbon atom or a silicon atom, h represents an integer from 1 to 3, i represents an integer from 0 to 2, and h+i=3 holds; and
if X³¹ represents a 2- to 8-valent organo(poly)siloxane residues, h represents an integer from 1 to 7, i represents an integer from 0 to 6, and h+i=1 to 7 holds.

In a case where X³¹ represents a group having a (h+i+1)-valent ring, h represents an integer from 1 to 7, i represents an integer from 0 to 6, and h+i=1 to 7 holds.

In a case where two or more (-Q^{b}-Si(R)ₙL₃₋ₙ) are present, the two or more (-Q^{b}-Si(R)ₙL₃₋ₙ) may be the same or different. In a case where two or more R³¹ are present, the two or more (—R³¹) may be the same or different.

In particular, i preferably represents 0, from the viewpoint of improving the abrasion resistance of the surface treatment layer.

In formula (3-1B), Q^{c} represents a single bond or a divalent linking group.

The definition of the divalent linking group is the same as the aforementioned definition regarding Q^{a}.

In formula (3-1B), R³² represents a hydrogen atom or an alkyl group having 1 to 10 carbon atoms, and preferably represents a hydrogen atom, from the viewpoint of ease of production of the compound.

The alkyl group is preferably a methyl group.

In formula (3-1B), Q^{d} represents a single bond or an alkylene group. The number of carbon atoms in the alkylene group is preferably 1 to 10, and more preferably 1 to 6. From the viewpoint of ease of production of the compound, Q^{d} preferably represents a single bond or CH₂—.

In formula (3-1B), R³³ represents a hydrogen atom or a halogen atom, and preferably represents a hydrogen atom, from the viewpoint of ease of production of the compound.

y represents an integer from 1 to 10, and preferably represents an integer from 1 to 6. Two or more [CH₂C(R³²)(-Q^{d}-Si(R²)ₙL₃₋ₙ)] may be the same or different.

Group (3-1A) is preferably groups (3-1A-1) to (3-1A-7).

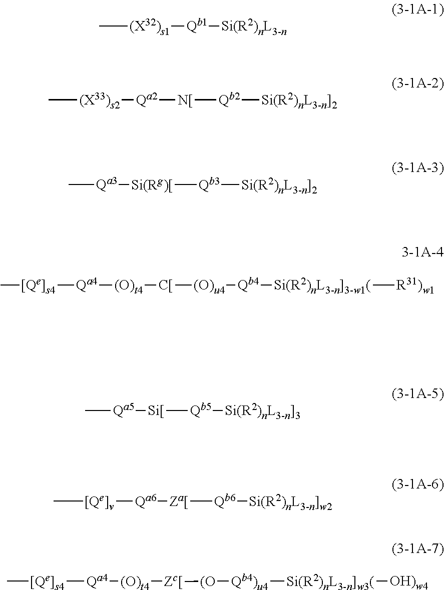

Note, definitions of R², L, and n in formulae (3-1A-1) to (3-1A-7) are as described above.

In particular, group (3-1A) is preferably group (3-1A-4).

In group (3-1A-1), X³² represents —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d}); or combination of any of these groups with a divalent linking group (where, N in the formula is bound to Q^{b1}).

The definition of R^{d} is as described above.

s1 represents 0 or 1.

In a case where X³² is given by combination of —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})—, with the divalent linking group, such divalent linking group is bound to Si(R³)₂ or Si(R^{d})₂ in formula (C) or (D), or, B¹¹ in formula (E).

Examples of the divalent linking group include alkylene group, organo(poly)siloxane residue, polyalkylene oxide group, and any combination thereof.

Q^{b1} represents a single bond or an alkylene group. The alkylene group may have —O—, silphenylene skeleton group, or dialkylsilylene group. The alkylene group may also have a plurality of groups selected from the group consisting of —O—, silphenylene skeleton group, divalent organo(poly)siloxane residue, and dialkylsilylene group.

The alkylene group, if having —O—, silphenylene skeleton group, divalent organo(poly)siloxane residue or dialkylsilylene group, preferably has any of these groups between the carbon-carbon atoms.

The number of carbon atoms in the alkylene group represented by Q^{b1} is preferably 1 to 30, more preferably 1 to 20, still more preferably 2 to 20, and particularly preferably 2 to 6. The number of carbon atoms may alternatively be 1 to 10.

In group (3-1A-2), X³³ represents —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})—; or combination of any of these groups with a divalent linking group.

The definition of R^{d} is as described above.

s2 represents 0 or 1. s2 preferably represents 0, from the viewpoint of ease of production of the compound.

In a case where X³³ is given by combination of —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})—, with the divalent linking group, such divalent linking group is bound to Si(R³)₂ or Si(R^{d})₂ in formula (C) or (D), or, B¹¹ in formula (E).

Examples of the divalent linking group include alkylene group, organo(poly)siloxane residue, polyalkylene oxide group, and any combination thereof.

Q^{a2} represents a single bond, alkylene group, —C(O)—, or group having an etheric oxygen atom, —C(O)—, —C(O)O—, —OC(O)—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, —C(O)N(R^{d})—, or —NH—, between the carbon-carbon atoms of an alkylene group having two or more carbon atoms.

The number of carbon atoms in the alkylene group represented by Q^{a2} is preferably 1 to 20, more preferably 1 to 10, still more preferably 1 to 6, and particularly preferably 1 to 3.

The number of carbon atoms in the group, having an etheric oxygen atom, —C(O)—, —C(O)O—, —OC(O)—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, —C(O)N(R^{d})—, or —NH—, between the carbon-carbon atoms of an alkylene group having two or more carbon atoms represented by Q^{a2}, is preferably 2 to 10, and more preferably 2 to 6.

Q^{a2} preferably represents a single bond, from the viewpoint of ease of production of the compound.

Q^{b2} represents an alkylene group, or a group having a divalent organo(poly)siloxane residue, an etheric oxygen atom, or —NH—, between the carbon-carbon atoms of an alkylene group having two or more carbon atoms.

The number of carbon atoms in the alkylene group represented by Q^{b2} is preferably 1 to 30, more preferably 1 to 20, still more preferably 2 to 20, may be 2 to 10, and may be 2 to 6. For example, examples include 2, 3, 8, 9, or 11. The number of carbon atoms may alternatively be 1 to 10.

The number of carbon atoms in the group, having a divalent organo(poly)siloxane residue, an etheric oxygen atom, or —NH—, between the carbon-carbon atoms of the alkylene group having two or more carbon atoms represented by Q^{b2}, is preferably 2 to 10, and more preferably 2 to 6.

Q^{b2} preferably represents —CH₂CH₂CH₂— or —CH₂CH₂OCH₂CH₂CH₂—, from the viewpoint of ease of production of the compound (where, the right side is bound to Si).

The two groups of [-Q^{b2}-Si(R²)ₙL₃₋ₙ] may be the same or different.

In group (3-1A-3), Q^{a3} represents a single bond, or an alkylene group optionally having an etheric oxygen atom. From the viewpoint of ease of production of the compound, Q^{a3} preferably represents a single bond.

The number of carbon atoms in the alkylene group optionally having an etheric oxygen atom is preferably 1 to 10, and particularly preferably 2 to 6.

R^{g} represents a hydrogen atom, hydroxy group, or alkyl group.

R^{g} preferably represents a hydrogen atom or an alkyl group, from the viewpoint of ease of production of the compound. The number of carbon atoms in the alkyl group is preferably 1 to 10, and more preferably 1 to 4. Methyl group is further preferred.

Q^{b3} represents an alkylene group, or a group having an etheric oxygen atom or a divalent organo(poly)siloxane residue between the carbon-carbon atoms of an alkylene group having two or more carbon atoms.

The number of carbon atoms in the alkylene group represented by Q^{b3} is preferably 1 to 30, more preferably 1 to 20, still more preferably 2 to 20, may be 2 to 10, and may be 2 to 6. For example, examples include 2, 3, 8, 9, or 11. The number of carbon atoms may alternatively be 1 to 10.

The number of carbon atoms in the group, having an etheric oxygen atom or a divalent organo(poly)siloxane residue, between the carbon-carbon atoms of the alkylene group having two or more carbon atoms represented by Q^{b3}, is preferably 2 to 20, more preferably 2 to 10, and still more preferably 2 to 6.

Q^{b3} preferably represents —CH₂CH₂—, —CH₂CH₂CH₂—, or —CH₂CH₂CH₂CH₂CH₂CH₂CH₂CH₂—, from the viewpoint of ease of production of the compound.

The two groups of [-Q^{b3}-Si(R²)ₙL₃₋ₙ] may be the same or different.

In group (3-1A-4), Q^{c} represents —C(O)O—, —SO₂N(R^{d})—, —N(R^{d})SO₂—, —N(R^{d})C(O)—, or —C(O)N(R^{d}); or combination of any of these groups with a divalent linking group.

In a case where Q^{c} is given by combination of —C(O)O—, —SO₂N(R^{d})—, —N(R^{d})SO₂—, —N(R^{d})C(O)—, or —C(O)N(R^{d})—, with the divalent linking group, such divalent linking group is bound to Si(R³)₂ or Si(R^{d})₂ in formula (C) or (D), or, B¹¹ in formula (E).

Examples of the divalent linking group include alkylene group, organo(poly)siloxane residue, polyalkylene oxide group, and any combination thereof.

The definition of R³¹ is as described above. In a case where w1 represents 1 or 2, R³¹ preferably represents a hydrogen atom.

s4 represents 0 or 1.

Q^{a4} represents a single bond, or an alkylene group optionally having an etheric oxygen atom.

The number of carbon atoms in the alkylene group optionally having an etheric oxygen atom is preferably 1 to 20, more preferably 1 to 10, still more preferably 1 to 6, and particularly preferably 1 to 3.

t4 represents 0 or 1 (and 0, if Q^{a4} represents a single bond).

From the viewpoint of ease of production of the compound, -Q^{a4}-(O)ₜ₄—, if s4 represents 0, preferably represents a single bond, —CH₂O—, —CH₂OCH₂—, —CH₂OCH₂CH₂O—, —CH₂OCH₂CH₂OCH₂—, or —CH₂OCH₂CH₂CH₂CH₂OCH₂—; and if s4 represents 1, preferably represents a single bond, —CH₂—, or —CH₂CH₂—.

Q^{b4} represents an alkylene group. The alkylene group may have —O—, —C(O)N(R^{d})— (the definition of R^{d} is as described above), silphenylene skeleton group, divalent organo(poly)siloxane residue, or dialkylsilylene group.

The alkylene group, if having —O— or silphenylene skeleton group, preferably has the —O— or the silphenylene skeleton between the carbon-carbon atoms. The alkylene group, if having —C(O)N(R^{d})—, dialkylsilylene group or divalent organo(poly)siloxane residue, preferably has any of these groups between the carbon-carbon atoms, or at the terminal on the side bound to (O)ᵤ₄.

The number of carbon atoms in the alkylene group represented by Q^{b4} is preferably 1 to 30, more preferably 1 to 20, still more preferably 2 to 20, may be 2 to 10, and may be 2 to 6. For example, examples include 2, 3, 8, 9, or 11. The number of carbon atoms may alternatively be 1 to 10.

u4 represents 0 or 1.

From the viewpoint of ease of production of the compound, —(O)ᵤ₄-Q^{b4}-preferably represents —CH₂CH₂—, —CH₂CH₂CH₂—, —CH₂OCH₂CH₂CH₂—, —CH₂OCH₂CH₂CH₂CH₂CH₂—, —OCH₂CH₂CH₂—, —OSi(CH₃)₂CH₂CH₂CH₂—, —OSi(CH₃)₂OSi(CH₃)₂CH₂CH₂CH₂—, or —CH₂CH₂CH₂Si(CH₃)₂PhSi(CH₃)₂CH₂CH₂— (where the right side is bound to Si).

w1 represents an integer from 0 to 2, preferably 0 or 1, and more preferably 0.

In a case where two or more [—(O)ᵤ₄-Q^{b4}-Si(R²)ₙL₃₋ₙ] are present, the two or more [—(O)ᵤ₄-Q^{b4}-Si(R²)ₙL₃₋ₙ] may be the same or different.

In a case where two or more R³¹ are present, the two or more (—R³¹) may be the same or different.

In group (3-1A-5), Q^{a5} represents an alkylene group optionally having an etheric oxygen atom.

The number of carbon atoms in the alkylene group optionally having an etheric oxygen atom is preferably 1 to 10, and particularly preferably 2 to 6.

From the viewpoint of ease of production of the compound, Q^{a3} preferably represents —OCH₂CH₂CH₂—, —OCH₂CH₂OCH₂CH₂CH₂—, —CH₂CH₂—, or —CH₂CH₂CH₂— (where, the right side is bound to Si).

Q^{b5} represents an alkylene group, or a group having an etheric oxygen atom or a divalent organo(poly)siloxane residue between the carbon-carbon atoms of an alkylene group having two or more carbon atoms.

The number of carbon atoms in the alkylene group represented by Q^{b5} is preferably 1 to 30, more preferably 1 to 20, still more preferably 2 to 20, may be 2 to 10, and may be 2 to 6. For example, examples include 2, 3, 8, 9, or 11. The number of carbon atoms may alternatively be 1 to 10.

The number of carbon atoms in the group, having an etheric oxygen atom or a divalent organo(poly)siloxane residue, between the carbon atoms of the alkylene group having two or more carbon atoms represented by Q^{b5}, is preferably 2 to 20, more preferably 2 to 10, and still more preferably 2 to 6.

From the viewpoint of ease of production of the compound, Q^{b5} preferably represents —CH₂CH₂CH₂— or —CH₂CH₂OCH₂CH₂CH₂— (where, the right side is bound to Si(R²)ₙL₃₋ₙ).

Three groups of [-Q^{b5}-Si(R²)ₙL₃₋ₙ] may be the same or different.

The definition of Q^{c} in group (3-1A-6) is as defined for the aforementioned group (3-1A-4).

v represents 0 or 1.

Q^{a6} represents an alkylene group optionally having an etheric oxygen atom.

The number of carbon atoms in the alkylene group optionally having an etheric oxygen atom is preferably 1 to 10, and particularly preferably 2 to 6.

From the viewpoint of ease of production of the compound, Q^{a6} preferably represents —CH₂OCH₂CH₂CH₂—, —CH₂OCH₂CH₂OCH₂CH₂CH₂—, —CH₂CH₂—, or —CH₂CH₂CH₂— (where the right side is bound to Z^{a}).

Z^{a} represents a (w2+1)-valent organo(poly)siloxane residue, or a group having a valence of (w2+1), and having an alkylene group between the organo(poly)siloxane residue and organo(poly)siloxane residue.

w2 represents an integer from 2 to 7.

The (w2+1)-valent organo(poly)siloxane residue, and the group having a valence of (w2+1), and having an alkylene group between the organo(poly)siloxane residue and organo(poly)siloxane residue, are exemplified by the groups below. Where, R^{a} in the following formulae is as described above. * Indicates a binding site.

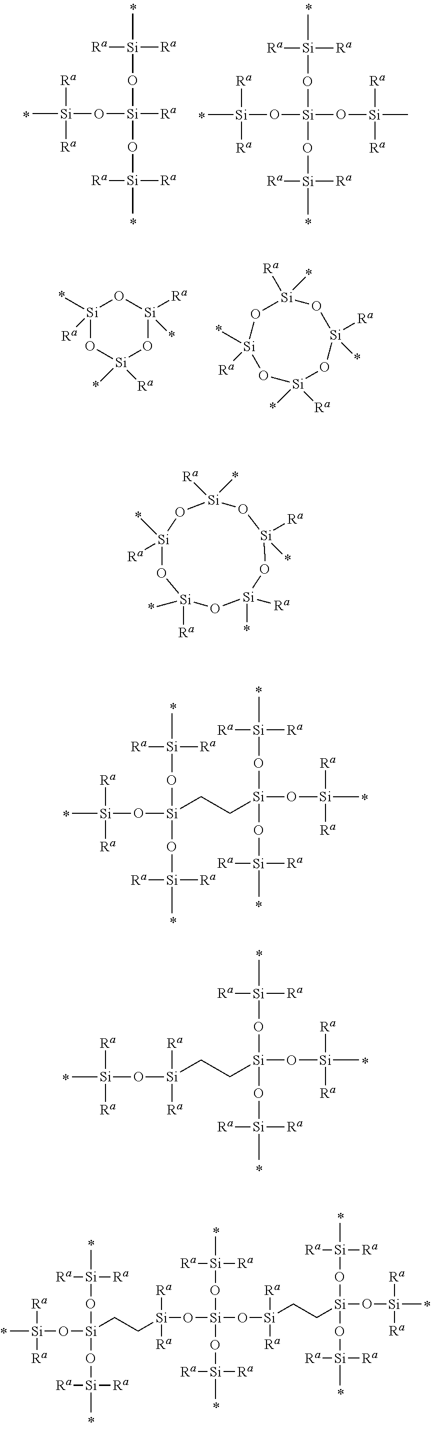

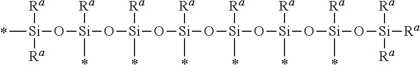

Q^{b6} represents an alkylene group, or a group having an etheric oxygen atom or a divalent organo(poly)siloxane residue between the carbon-carbon atoms of an alkylene group having two or more carbon atoms.

The number of carbon atoms in the alkylene group represented by Q^{b6} is preferably 1 to 30, more preferably 1 to 20, still more preferably 2 to 20, may be 2 to 10, and may be 2 to 6. For example, examples include 2, 3, 8, 9, or 11. The number of carbon atoms may alternatively be 1 to 10.

The number of carbon atoms in the group, having an etheric oxygen atom or a divalent organo(poly)siloxane residue, between the carbon-carbon atoms of the alkylene group having two or more carbon atoms represented by Q^{b6}, is preferably 2 to 20, more preferably 2 to 10, and still more preferably 2 to 6.

From the viewpoint of ease of production of the compound, Q^{b6} preferably represents —CH₂CH₂— or —CH₂CH₂CH₂—.

w2 groups of [-Q^{b6}-Si(R²)ₙL₃₋ₙ] may be the same or different.

In group (3-1A-7), Ze represents a (w3+w4+1)-valent hydrocarbon group.

w3 represents an integer of 4 or larger.

w4 represents an integer of 0 or larger.

The definitions and preferred ranges of Q^{c}, s4, Q^{a4}, t4, Q^{b4}, and u4 are the same as the definitions of the respective reference signs in group (3-1A-4).

Z^{e} may be composed of a hydrocarbon chain, may have an etheric oxygen atom between the carbon-carbon atoms of the hydrocarbon chain, and is preferably composed of a hydrocarbon chain.

The valence of Z^{e} is preferably 5 to 20, more preferably 5 to 10, still more preferably 5 to 8, and particularly preferably 5 to 6.

The number of carbon atoms in Z^{e} is preferably 3 to 50, more preferably 4 to 40, and still more preferably 5 to 30.

w3 preferably represents 4 to 20, more preferably 4 to 16, still more preferably 4 to 8, and particularly preferably 4 to 5.

w4 preferably represents 0 to 10, more preferably 0 to 8, still more preferably 0 to 6, particularly preferably 0 to 3, and most preferably 0 to 1.

In a case where two or more [—(O-Q^{b4})ᵤ₄-Si(R²)ₙL₃₋ₙ] are present, the two or more [—(O-Q^{b4})ᵤ₄-Si(R²)ₙL₃₋ₙ] may be the same or different.

A in formula A(Si(R²)ₙL₃₋ₙ)_{q1} may be groups (g2-1) to (g2-7).

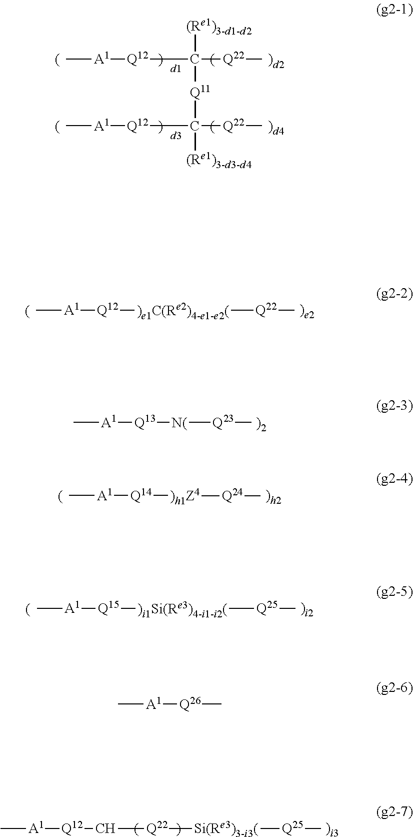

Where, in each of formulae (g2-1) to (g2-7), A¹ is given on the side bound to Si(R³)₂ or Si(R^{d})₂, meanwhile Q²², Q²³, Q²⁴, Q²⁵ or Q²⁶ is given on the side bound to [—Si(R²)ₙL₃₋ₙ].

A¹ represents a single bond, —C(O)NR⁶—, —C(O)—, —OC(O)O—, —NHC(O)O—, —NHC(O)NR⁶—, —O— or SO₂NR⁶—.

Q¹¹ represents a single bond, —O—, alkylene group, or a group having —C(O)NR⁶—, —C(O)—, —NR⁶—, or O— between the carbon-carbon atoms of an alkylene group having two or more carbon atoms.

Q¹² represents a single bond, an alkylene group, or a group having —C(O)NR⁶—, —C(O)—, —NR⁶—, or O-between the carbon-carbon atoms of an alkylene group having two or more carbon atoms. In a case where A has two or more Q¹², such two or more Q¹² may be the same or different.

Q¹³ represents a single bond (where, A¹ represents —C(O)—), an alkylene group, a group having —C(O)NR⁶—, —C(O)—, —NR⁶—, or O— between the carbon-carbon atoms of an alkylene group having two or more carbon atoms, or a group having —C(O)— at the N-side terminal of an alkylene group.

Q¹⁴ equals to Q¹² if the atom in Z⁴ to which Q¹⁴ is bound is a carbon atom, and equals to Q¹³ if the atom in Z⁴ to which Q¹⁴ is bound is a nitrogen atom. In a case where A has two or more Q¹⁴, such two or more Q¹⁴ may be the same or different.

Q¹⁵ represents an alkylene group, or a group having —C(O)NR⁶—, —C(O)—, —NR⁶—, or O— between the carbon-carbon atoms of an alkylene group having two or more carbon atoms. In a case where A has two or more Q¹⁵, such two or more Q¹⁵ may be the same or different.

Q²² represents an alkylene group; a group having —C(O)NR⁶—, —C(O)—, —NR⁶—, or O— between the carbon-carbon atoms of an alkylene group having two or more carbon atoms; a group having —C(O)NR⁶—, —C(O)—, —NR⁶—, or O— at the terminal of the alkylene group on the side not bound to Si; or a group having —C(O)NR⁶—, —C(O)—, —NR⁶—, or O— between the carbon-carbon atoms of an alkylene group having two or more carbon atoms, as well as having —C(O)NR⁶—, —C(O)—, —NR⁶—, or O— at the terminal on the side not bound to Si. In a case where A has two or more Q²², such two or more Q²² may be the same or different.

Q²³ represents an alkylene group, or a group having —C(O)NR⁶—, —C(O)—, —NR⁶—, or O— between the carbon-carbon atoms of an alkylene group having two or more carbon atoms, wherein two groups of Q²³ may be the same or different.

Q²⁴ equals to Q²² if the atom in Z⁴ to which Q²⁴ is bound is a carbon atom, meanwhile equals to Q²³ if the atom in Z⁴ to which Q²⁴ is bound is a nitrogen atom. In a case where A has two or more Q²⁴, such two or more Q²⁴ may be the same or different.

Q²⁵ represents an alkylene group, or a group having —C(O)NR⁶—, —C(O)—, —NR⁶— or O— between the carbon-carbon atoms of an alkylene group having two or more carbon atoms. In a case where A has two or more Q²⁵, such two or more Q²⁵ may be the same or different.

Q²⁶ represents an alkylene group, or a group having —C(O)NR⁶—, —C(O)—, —NR⁶—, or O— between the carbon-carbon atoms of an alkylene group having two or more carbon atoms.

In a case where each of Q²², Q²³, Q²⁴, Q²⁵, and Q²⁶ represents an alkylene group, the number of carbon atoms is preferably 1 to 20, more preferably 1 to 10, and still more preferably 1 to 6.

Z⁴ represents a group having a (h1+h2)-valent ring structure which has a carbon atom or a nitrogen atom to which Q¹⁴ is directly bound, and has a carbon atom or a nitrogen atom to which Q²⁴ is directly bound.

R^{e1} represents a hydrogen atom or an alkyl group. In a case where A has two or more R^{e1}, such two or more R^{e1} may be the same or different.

R^{e2} represents a hydrogen atom, hydroxy group, alkyl group, or acyloxy group.

R^{e3} represents an alkyl group. R⁶ represents a hydrogen atom, alkyl group having 1 to 6 carbon atoms, or phenyl group.

d1 represents an integer from 0 to 3, which is preferably 1 or 2.

d2 represents an integer from 0 to 3, which is preferably 1 or 2.

d1+d2 represents an integer from 1 to 3.

d3 represents an integer from 0 to 3, which is preferably 0 or 1.

d4 represents an integer from 0 to 3, which is preferably 2 or 3.

d3+d4 represents an integer from 1 to 3.

d1+d3 represents an integer from 1 to 5, which is preferably 1 or 2.

d2+d4 represents an integer from 1 to 5, which is preferably 4 or 5.

e1+e2 represents 3 or 4.

e1 represents an integer from 1 to 3, which is preferably 1 or 2.

e2 represents an integer from 1 to 3, which is preferably 2 or 3.

h1 represents an integer of 1 or larger, which is preferably 1 or 2.

h2 represents an integer of 1 or larger, which is preferably 2 or 3.

i1+i2 represents 3 or 4.

i1 represents an integer from 1 to 3, which is preferably 1 or 2.

i2 represents an integer from 1 to 3, which is preferably 2 or 3.

i3 represents 2 or 3.

The number of carbon atoms in the alkylene groups represented by Q¹¹, Q¹², Q¹³, Q¹⁴, Q¹⁵, Q²², Q²³, Q²⁴, Q²⁵, and Q²⁶ is preferably 1 to 30, more preferably 1 to 20, still more preferably 2 to 20, may be 2 to 10, and may be 2 to 6, from the viewpoint of ease of production of the compound, and further excellence in the abrasion resistance of the surface treatment layer. For example, examples include 2, 3, 8, 9, or 11. The number of carbon atoms may alternatively be 1 to 10, may be 1 to 6, or may be 1 to 4. Where, in a case where the specific bond is present between the carbon-carbon atoms, the lower limit value of the number of carbon atoms in the alkylene group is 2.

Examples of the ring structure in Z⁴ include the ring structures described above. The same will apply to the preferred aspects. Q¹⁴ and Q²⁴ are directly bound to the ring structure in Z⁴. In a case where an alkylene group is bound to the ring structure, therefore Q¹⁴ and Q²⁴ are not bound to the alkylene group.

The number of carbon atoms in the alkyl group represented by R^{e1}, R^{e2}, or R^{e3} is preferably 1 to 6, more preferably 1 to 3, and particularly preferably 1 or 2, from the viewpoint of ease of production of the compound.

The number of carbon atoms in an alkyl group moiety of acyloxy group represented by R^{e2} is preferably 1 to 6, more preferably 1 to 3, and particularly preferably 1 or 2, from the viewpoint of ease of production of the compound.

From the viewpoint of ease of production of the compound, and further excellence in the abrasion resistance of the surface treatment layer, h1 preferably represents 1 to 6, more preferably 1 to 4, still more preferably 1 or 2, and particularly preferably 1.

From the viewpoint of ease of production of the compound, and further excellence in the abrasion resistance of the surface treatment layer, h2 preferably represents 2 to 6, more preferably 2 to 4, and particularly preferably 2 or 3.

Examples of another aspect of A in formula A(Si(R²)ₙL₃₋ₙ)_{q1} include groups (g2-8) to (g2-14).

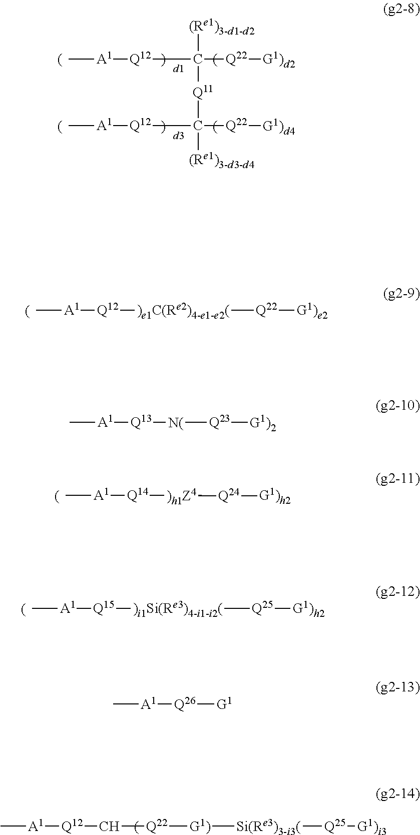

Where, in each of formulae (g2-8) to (g2-14), A¹ is given on the side bound to Si(R³)₂ or Si(R^{d})₂, meanwhile G1 is given on the side bound to [—Si(R²)ₙL₃₋ₙ].

G1 represents group (g3) below. Two or more G1 present in A may be the same or different. Reference signs other than G1 are the same as the reference signs in formulae (g2-1) to (g2-7).

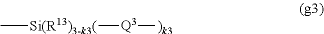

Where, in group (g3), Si is given on the side bound to Q²², Q²³, Q²⁴, Q²⁵, or Q²⁶ meanwhile Q³ is given on the side bound to [—Si(R²)ₙL₃₋ₙ]. R¹³ represents an alkyl group. Q³ represents an alkylene group, a group having —C(O)NR⁶—, —C(O)—, —NR⁶— or O— between the carbon-carbon atoms of an alkylene group having two or more carbon atoms, or (OSi(R⁹)₂)ₚ—O—. Two or more Q³ may be the same or different. k3 represents 2 or 3. R⁶ represents a hydrogen atom, alkyl group having 1 to 6 carbon atoms, or phenyl group. R⁹ represents an alkyl group, phenyl group, or alkoxy group. Two groups of R⁹ may be the same or different. p represents an integer from 0 to 5. If p represents 2 or larger, two or more (OSi(R⁹)₂) may be the same or different.

The number of carbon atoms in the alkylene group represented by Q³ is preferably 1 to 30, more preferably 1 to 20, still more preferably 2 to 20, may be 2 to 10, and may be 2 to 6, from the viewpoint of ease of production of the compound, and further excellence in the abrasion resistance of the surface treatment layer. For example, examples include 2, 3, 8, 9, or 11. The number of carbon atoms may alternatively be 1 to 10, may be 1 to 6, or may be 1 to 4. Where, in a case where the specific bond is present between the carbon-carbon atoms, the lower limit value of the number of carbon atoms in the alkylene group is 2.

The number of carbon atoms in the alkyl group represented by R¹³ is preferably 1 to 6, more preferably 1 to 3, and particularly preferably 1 or 2, from the viewpoint of ease of production of the compound.

The number of carbon atoms in the alkyl group represented by R⁹ is preferably 1 to 6, more preferably 1 to 3, and particularly preferably 1 or 2, from the viewpoint of ease of production of the compound.

The number of carbon atoms in the alkoxy group represented by R⁹ is preferably 1 to 6, more preferably 1 to 3, and particularly preferably 1 or 2, from the viewpoint of excellence in shelf stability of the compound.

p preferably represents 0 or 1.

### [Examples of First Compound and Second Compound]

Hereinafter, specific examples of the first compound and the second compound will be described in detail.

Specific examples of the first compound include compounds (1) to (3), (4A), and (5) below.

Specific examples of the second compound include compound (4B) below.

### Compound (1)

A compound that contains group 1a below, a chain organo(poly)siloxane residue, a partial structure which is an alkylene chain having three or more carbon atoms or a polyalkylene oxide chain, and group 1b below.

Group 1a: -M¹T¹₃

Group 1b: —Si(R²)ₙL₃₋ₙ
M¹ represents Si, Sn, or Ge;
each T¹ independently represents a hydrocarbon group or a trialkylsilyloxy group;
each R² independently represents a monovalent hydrocarbon group;
each L independently represents a hydrolyzable group, a group having a hydrolyzable group, or a hydroxy group; and
each n independently represents an integer from 0 to 2.
R², L, and n are the same as R², L, and n in formula (S1) above.

Details of group 1a are the same as details of T¹₃M¹- in the description regarding T¹¹ in formula (C).

### Compound (2)

A compound that contains an alkyl group having two or more carbon atoms, a chain organo(poly)siloxane residue, and a reactive silyl group.

### Compound (3)

A compound that contains group 3a below, a partial structure that contains a divalent chain organo(poly)siloxane residue, and group 3b below, wherein the partial structure is a divalent chain organo(poly)siloxane residue, or a combination of a divalent chain organo(poly)siloxane residue with at least either an alkylene chain or a polyalkylene oxide chain.

Group 3a: monovalent cyclic polysiloxane residue, or monovalent cage-like polysiloxane residue

Group 3b: —Si(R²)ₙL₃₋ₙ
Each R² independently represents a monovalent hydrocarbon group;
each L independently represents a hydrolyzable group, a group having a hydrolyzable group, or a hydroxy group; and
each n independently represents an integer from 0 to 2.
R², L, and n are the same as R², L, and n in formula (S1) above.

### Compounds (4A) and (4B)

Compounds represented by formula (4A) or (4B) below:

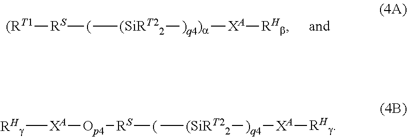

In formulae (4A) and (4B),
each R^{S} independently represents a divalent linear organosiloxane group;
each R^{T1} independently represents a hydrocarbon group;
each R^{T2} independently represents a hydrocarbon group;
p4 represents 0 or 1;
each q4 independently represents 0 or 1;
R^{H} is a group represented by any one of formulae (W1) to (W4) below;
the R^{H} has contained therein two or more Si atoms to which a hydroxy group or a hydrolyzable group is bound;
each X^{A} independently represents a single bond or a group represented by formula (W5) below;
α represents an integer from 1 to 9;
β represents an integer from 1 to 9; and
each γ independently represents an integer from 1 to 9.

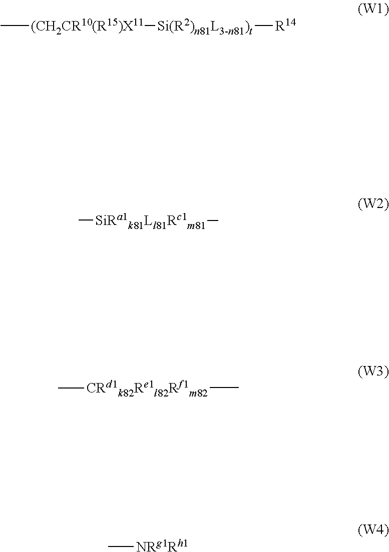

In formulae (W1) to (W4),
each L independently represents a hydrolyzable group, a group having a hydrolyzable group, or a hydroxy group;
each R² independently represents a monovalent hydrocarbon group;
each n81 independently represents an integer from 0 to 3 for each (SiR²ₙ₈₁L₃₋ₙ₈₁) unit;
each X¹¹ independently represents a single bond or a divalent organic group;
each R¹⁰ independently represents a hydrogen atom or a monovalent organic group;
each t independently represents an integer of 2 or larger;
each R¹⁴ independently represents a hydrogen atom, halogen atom, or —X¹¹—Si(R²)ₙ₈₁L₃₋ₙ₈₁,
each R¹⁵ independently represents a single bond, oxygen atom, alkylene group having 1 to 6 carbon atoms, or alkyleneoxy group having 1 to 6 carbon atoms;
each R^{a1} independently represents —Z⁸¹—SiR²¹ₚ₈₁L_{q81}R²³ᵣ₈₁;
each Z⁸¹ independently represents a divalent organic group;
each R²¹ independently represents —Z^{1′}—SiR^{21′}_{p1′}L_{q1′}R^{23′}_{r1′};
each R²³ independently represents a monovalent organic group;
each p81 independently represents an integer from 0 to 3;
each q81 independently represents an integer from 0 to 3;
each r81 independently represents an integer from 0 to 3;
p81+q81+r81 represents 3;
each Z^{1′} independently represents a divalent organic group;
each R^{21′} independently represents —Z^{1″}—SiL_{q1″}R^{23″}_{r1″};
each R^{23′} independently represents a monovalent organic group;
each p1′ independently represents an integer from 0 to 3;
each q1′ independently represents an integer from 0 to 3;
each r1′ independently represents an integer from 0 to 3;
p1′+q1′+r1′ represents 3;
each Z^{1″} independently represents a divalent organic group;
each R^{23″} independently represents a monovalent organic group;
each q1″ independently represents an integer from 0 to 3;
each r1″ independently represents an integer from 0 to 3;
q1″+r1″ represents 3;
each R^{e1} independently represents a monovalent organic group;
each k81 independently represents an integer from 0 to 3;
each l81 independently represents an integer from 0 to 3;
each m81 independently represents an integer from 0 to 3;
k81+l81+m81 represents 3;
each R^{d1} independently represents —Z⁸²—CR⁷¹ₚ₈₂R⁷²_{q82}R⁷³ᵣ₈₂;
each Z⁸² independently represents a single bond, oxygen atom, or divalent organic group;
each R⁷¹ independently represents —Z^{2′}—CR^{32′}_{q2′}R^{33′}_{r2′};
each R⁷² independently represents —Z⁸³—SiLₙ₈₂R³⁵₃₋ₙ₈₂;
each R⁷³ independently represents a hydrogen atom, hydroxy group, or monovalent organic group;
each p82 independently represents an integer from 0 to 3;
each q82 independently represents an integer from 0 to 3;
each r82 independently represents an integer from 0 to 3;
p82+q82+r82 represents 3;
each Z^{2′} independently represents a single bond, oxygen atom, or divalent organic group;
each R^{32′} independently represents —Z⁸³—SiLₙ₈₂R³⁵₃₋ₙ₈₂;
each R^{33′} independently represents a hydrogen atom, hydroxy group, or monovalent organic group;
each q2′ independently represents an integer from 0 to 3;
each r2′ independently represents an integer from 0 to 3;
q2′+r2′ represents 3;
each Z⁸³ independently represents a single bond, oxygen atom, or divalent organic group;
each R³⁵ independently represents a monovalent organic group;
each n82 independently represents an integer from 0 to 3;
each R^{e1} independently represents —Z⁸³—SiLₙ₈₂R³⁵₃₋ₙ₈₂;
each R^{f1} independently represents a hydrogen atom, hydroxy group, or monovalent organic group;
each k82 independently represents an integer from 0 to 3;
each l82 independently represents an integer from 0 to 3;
each m82 independently represents an integer from 0 to 3.
k82+l82+m82 represents 3;
each of R^{g1} and R^{h1} independently represents —Z⁸⁴—SiLₙ₈₁R²₃₋ₙ₈₁, —Z⁸⁴—SiR^{a1}ₖ₈₁Lₗ₈₁R^{c1}ₘ₈₁,
each Z⁸⁴ independently represents a single bond, oxygen atom, or divalent organic group;
where, in formulae (W1), (W2), (W3), and (W4), there are at least two Si atoms to which a hydrolyzable group, a group having a hydrolyzable group, or a hydroxy group is bound.
R² and L are the same as R² and L in formula (S1) above.

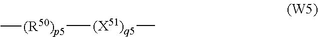

In formula (W5),
R⁵⁰ represents a single bond, —(CH₂)ₛ₅— or o-, m- or p-phenylene group,
s5 represents an integer from 1 to 20;
X⁵¹ represents —(X⁵²)ₗ₅—;
X⁵² for every occurrence independently represents a group selected from the group consisting of —O—, —S—, o-, m- or p-phenylene group, —CO—, —C(O)O—, —CONR⁵⁴—, —O—CONR⁵⁴—, —NR⁵⁴— and —(CH₂)ₙ₅—;
R⁵⁴ for every occurrence independently represents a hydrogen atom or a monovalent organic group,
n5 for every occurrence independently represents an integer from 1 to 20;
l5 represents an integer from 1 to 10;
p5 represents 0 or 1;
q5 represents 0 or 1;
at least either p5 or q5 represents 1; and the order of occurrence of (R⁵⁰)ₚ₅ and (X⁵¹)_{q5} is freely selectable.

It is preferred that each X^{A} independently represents a single bond, alkylene group having 1 to 20 carbon atoms, —(CH₂)ₛ₅—X⁵³—, —X⁵³—(CH₂)ₜ₅—, or —(CH₂)ₛ₅—X⁵³—(CH₂)ₜ₅—.

It is preferred that X⁵³ represents a single bond, —O—, —CO—, —CONR⁵⁴—, —O—CONR⁵⁴—, —O—(CH₂)ᵤ₅—CONR⁵⁴—, or —O—(CH₂)ᵤ₅—CO—;
R⁵⁴ for every occurrence independently represents a hydrogen atom, phenyl group, alkyl group having 1 to 6 carbon atoms, or oxyalkylene-containing group having 1 to 10 carbon atoms;
s5 represents an integer from 1 to 20;
t5 represents an integer from 1 to 20; and
u5 represents an integer from 1 to 20.

### Compound (5)

A compound represented by formula (5) below.

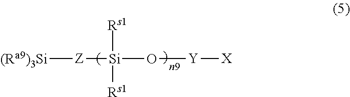

In formula (5),
Y represents a single bond or *—Si(R^{s2})₂-L^{s1}-. * Indicates a bond with an oxygen atom.
Z represents an oxygen atom, or a divalent hydrocarbon group having 1 to 10 carbon atoms.

Each R^{a9} independently represents a hydrocarbon group or a trialkylsilyloxy group. Where, in a case all of R^{a9} represent hydrocarbon groups, the hydrocarbon group represented by R^{a9} is an alkyl group.

Each of R^{s1} and R^{s2} independently represents an alkyl group having 1 to 10 carbon atoms.

L^{s1} represents a divalent hydrocarbon group having 1 to 10 carbon atoms.

X represents a group represented by any of formulae (X-1) to (X-3) below.

n9 represents a number from 1 to 150.

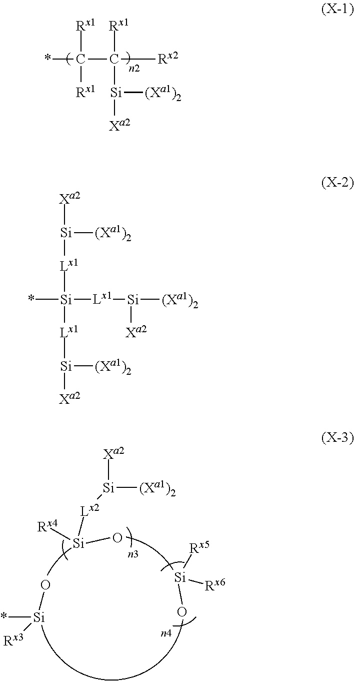

In formulae (X-1) to (X-3),
each of L^{x1} and L^{x2} independently represents a divalent hydrocarbon group having 1 to 20 carbon atoms, and a methylene group (—CH₂—) contained in the divalent hydrocarbon group may be replaced with —O— or —O—Si(R^{x7})₂—.

Each of R^{x1} to R^{x7} independently represents a hydrogen atom, or a hydrocarbon group having 1 to 10 carbon atoms.

Each X^{a1} independently represents a hydrolyzable group, a group having a hydrolyzable group, or a trialkoxysilyloxy group.

Each X^{a2} independently represents a trialkylsilyl-containing group, a hydrocarbon chain-containing group, a siloxane skeleton-containing group, a hydrolyzable group, a group having a hydrolyzable group, or a trialkoxysilyloxy group. In a case where X^{a2} represents a hydrolyzable group, X^{a2} and X^{a1} may be the same or different.

n2 represents an integer from 1 to 50.

n3 represents a number from 2 to 5.

n4 represents a number from 0 to 5.

In formula (X-3), the sequential order of units represented by (Si(R^{x4})(-L^{x2}-Si(X^{a2})(X^{a1})₂)—O—) and (Si(R^{x5})(R^{x6})—O—) is freely selectable.

Hereinafter, the compounds (1) to (5) will be described.

### (Compound (1))

The compound (1) is preferably represented by formula (1A) below:

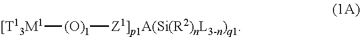

In formula (1A),
M¹ represents Si, Sn, or Ge;
each T¹ independently represents a hydrocarbon group or a trialkylsilyloxy group;
r represents 0 or 1;
each Z¹ independently represents an alkylene chain or a polyalkylene oxide chain, or, combination of an alkylene chain with a divalent chain organo(poly)siloxane residue; A represents a single bond or a (p1+q1)-valent linking group;
each R² independently represents a monovalent hydrocarbon group;
each L independently represents a hydrolyzable group, a group having a hydrolyzable group, or a hydroxy group;
each n independently represents an integer from 0 to 2; and
each of p1 and q1 independently represents an integer of 1 or larger.

Where, in a case where each Z¹ independently represents an alkylene chain or a polyalkylene oxide chain, A represents a (p1+q1)-valent linking group that contains a chain organo(poly)siloxane residue.

T¹ and M¹ are the same as T¹ and M¹ in group 1a, and will not be described.

M¹ preferably represents Si.

T¹ preferably represents a trialkylsilyloxy group. Butyldimethylsilyloxy group, trimethylsilyloxy group, or triethylsilyloxy group is more preferred.

R², L, and n are the same as R², L, and n in formula (S1) above.

The combination of an alkylene chain and a divalent chain organo(poly)siloxane residue represented by Z¹ is preferably represented by formula (D3), (D4), or (D5) below:

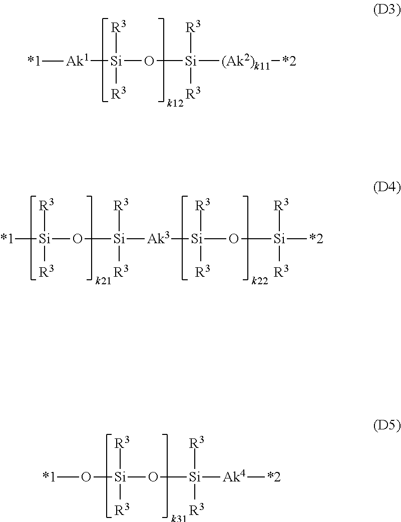

In formula (D3), each of Ak¹ and Ak² independently represents an alkylene chain. R³ is the same as R³ in formula (B1). k1l represents a number of 1 or larger. k12 represents 0 or 1.

In formula (D4), Ak³ represents an alkylene chain. R³ is the same as R³ in formula (B¹). Each of k21 and k22 independently represents a number of 1 or larger.

In formula (D5), Ak⁴ represents an alkylene chain. R³ is the same as R³ in formula (B¹). k31 represents a number of 1 or larger.

In formulae (D3), (D4), or (D5), *1 indicates the side bound to group 1a, and *2 indicates the side bound to group 1b.

A may only be a group unlikely to damage the effect of the present disclosure, and examples thereof include alkylene group optionally having an etheric oxygen atom or a divalent chain organo(poly)siloxane residue, carbon atom, nitrogen atom, silicon atom, 2- to 8-valent chain organo(poly)siloxane residues, and group that remains after removal of Si(R²)ₙL₃₋ₙ from group (3-1A), group (3-1B), and groups (3-1A-1) to (3-1A-7).

A may have a triptycene structure. The triptycene structure refers to a partial structure that remains after removal of two or more hydrogen atoms from triptycene.

A may also be any of groups (g2-1) to (g2-14).

p1 represents an integer of 1 or larger. From the viewpoint of more excellent water repellency of the surface treatment layer, p1 preferably represents 1 to 6, and more preferably 2 to 4. p1 may also represent 1.

In a case where p1 represents 2 or larger, the plurality of [T¹₃M¹-(O)ᵣ—Z¹] may be the same or different from each other.

q1 represents an integer of 1 or larger. From the viewpoint of more excellent abrasion resistance of the surface treatment layer, q1 preferably represents 1 to 15, which is more preferably 1 to 6, further preferably 2 to 6, particularly preferably 2 to 4, and extremely preferably 2 or 3. q1 may also represent 1.

If q1 represents 2 or larger, the plurality of [Si(R²)ₙL₃₋ₙ] may be the same or different from each other.

Preferred aspect of group A(Si(R²)ₙL₃₋ₙ)_{q1} in formula (1A) is the same as the preferred aspect of group A(Si(R²)ₙL₃₋ₙ)_{q1} described previously in the section titled “Partial Structures of First Compound, Second Compound, and Compound (E)”. Where, A in group A(Si(R²)ₙL₃₋ₙ)_{q1} is bound to [T¹₃M¹-(O)ᵣ—Z¹]ₚ₁ in formula (1A). In a case where the terminal of Z¹ on the side bound to A has an alkylene chain, the terminal of A on the side bound to Z¹ does not have an alkylene chain. In a case where the terminal of Z¹ on the side bound to A has a polyalkylene oxide chain, the terminal of A on the side bound to Z¹ does not have a polyalkylene oxide chain.

The compound (1) is preferably represented by a compound represented by formula (1B) below:

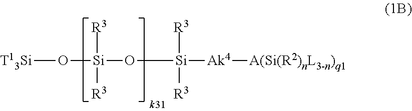

In formula (1B), T¹ is the same as T¹ in group 1a.

R³ is the same as R³ in formula (B1). k31 is the same as k31 in formula (D5).

A group represented by A(Si(R²)ₙL₃₋ₙ)_{q1} is the same as the group represented by A(Si(R²)ₙL₃₋ₙ)_{q1} in formula (1A).

Ak⁴ is the same as Ak⁴ in formula (D5).

The compound (1) is preferably represented by a compound represented by formula (1C), formula (1D), or formula (1E) below:

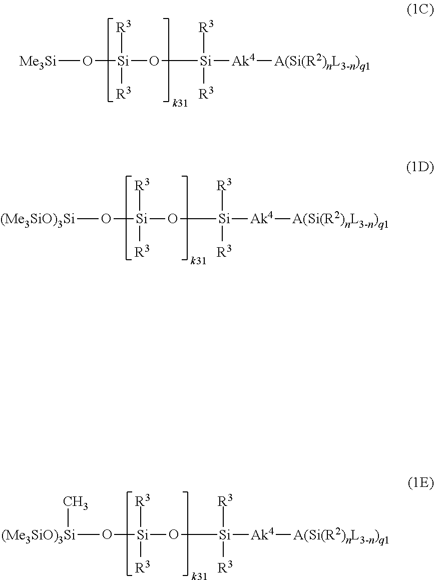

R³ in formula (1C), formula (1D) and formula (1E) is the same as R³ in formula (B1). k31 is the same as k31 in formula (D5).

A group represented by A(Si(R²)ₙL₃₋ₙ)_{q1} is the same as the group represented by A(Si(R²)ₙL₃₋ₙ)_{q1} in formula (1A).

Ak⁴ is the same as Ak⁴ in formula (D5).

Specific examples of the compound (1) include the compound below.

In the formula below, n10 represents a number of 1 or larger, preferably a number from 1 to 60, may be a number from 3 to 50, may be a number from 5 to 30, and may be a number from 7 to 25.

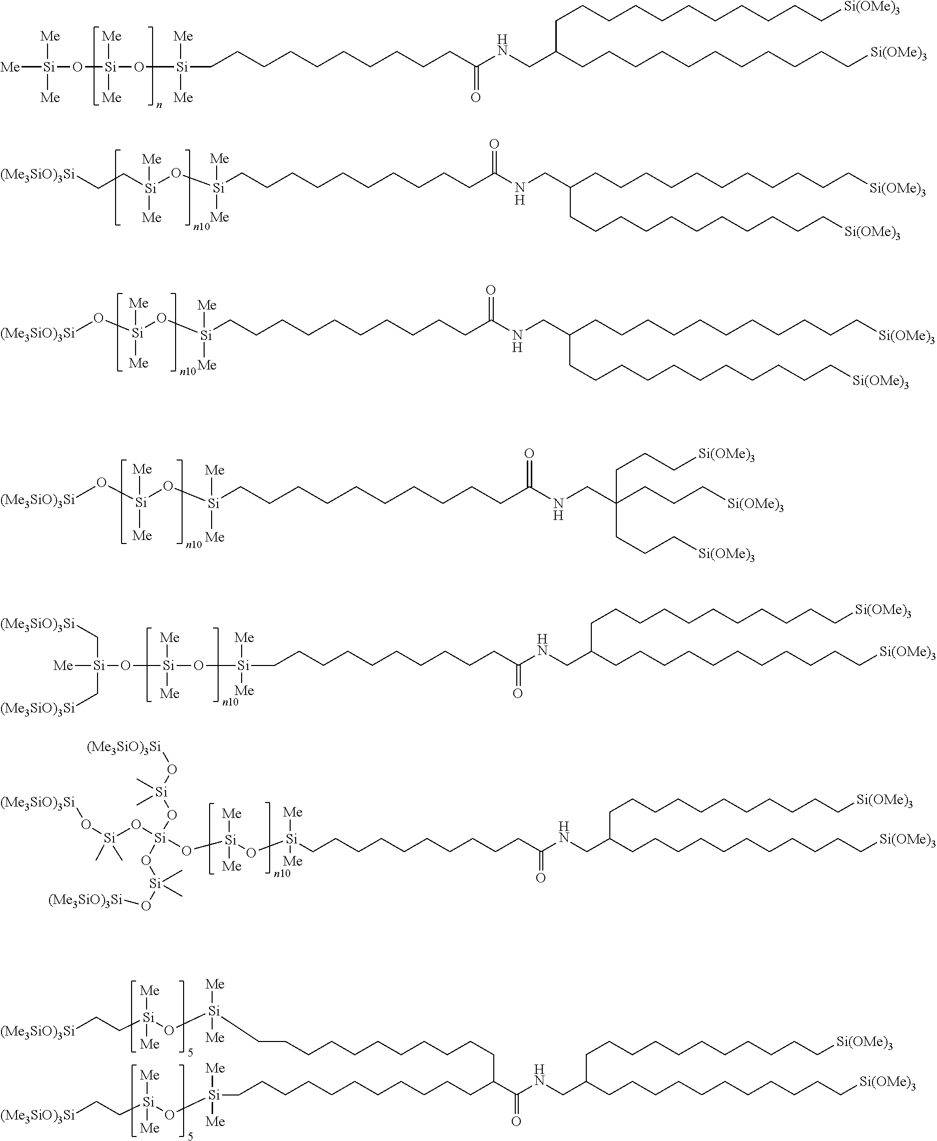

In the formula below, k preferably represents 1 to 80, more preferably 3 to 50, and still more preferably 3 to 30. m preferably represents 1 to 30, more preferably 3 to 20, and still more preferably 3 to 10. t preferably represents 1 to 30, more preferably 3 to 20, and still more preferably 3 to 10.

In the formula below, n10 represents a number of 1 or larger, preferably a number from 1 to 60, may be a number from 3 to 50, may be a number from 5 to 30, and may be a number from 7 to 25.

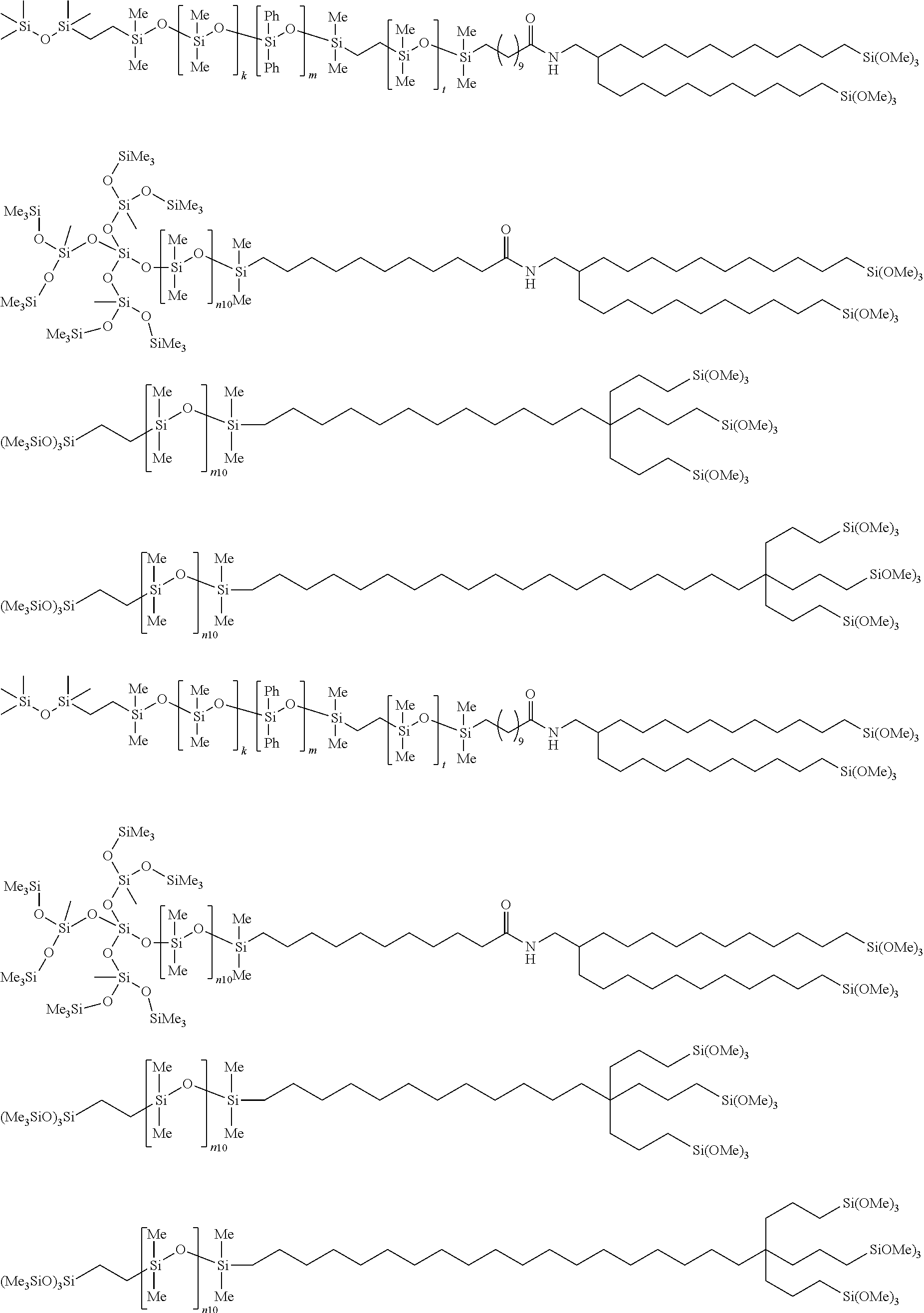

In the formula below, n10 represents a number of 1 or larger, preferably a number from 1 to 60, may be a number from 3 to 50, may be a number from 5 to 30, and may be a number from 7 to 25.

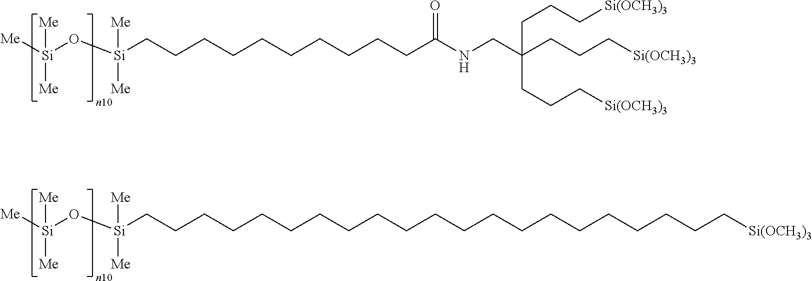

### (Compound (2))

In the compound (2), the alkyl group means an unsubstituted alkyl group. The alkyl group may be any of linear alkyl group, branched alkyl group, and cycloalkyl group. Linear alkyl group or branched alkyl group is preferred. The number of carbon atoms in the alkyl group is preferably 2 to 30, more preferably 3 to 28, and still more preferably 4 to 22.

In the compound, only one, or two or more alkyl groups may be contained.

The alkyl group, which is a monovalent group, is located at the terminal of the compound.

The compound (2) is preferably represented by formula (2A) below:

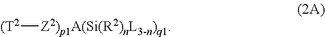

In formula (2A),
T² represents an alkyl group having two or more carbon atoms;
Z² represents a divalent chain organo(poly)siloxane residue;
A represents a single bond or a (p1+q1)-valent linking group;
each R² independently represents a monovalent hydrocarbon group;
each L independently represents a hydrolyzable group, a group having a hydrolyzable group, or a hydroxy group;
n represents an integer from 0 to 2; and
each of p1 and q1 independently represents an integer of 1 or larger.

Preferred aspects of the alkyl group having two or more carbon atoms represented by T² are as described above.

The divalent chain organo(poly)siloxane residue represented by Z² is preferably the group represented by the aforementioned formula (B1).

R², L, and n are the same as R², L, and n in formula (S1) above.

The group represented by A(Si(R²)ₙL₃₋ₙ)_{q1} is the same as the group represented by A(Si(R²)ₙL₃₋ₙ)_{q1} in formula (1A), except for details given below.

p1 and q1 are the same as p1 and q1 in formula (1A) above.

The group represented by A(Si(R²)ₙL₃₋ₙ)_{q1} is preferably group (3-1A) or group (3-1B). Group (3-1A) is more preferred.

In formula (3-1A), Q^{a} represents a single bond or a divalent linking group.

Where, the terminal of Q^{a} on the side bound to Z² does not have an oxysilyl group.

In formula (3-1A), X³¹ represents a single bond, alkylene group, carbon atom, nitrogen atom, silicon atom, 2- to 8-valent organo(poly)siloxane residues, or group having a (h+i+1)-valent ring.

Where, in a case where Q^{a} represents a single bond, the terminal of X³¹ on the side bound to Z² does not have an oxysilyl group. In cases other than the above, the terminal of X³¹ may have an oxysilyl group.

In formula (3-1A), Q^{b} represents a single bond or a divalent linking group.

Where, in a case where each of Q^{a} and X³¹ represents a single bond, the terminal of Q^{b} on the side bound to Z² does not have an oxysilyl group. In cases other than the above, the terminal of Q^{b} may have an oxysilyl group.

In a case where h represents 1, and Q^{b} represents an alkylene group, the Q^{b}-side terminal of Q^{a}-X³¹ does not have an alkylene group.

In formula (3-1B), Q^{c} represents a single bond or a divalent linking group.

Where, the terminal of Q^{c} on the side bound to Z does not have an oxysilyl group.

Group (3-1A) is preferably any of groups (3-1A-1) to (3-1A-7).

Where, each of the terminals of groups (3-1A-1) to (3-1A-7) on the side bound to Z² does not have an oxysilyl group.

In group (3-1A-1), X³² preferably represents —O—, —S—, —N(R^{d})—, —C(O)O—, —C(O)S—, —N(R^{d})C(O)N(R^{d})—, —OC(O)N(R^{d})—, or —C(O)N(R^{d})—, wherein —C(O)O— or —C(O)N(R^{d})— is more preferred.

s1 preferably represents 0, and Q^{b1} preferably represents an alkylene group having 2 to 6 carbon atoms.

In group (3-1A-2), X³³ preferably represents —O—, —C(O)O—, or —C(O)N(R^{d})—.

A in formula (2A) may also be any of groups (g2-1) to (g2-7).

Where, in each of formulae (g2-1) to (g2-7), A¹ is given on the side bound to Z², meanwhile Q²², Q²³, Q²⁴, Q²⁵ or Q²⁶ is given on the side bound to [—Si(R²)ₙL₃₋ₙ].

Examples of another aspect of A include groups (g2-8) to (g2-14).

Where, in each of formulae (g2-8) to (g2-14), A¹ is given on the side bound to Z², meanwhile G1 is given on the side bound to [—Si(R²)ₙL₃₋ₙ].

The compound (2) is preferably a compound represented by formula (2B) below:

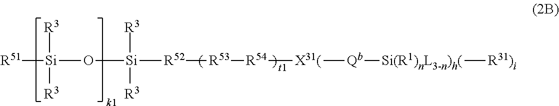

In formula (2B), R³¹ represents an alkyl group having two or more carbon atoms.

Each of R⁵² and R⁵⁴ independently represents an alkylene group.

R⁵³ represents —C(O)O—, —SO₂N(R^{d})—, —N(R^{d})SO₂—, —N(R^{d})C(O)—, or —C(O)N(R^{d})—.

R³ is the same as R³ in formula (B1). k1 is the same as k1 in formula (B1).

A group represented by X³¹(-Q^{b}-Si(R²)ₙL₃₋ₙ)ₕ(—R³¹)ᵢ is the same as the group represented by X³¹(-Q^{b}-Si(R²)ₙL₃₋ₙ)ₕ(—R³¹); in group (3-1A).

t1 represents 0 or 1.

Preferred aspects of the alkyl group represented by R⁵¹ are as described above in the section regarding the alkyl group.

The alkylene group represented by R⁵² may be linear, branched, or cyclic. The number of carbon atoms in the alkylene group is preferably 1 to 30, more preferably 1 to 20, still more preferably 4 to 20, and particularly preferably 5 to 15.

The alkylene group represented by R⁵⁴ may be linear, branched, or cyclic. The number of carbon atoms in the alkylene group is preferably 1 to 20, more preferably 1 to 10, still more preferably 1 to 6, and particularly preferably 1 to 3.

Specific examples of the compound (2) include the compounds below. In formula below, n10 represents a number of 1 or larger, preferably a number from 1 to 60, may be a number from 3 to 50, may be a number from 5 to 30, and may be a number from 7 to 25.

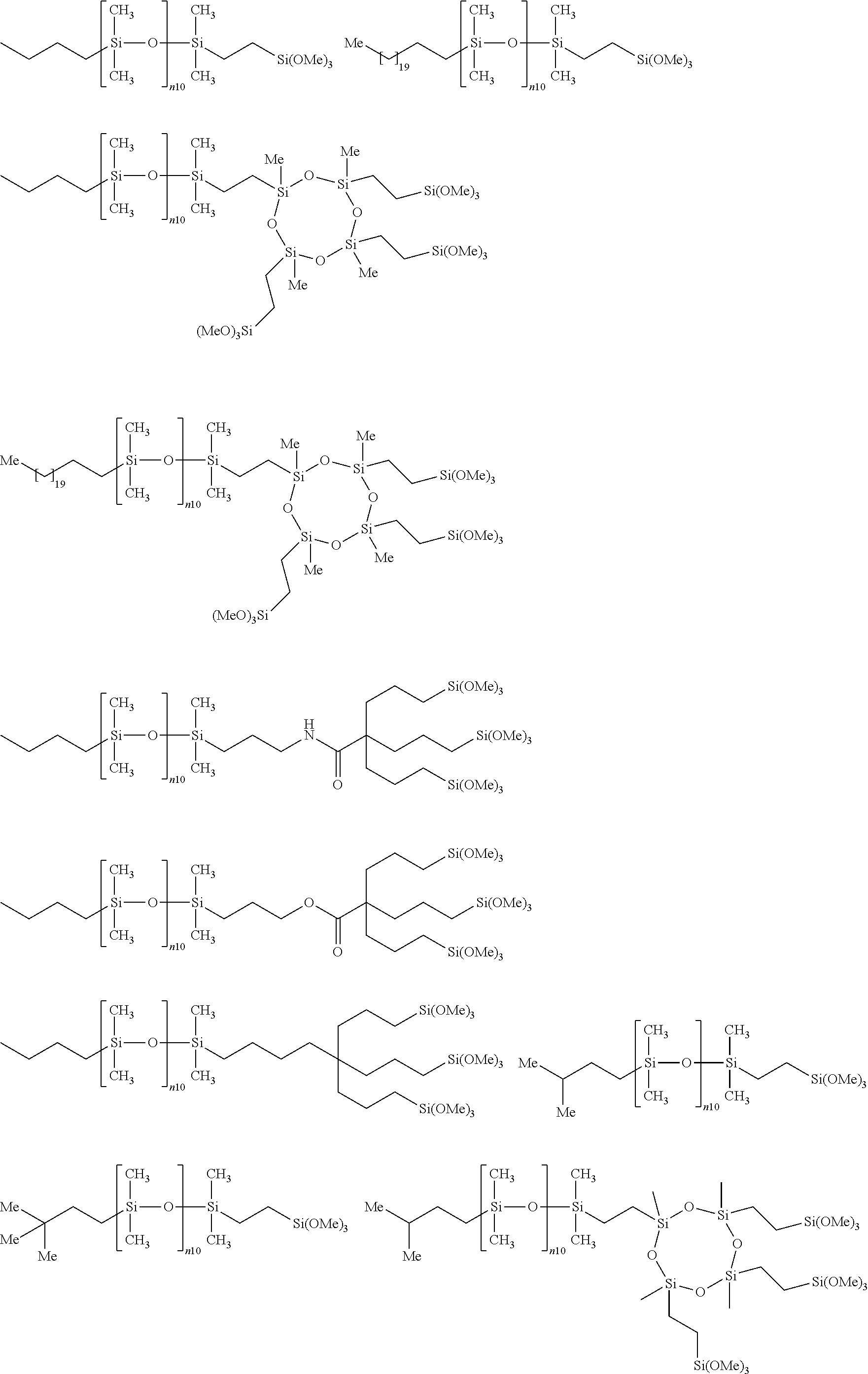

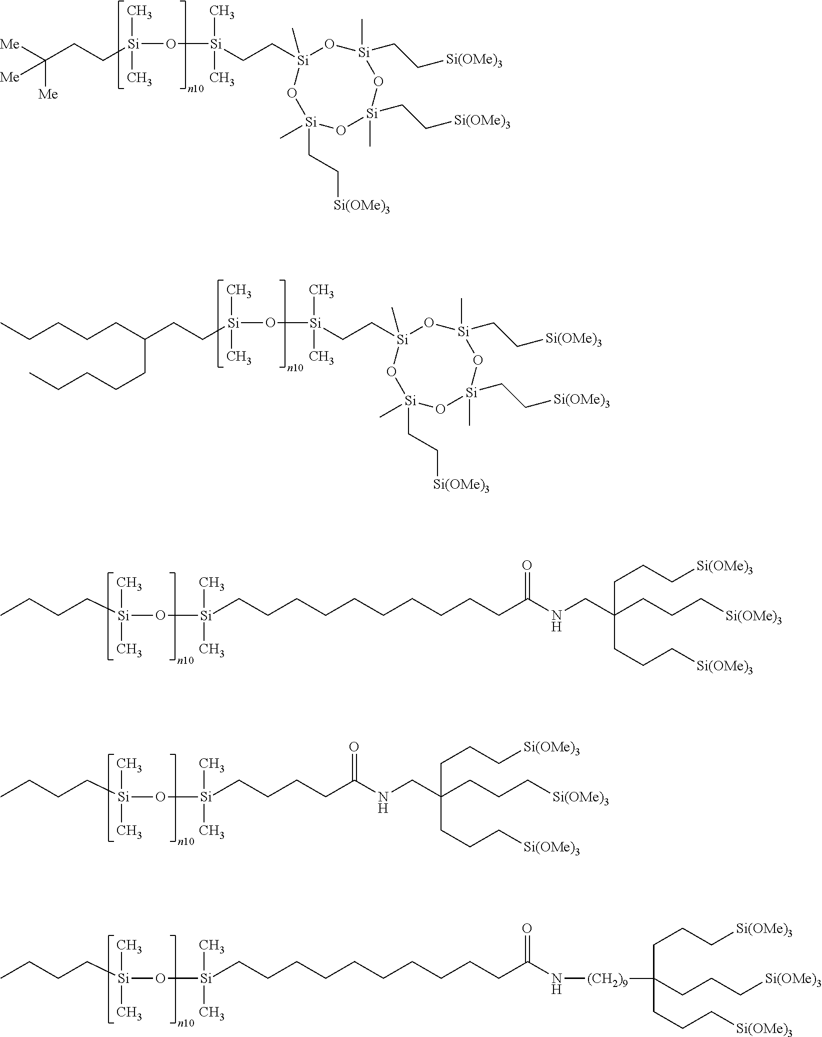

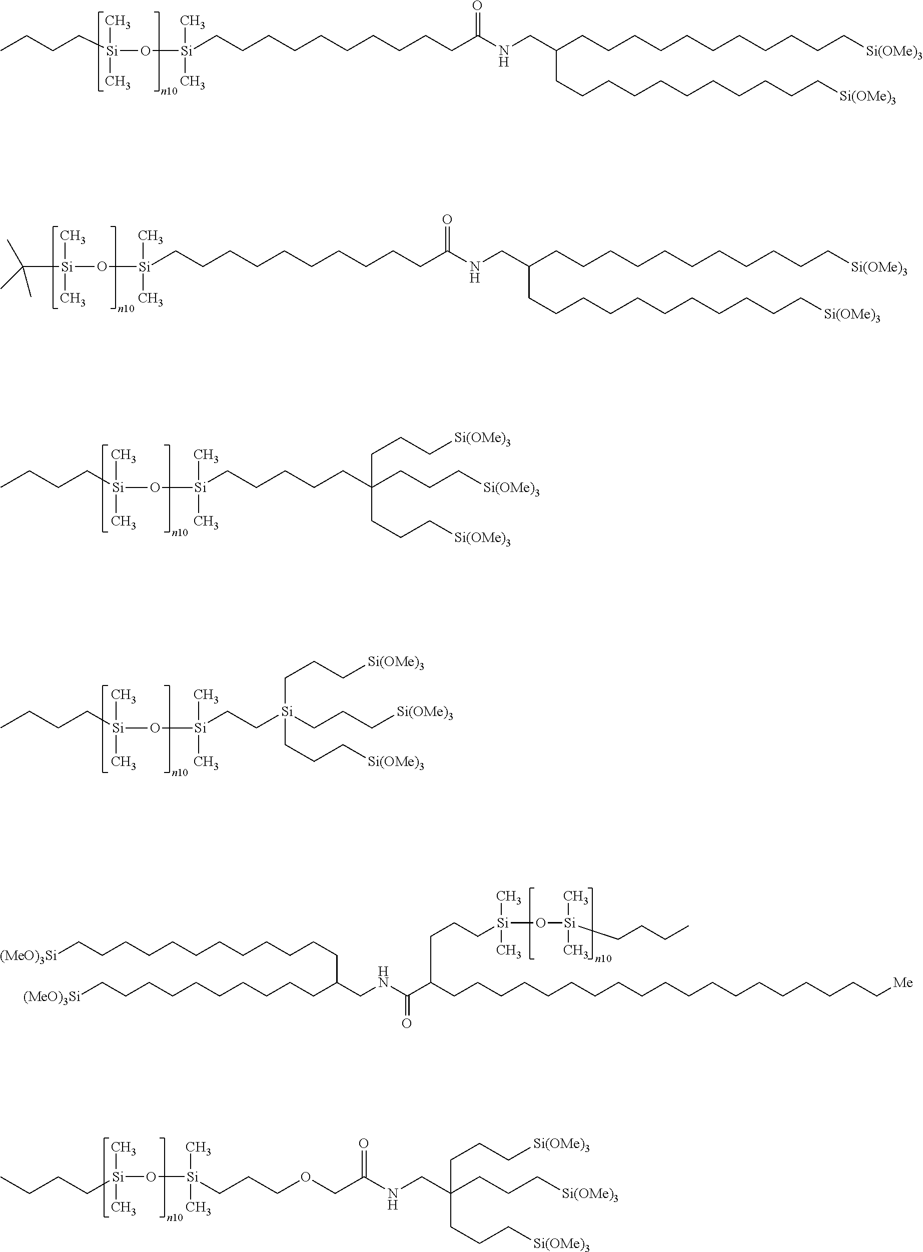

### (Compound (3))

The compound (3) is preferably represented by formula (3A) below:

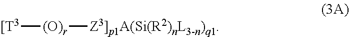

In formula (3A),
each T³ independently represents a monovalent cyclic polysiloxane residue or a monovalent cage-like polysiloxane residue;
r represents 0 or 1;
Z³ represents a divalent chain organo(poly)siloxane residue, or, combination of divalent chain organo(poly)siloxane residue, with at least either an alkylene chain or a polyalkylene oxide chain;
A represents a single bond or a (p1+q1)-valent linking group;
each R² independently represents a monovalent hydrocarbon group;
each L independently represents a hydrolyzable group, a group having a hydrolyzable group, or a hydroxy group;
each n independently represents an integer from 0 to 2; and
each of p1 and q1 independently represents an integer of 1 or larger.

R², L, and n are the same as R², L, and n in formula (S1) above.

The group represented by A(Si(R²)ₙL₃₋ₙ)_{q1} is the same as the group represented by A (Si(R²)ₙL₃₋ₙ)_{q1} in formula (1A), except for details given below.

p1 and q1 are the same as p1 and q1 in formula (1A) above.

Details of the monovalent cyclic polysiloxane residue or the monovalent cage-like polysiloxane residue are as described above in the description regarding T¹ in formula (C).

The group represented by A(Si(R²)ₙL₃₋ₙ)_{q1} is preferably group (3-1A) or group (3-1B). Group (3-1A) is more preferred.

In formula (3-1A), Q^{a} represents a single bond or a divalent linking group.

Where, the terminal of Q^{a} on the side bound to Z³ has none of alkylene group, polyalkylene oxide chain, or divalent organo(poly)siloxane residue.

In a case where the A-side terminal of Z³ has an alkylene chain, Q^{a} preferably represents a divalent hydrocarbon group other than alkylene group, divalent heterocyclic group, —O—, —S—, —SO₂—, —N(R^{d})—, —C(O)—, —Si(R^{d})₂—, —OC(O)—, —C(O)O—, —C(O)S—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, alkylene group having —C(O)N(R^{d})—, alkylene group having —N(R^{d})C(O)—, alkylene group having OC(O)N(R^{d})—, alkylene group having an etheric oxygen atom, alkylene group having —S—, alkylene group having —OC(O)—, alkylene group having —C(O)O—, alkylene group having —C(O)S—, alkylene group having —N(R^{d})—, alkylene group having —N(R^{d})C(O)N(R^{d})—, or alkylene group having —SO₂N(R^{d})—. Q^{a} more preferably represents —OC(O)—, alkylene group having —C(O)N(R^{d})—, alkylene group having —OC(O)N(R^{d})—, alkylene group having an etheric oxygen atom, alkylene group having —S—, alkylene group having —C(O)O—, alkylene group having —C(O)S—, alkylene group having —N(R^{d})—, or alkylene group having —N(R^{d})C(O)N(R^{d})—; and still more preferably represents alkylene group having —C(O)O—, or alkylene group having —C(O)N(R^{d})—.

In a case where the A-side terminal of Z³ has a polyalkylene oxide chain, Q^{a} preferably represents a divalent hydrocarbon group other than alkylene group, divalent heterocyclic group, —SO₂—, —C(O)—, —Si(R^{a})₂—, —C(O)O—, —C(O)S—, —C(O)N(R^{d})—, —SO₂N(R^{d})—, alkylene group having —C(O)N(R^{d})—, alkylene group having —C(O)O—, or alkylene group having —SO₂N(R^{d})—, wherein —C(O)— is more preferred.

In a case where the A-side terminal of Z³ has a divalent chain organo(poly)siloxane residue, Q^{a} preferably represents a divalent hydrocarbon group other than alkylene group, divalent heterocyclic group, —O—, —S—, —SO₂—, —N(R^{d})—, —C(O)—, —Si(R^{d})₂—, —OC(O)—, —C(O)O—, —C(O)S—, —C(O)N(R^{d})—, —N(R^{d})C(O)—, —N(R^{d})C(O)N(R^{d})—, —N(R^{d})C(O)O—, —OC(O)N(R^{d})—, —SON(R^{d})—, —N(R^{d})SO₂—, alkylene group having —C(O)N(R^{d})—, alkylene group having —N(R^{d})C(O)—, alkylene group having OC(O)N(R^{d})—, alkylene group having an etheric oxygen atom, alkylene group having —S—, alkylene group having —OC(O)—, alkylene group having —C(O)O—, alkylene group having —C(O)S—, alkylene group having —N(R^{d})—, alkylene group having —N(R^{d})C(O)N(R^{d})—, or alkylene group having —SO₂N(R^{d})—.

In formula (3-1A), X³¹ represents a single bond, alkylene group, carbon atom, nitrogen atom, silicon atom, 2- to 8-valent organo(poly)siloxane residues, or group having a (h+i+1)-valent ring.

Where, in a case where Q^{a} represents a single bond, the terminal of X³¹ on the side bound to Z³ has none of alkylene group, polyalkylene oxide chain, or divalent organo(poly)siloxane residue. In cases other than the above, the terminal of X³¹ may have any of alkylene group, polyalkylene oxide chain, or divalent organo(poly)siloxane residue.

In formula (3-1A), Q^{b} represents a single bond or a divalent linking group.

Where, in a case where each of Q^{a} and X³¹ represents a single bond, the terminal of Q^{b} on the side bound to Z³ has none of alkylene group, polyalkylene oxide chain, or divalent organo(poly)siloxane residue. In cases other than the above, the terminal of Q^{b} may have any of alkylene group, polyalkylene oxide chain, or divalent organo(poly)siloxane residue.

In a case where each of Q^{a}, X³¹, and Q^{b} in formula (3-1A) represents a single bond, [Si(R²)ₙL₃₋ₙ] is directly bound to Z³, where Z³ represents an alkylene chain.

In formula (3-1B), Q^{c} represents a single bond or a divalent linking group.

Where, the terminal of Q′ on the side bound to Z³ has none of alkylene group, polyalkylene oxide chain, or divalent organo(poly)siloxane residue.

Group (3-1A) is preferably any of groups (3-1A-1) to (3-1A-7).

Where, each of the terminals of groups (3-1A-1) to (3-1A-7) on the side bound to Z³ has none of alkylene group, polyalkylene oxide chain, or divalent organo(poly)siloxane residue.

In a case where the A-side terminal of Z³ in group (3-1A-1) has an alkylene group, X³² preferably represents —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})—; more preferably represents —O—, —S—, —N(R^{d})—, —C(O)O—, —C(O)S—, —N(R^{d})C(O)—, —N(R^{d})C(O)N(R^{d})—, —OC(O)N(R^{d})—, or —C(O)N(R^{d})—; and still more preferably represents —C(O)O— or —N(R^{d})C(O)—.

In a case where the A-side terminal of Z³ has a polyalkylene oxide chain, X³² preferably represents —C(O)—, —C(O)O—, —C(O)S—, —SO₂N(R^{d})—, or —C(O)N(R^{d})—, and more preferably represents —C(O)—.

In a case where the A-side terminal of Z³ has a divalent chain organo(poly)siloxane residue, X³² preferably represents —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})—, and more preferably represents —O—.

In a case where the A-side terminal of Z³ has an alkylene chain, it is preferred that s1 represents 0 and Q^{b1} represents a single bond, or, s1 represents 1 and Q^{b1} represents an alkylene group having 2 to 6 carbon atoms.

In a case where the A-side terminal of Z³ has a polyalkylene oxide chain, it is preferred that s1 represents 1, and Q^{b1} represents an alkylene group having 2 to 6 carbon atoms.

In a case where the A-side terminal of Z³ has a divalent chain organo(poly)siloxane residue, it is preferred that s1 represents 1, and Q^{b1} represents a single bond.

In a case where the A-side terminal of Z³ in group (3-1A-2) has an alkylene chain or a divalent chain organo(poly)siloxane residue, X³³ preferably represents —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})—.

In a case where the A-side terminal of Z³ has a polyalkylene oxide chain, X³³ preferably represents —C(O)O—, —C(O)S—, —SO₂N(R^{d})—, or —C(O)N(R^{d})—.

A in formula (3A) may also be any of groups (g2-1) to (g2-7).

Where, in each of formulae (g2-1) to (g2-7), A¹ is given on the side bound to Z³, meanwhile Q²², Q²³, Q²⁴, Q²⁵ or Q²⁶ is given on the side bound to [—Si(R²)ₙL₃₋ₙ].

Examples of another aspect of A include groups (g2-8) to (g2-14).

Where, in each of formulae (g2-8) to (g2-14), A¹ is given on the side bound to Z³, meanwhile G1 is given on the side bound to [—Si(R²)ₙL₃₋ₙ].

Specific examples of the compound (3) include the compound below. In formula below, n10 represents a number of 1 or larger, preferably a number from 1 to 60, may be a number from 3 to 50, may be a number from 5 to 30, and may be a number from 7 to 25.

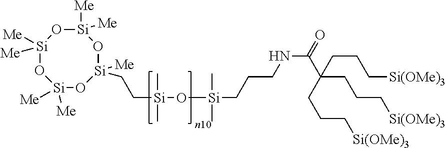

### (Compounds (4A) and (4B))

In the compounds (4A) and (4B), it is more preferred that
each X^{A} independently represents:
—(CH₂)ₛ₇—O—(CH₂)ₜ₇—,
—(CH₂)ₛ₇—CONR⁵⁴—(CH₂)ₜ₇—,
—(CH₂)ₛ₇—O—(CH₂)ᵤ₇—CO—, or
—(CH₂)ₛ₇—O—(CH₂)ᵤ₇—CONR⁵⁴—(CH₂)ₜ₇—.

Each R⁵⁴ independently represents a hydrogen atom, phenyl group, alkyl group having 1 to 6 carbon atoms, or oxyalkylene-containing group having 1 to 10 carbon atoms;
s7 represents an integer from 1 to 20;
t7 represents an integer from 1 to 20; and
u7 represents an integer from 1 to 20.

Each X^{A} independently represents a group represented by formula (W6) below.

In formula (W6), each X^{a} independently represents a single bond, or a divalent organic group.

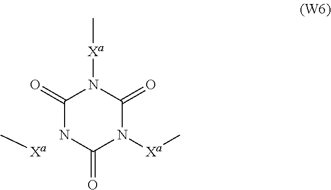

Specific examples of the compound (4A) include the compound below.
—(CH₃)₃Si—(OSi(CH₃)₂)₁₉—(CH₂)₁₀—CONH—CH₂C{CH₂CH₂CH₂Si(OCH₃)₃}₃

### (Compound (5))

The surface treatment agent of the present disclosure, if containing the compound (5), is preferred to further contain a metal compound.

The metal compound is preferably a compound represented by formula (M6a) or (M6b) below:

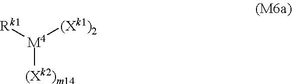

In formula (M6a),
R^{k1} represents a siloxane skeleton-containing group, a hydrocarbon chain-containing group, or a hydrolyzable group; and
each of a plurality of X^{k1} independently represent a hydrolyzable group.
X^{k2} represents a siloxane skeleton-containing group, a hydrocarbon chain-containing group, or a hydrolyzable group.

The number of atoms of the siloxane skeleton-containing group in R^{k1} and X^{k1} is smaller than the number of atoms of the trialkylsilyl group-containing molecular chain represented by (R^{a9})₃Si—Z—(Si(R^{s1})₂—O—)ₙ₉—Y— of the compound (5), and the number of carbon atoms of the longest straight chain of the hydrocarbon chain contained in the hydrocarbon chain-containing group in R^{k1} and X^{k1} is smaller than the number of elements of the trialkylsilyl group-containing molecular chain represented by (R^{a9})₃Si—Z—(Si(R^{s1})₂—O—)ₙ₉—Y— of the compound (5),

In a case where each of R^{k1} and X⁴² represents a siloxane skeleton-containing group or a hydrocarbon chain-containing group, R^{k1} and X^{k2} may be the same or different.

In a case where X^{k2} represents a hydrolyzable group, X^{k2} and X^{k1} may be the same or different. Also R^{k1} and X¹² may be the same or different. M⁴ represents a trivalent or tetravalent metal atom capable of forming a metal alkoxide. m14 represents an integer of 0 or 1, depending on M⁴.

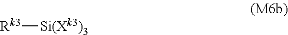

In formula (M6b),
R¹³ represents a hydrolyzable silane oligomer residue; and
X^{k3} represents a hydrolyzable group, a fluorine-containing alkyl group having 1 to 4 carbon atoms, or an alkyl group having 1 to 4 carbon atoms.

Specific examples of the compound (5) include the compounds below. In the formulae below, n10 represents a number of 1 or larger, preferably a number from 1 to 60, may be a number from 3 to 50, may be a number from 5 to 30, and may be a number from 7 to 25.

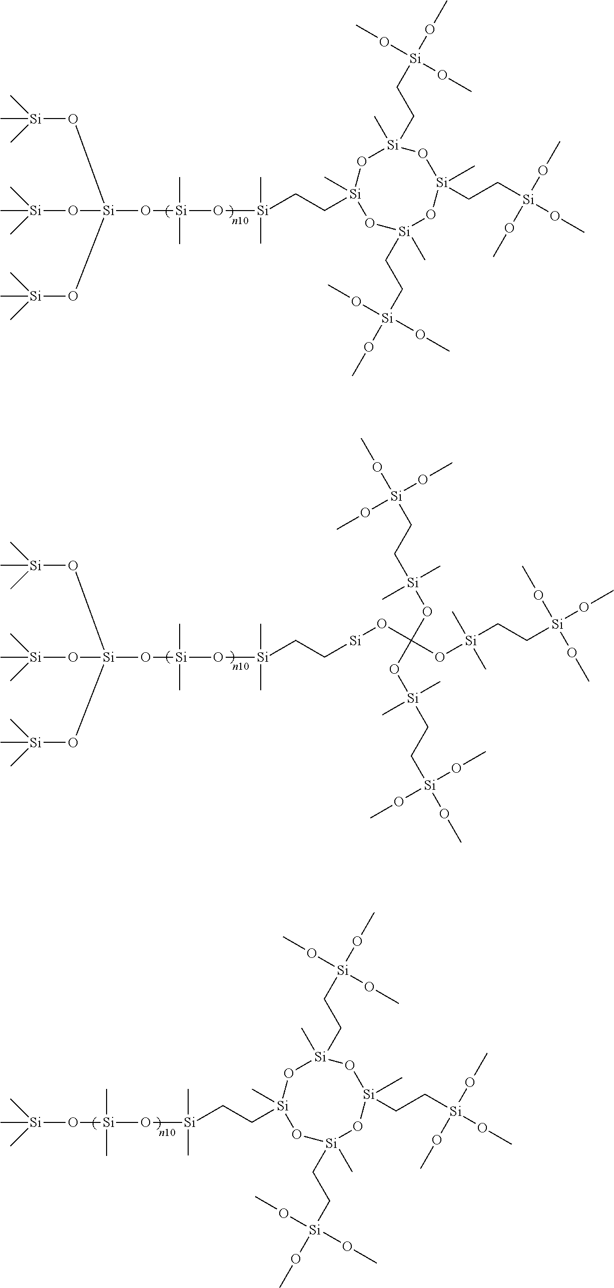

### <Liquid Medium>

The surface treatment agent may also contain a liquid medium.

The liquid medium may be used singly or in combination of two or more kinds thereof.

The liquid medium is preferably an organic solvent.

Examples of the organic solvent include compounds composed only of hydrogen atom and carbon atom, and compounds composed only of hydrogen atom, carbon atom, and oxygen atom. Specific examples thereof include hydrocarbon-based organic solvent, ketone-based organic solvent, ether-based organic solvent, ester-based organic solvent, glycol-based organic solvent, and alcohol-based organic solvent.

Specific examples of the hydrocarbon-based organic solvent include pentane, hexane, heptane, octane, hexadecane, isohexane, isooctane, isononane, cycloheptane, cyclohexane, bicyclohexyl, benzene, toluene, ethylbenzene, o-xylene, m-xylene, p-xylene, o-diethylbenzene, m-diethylbenzene, p-diethylbenzene, n-butylbenzene, sec-butylbenzene, and tert-butylbenzene.

Specific examples of the ketone-based organic solvent include acetone, methyl ethyl ketone, methyl isobutyl ketone, diisobutyl ketone, cyclohexanone, 2-heptanone, 4-heptanone, 3,5,5-trimethyl-2-cyclohexene-1-one, and 3,3,5-trimethylcyclohexanone and isophorone.

Specific examples of the ether-based organic solvent include diethyl ether, cyclopentyl methyl ether, tetrahydrofuran, and 1,4-dioxane.

Specific examples of the ester-based organic solvent include methyl acetate, ethyl acetate, propyl acetate, isopropyl acetate, butyl acetate, isobutyl acetate, tert-butyl acetate, amyl acetate, isoamyl acetate, ethyl 3-ethoxypropionate, ethyl lactate, ethylene glycol monobutyl ether acetate, diethylene glycol monobutyl ether acetate, propylene glycol monomethyl ether acetate, dipropylene glycol methyl ether acetate, 3-methoxy-3-methyl butyl acetate, 3-methoxybutyl acetate, propylene glycol monomethyl acetate, propylene glycol dimethyl acetate, ethylene glycol monoethyl ether acetate, ethylene glycol monomethyl ether acetate, diethylene glycol monoethyl ether acetate, cyclohexanol acetate, propylene glycol diacetate, propylene glycol monomethyl ether acetate, propylene glycol monomethyl ether propionate, propylene glycol monoethyl ether acetate, propylene glycol monobutyl ether acetate, propylene glycol monopropyl ether acetate, dipropylene glycol methyl ether acetate, 1,3-butylene glycol diacetate, 1,4-butanediol diacetate, 1,3-butylene glycol diacetate, 1,6-hexanediol diacetate, γ-butyrolactone, triacetin, and 2,2,4-trimethyl-1,3-pentanediol monoisobutyrate.

Specific examples of the glycol-based organic solvent include ethylene glycol, ethylene glycol monobutyl ether, diethylene glycol monobutyl ether, triethylene glycol monobutyl ether, tetraethylene glycol monobutyl ether, ethylene glycol monohexyl ether, diethylene glycol monohexyl ether, ethylene glycol mono-2-ethylhexyl ether, diethylene glycol mono-2-ethylhexyl ether, propylene glycol monomethyl ether, propylene glycol monoethyl ether, propylene glycol monobutyl ether, propylene glycol monopropyl ether, ethylene glycol monoisopropyl ether, ethylene glycol monoethyl ether, ethylene glycol mono-tert-butyl ether, ethylene glycol monopropyl ether, ethylene glycol monomethyl ether, diethylene glycol monoisopropyl ether, diethylene glycol monomethyl ether, dipropylene glycol monoethyl ether, dipropylene glycol monobutyl ether, dipropylene glycol monopropyl ether, dipropylene glycol monomethyl ether, tripropylene glycol monobutyl ether, tripropylene glycol monomethyl ether, propylene glycol monophenyl ether, 1,3-butylene glycol, propylene glycol n-propyl ether, propylene glycol n-butyl ether, diethylene glycol monoethyl ether, dipropylene glycol n-propyl ether, dipropylene glycol n-butyl ether, tripropylene glycol methyl ether, tripropylene glycol n-butyl ether, ethylene glycol dimethyl ether, ethylene glycol diethyl ether, ethylene glycol dibutyl ether, diethylene glycol diethyl ether, diethylene glycol dimethyl ether, dipropylene glycol dimethyl ether, diethylene glycol dibutyl ether, tetraethylene glycol dimethyl ether, triethylene glycol dimethyl ether, and polyethylene glycol dimethyl ether.

Specific examples of the alcohol-based organic solvent include methanol, ethanol, 1-propanol, isopropyl alcohol, n-butanol, diacetone alcohol, isobutanol, sec-butanol, tert-butanol, pentanol, 3-methyl-1,3-butanediol, 1,3-butanediol, 1,3-butylene glycol, octanediol, 2,4-diethylpentanediol, butylethylpropanediol, 2-methyl-1,3-propanediol, 4-hydroxy-4-methyl-2-pentanone, 2-ethyl-1-hexanol, 3,5,5-trimethyl-1-hexanol, isodecanol, isotridecanol, 3-methoxy-3-methyl-1-butanol, 2-methoxybutanol, 3-methoxybutanol, cyclohexanol, furfuryl alcohol, tetrahydrofurfuryl alcohol, benzyl alcohol, and methylcyclohexanol.

Examples of the organic solvent include halogen-containing organic solvent, nitrogen-containing compound, sulfur-containing compound, siloxane compound, and fluorine-containing organic solvent.

Specific examples of the halogen-containing organic solvent include dichloromethane, chloroform, carbon tetrachloride, dichloroethane, chlorobenzene, o-chlorotoluene, m-chlorotoluene, p-chlorotoluene, m-dichlorobenzene, and 1,2,3-trichloropropane.

Examples of the nitrogen-containing compound include nitrobenzene, acetonitrile, benzonitrile, N,N-dimethylformamide, N,N-dimethylacetamide, N-methylpyrrolidone, and 1,3-dimethyl-2-imidazolidinone.

Examples of the sulfur-containing compound include carbon disulfide and dimethyl sulfoxide.

Examples of the siloxane compound include hexamethyldisiloxane, hexaethyldisiloxane, octamethyltrisiloxane, octaethyltrisiloxane, hexamethylcyclotrisiloxane, hexaethylcyclotrisiloxane, octamethylcyclotetrasiloxane, octaethylcyclotetrasiloxane, and decamethyltetrasiloxane.

Examples of the fluorine-containing organic solvent include polyfluoroaromatic hydrocarbons (for example, 1,3-bis(trifluoromethyl)benzene); polyfluoroaliphatic hydrocarbon (for example, C₆F₁₃CH₂CH₃ (for example, ASAHIKLIN (registered trademark) AC-6000 from AGC Inc.), 1,1,2,2,3,3,4-heptafluorocyclopentane (for example, ZEORORA (registered trademark) H from Zeon Corporation); hydrofluoroether (HFE) (for example, alkyl perfluoroalkyl ether (perfluoroalkyl group and alkyl group may be linear or branched), such as perfluoropropyl methyl ether (C₃F₇OCH₃) (for example, NOVEC (trademark) 7000 from Sumitomo 3M Limited), perfluorobutyl methyl ether (C₄F₉OCH₃) (for example, NOVEC (trademark) 7100 from Sumitomo 3M Limited), perfluorobutyl ethyl ether (C₄F₉OC₂H₅) (for example, NOVEC (trademark) 7200 from Sumitomo 3M Limited), and perfluorohexyl methyl ether (C₂F₅CF(OCH₃)C₃F₇) (for example, NOVEC (trademark) 7300 from Sumitomo 3M Limited), and CF₃CH₂OCF₂CHF₂ (for example, ASAHIKLIN (registered trademark) AE-3000 from AGC Inc.)); and hydrofluoroolefin (HFO) (for example, 1-chloro-2,3,3-trifluoro-1-propene (HCFO-1233 yd) (for example, AMOLEA (registered trademark) AS-300 from AGC Inc.), OPTEON (registered trademark) SF01, SF05, SF10, SF30, SF33, SF70, SF79, and SF80 from The Chemours Company).

The content of the liquid medium, with respect to the total amount of the surface treatment agent, is preferably from 50 to 99.999 mass %, more preferably from 80 to 99.99 mass %, and still more preferably from 90 to 99.9 mass %. For the surface treatment agent intended for use in wet coating, the content of the liquid medium, with respect to the total amount of the surface treatment agent, may be from 90 to 99.99 mass %, may be from 95 to 99.98 mass %, may be from 97 to 99.97 mass %, and may be from 98 to 99.95 mass %.

### <Other Components>

The surface treatment agent may contain other components besides the liquid medium, as long as the effects of the present disclosure are not degraded.

Examples of such other components include known additives such as acid catalyst and basic catalyst that promote hydrolysis and condensation reaction of the reactive silyl group.

The catalyst usable herein includes freely selectable appropriate acid or base, transition metal (for example, Ti, Ni, Sn, Zr, Al, B, and the like), sulfur-containing compound having lone pair in the molecular structure, and nitrogen-containing compound (such as sulfoxide compound, aliphatic amine compound, aromatic amine compound, phosphoric acid amide compound, amide compound, and urea compound).

Examples of the acid catalyst include acetic acid, formic acid, trifluoroacetic acid, hydrochloric acid, nitric acid, sulfuric acid, phosphoric acid, sulfonic acid, methanesulfonic acid, and p-toluenesulfonic acid.

Examples of the base catalyst include ammonia, sodium hydroxide, and potassium hydroxide; and organic amine such as triethylamine and diethylamine.

Examples of such other components also include metal compound having a hydrolyzable group (the metal compound having a hydrolyzable group is also referred to as “specific metal compound”, hereinafter). As a result of inclusion of the specific metal compound in the surface treatment agent, the surface treatment layer may be improved in the slippage and antifouling property. Examples of the specific metal compound include those represented by formulae (M1) to (M3) below:

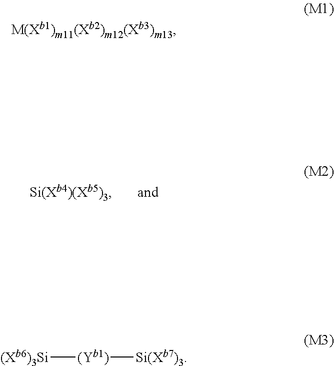

In formula (M1),
M represents a trivalent or tetravalent metal atom.
Each X^{b1} independently represents a hydrolyzable group.
Each X^{b2} independently represents a siloxane skeleton-containing group.
Each X^{b3} independently represents a hydrocarbon chain-containing group.
m11 represents an integer from 2 to 4;
each of m12 and m13 independently represents an integer from 0 to 2;
in a case where M represents a trivalent metal atom, m11+m12+m13 represents 3;
   and in a case where M represents a tetravalent metal atom, m11+m12+m13 represents 4.

In formula (M2),
X^{b4} represents a hydrolyzable silane oligomer residue.
Each X^{b5} independently represents a hydrolyzable group or an alkyl group having 1 to 4 carbon atoms.

In formula (M3),
each of X^{b6} and X^{b7} independently represents a hydrolyzable group or a hydroxy group.
Y^{b1} represents a divalent organic group.

The metal represented by M in formula (M1) also includes metalloid such as Si and Ge. M preferably represents a trivalent metal or a tetravalent metal, for which Al, Fe, In, Hf, Si, Ti, Sn, and Zr are more preferred; Al, Si, Ti, and Zr are still more preferred; and Si is particularly preferred.

The hydrolyzable group represented by X^{b1} in formula (M1) includes those same as the hydrolyzable group represented by Lin [—Si(R²)ₙL₃₋ₙ] in the reactive silyl group.

The siloxane skeleton-containing group represented by X^{b2} has a siloxane unit (—Si—O—), and may be linear or branched. The siloxane unit is preferably dialkylsilyloxy group, and examples thereof include dimethylsilyloxy group and diethylsilyloxy group. The number of repetitions of the siloxane unit in the siloxane skeleton-containing group is 1 or larger, preferably 1 to 5, more preferably 1 to 4, and still more preferably 1 to 3.

The siloxane skeleton-containing group may contain a divalent hydrocarbon group in a part of the siloxane skeleton. More specifically, a part of oxygen atoms in the siloxane skeleton may be replaced by divalent hydrocarbon group. Examples of the divalent hydrocarbon group include alkylene groups such as methylene group, ethylene group, propylene group, and butylene group.

Silicon atom at the terminal of the siloxane skeleton-containing group may have, bound thereto, hydrolyzable group, hydrocarbon group (preferably alkyl group) or the like.

The number of atoms in the siloxane skeleton-containing group is preferably 100 or smaller, more preferably 50 or smaller, and still more preferably 30 or smaller. The number of atoms is preferably 10 or larger.

The siloxane skeleton-containing group is preferably a group represented by *—(O—Si(CH₃)₂)ₙCH₃, where n represents an integer from 1 to 5, and * indicates a bonding site with a neighboring atom.

The hydrocarbon chain-containing group represented by X^{b3} may be composed only of a hydrocarbon chain, or may have an etheric oxygen atom between the carbon-carbon atoms of the hydrocarbon chain. The hydrocarbon chain may be linear or branched, and is preferably linear. The hydrocarbon chain may be a saturated hydrocarbon chain or an unsaturated hydrocarbon chain, and is preferably a saturated hydrocarbon chain. The number of carbon atoms in the hydrocarbon chain-containing group is preferably 1 to 3, more preferably 1 to 2, and still more preferably 1. The hydrocarbon chain-containing group is preferably alkyl group, and more preferably methyl group, ethyl group, or propyl group.

m1 preferably represents 3 or 4.

The compound represented by formula (M1) is preferably any of compounds represented by formulae (M1-1) to (M1-5) having Si for M, and more preferably a compound represented by formula (M1-1). The compound represented by formula (M1-1) is preferably tetraethoxysilane, tetramethoxysilane, or triethoxymethylsilane.

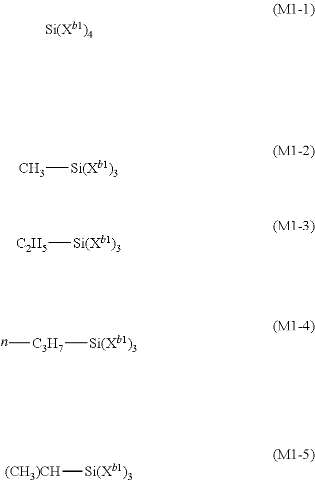

In formula (M2), the number of silicon atoms contained in the hydrolyzable silane oligomer residue represented by X^{b4} is preferably 3 or larger, more preferably 5 or larger, and still more preferably 7 or larger. The number of silicon atoms is preferably 15 or smaller, more preferably 13 or smaller, and still more preferably 10 or smaller.

The hydrolyzable silane oligomer residue may have an alkoxy group bound to silicon atom. Examples of the alkoxy group include methoxy group, ethoxy group, propoxy group, and butoxy group. Methoxy group and ethoxy group are preferred. The hydrolyzable silane oligomer residue may have one kind, or two or more kinds of these alkoxy groups, and preferably has one kind thereof.

Examples of the hydrolyzable silane oligomer residue include (C²H₅O)₃Si—(OSi(OC₂H₅)₂)₄O—*. Where, * indicates a binding site with a neighboring atom.

Examples of the hydrolyzable group represented by X^{b5} in formula (M2) include those same as the hydrolyzable group represented by L in [—Si(R²)ₙL₃₋ₙ] in the reactive silyl group, cyano group, hydrogen atom, and allyl group. Alkoxy group or isocyanato group is preferred. The alkoxy group preferably has 1 to 4 carbon atoms.

X^{b5} preferably represents a hydrolyzable group.

Examples of the compound represented by formula (M2) include (H₅C₂O)₃—Si—(OSi(OC₂H₅)₂)₄OC₂H₅.

The compound represented by formula (M3) is a compound having a reactive silyl group at each of both terminals of the divalent organic group, that is, bissilane.

Examples of the hydrolyzable group represented by X^{b6} and X^{b7} in formula (M3) include alkoxy group, acyloxy group, ketoxime group, alkenyloxy group, amino group, aminoxy group, amide group, isocyanato group, and halogen atom. Alkoxy group and isocyanato group are preferred. The alkoxy group is preferably alkoxy group having 1 to 4 carbon atoms. Methoxy group and ethoxy group are more preferred.

In formula (M3), X^{b6} and X^{b7} may be the same group or different groups. From the viewpoint of availability, X^{b6} and X^{b7} are preferably the same group.

In formula (M3), Y^{b1} represents a divalent organic group that binds the reactive silyl groups at both terminals. The number of carbon atoms in the divalent organic group Y^{b1} is preferably 1 to 8, and more preferably 1 to 3.

Examples of Y^{b1} include alkylene group, phenylene group, and alkylene group having etheric oxygen atom between the carbon atoms. Examples thereof include —CH₂CH₂—, —CH₂CH₂CH₂—, —CH₂CH₂CH₂CH₂—, —CH₂CH₂CH₂CH₂CH₂—, —CH₂CH₂CH₂CH₂CH₂CH₂—, —CH₂C(CH₃)₂CH₂—, —C(CH₃)₂CH₂CH₂C(CH₃)₂—, —CH₂CH₂OCH₂CH₂—, —CH₂CH₂CH₂OCH₂CH₂CH₂—, —CH(CH₃) CH₂OCH₂CH(CH₃)—, and —C₆H₄—.

Examples of the compound represented by formula (M3) include (CH₃O)₃Si(CH₂)₂Si(OCH₃)₃, (C₂H₅O)₃Si(CH₂)₂Si(OCH₅)₃, (OCN)₃Si(CH₂)₂Si(NCO)₃, Cl₃Si(CH₂)₂SiCl₃, (CH₃O)₃Si(CH₂)₆Si(OCH₃)₃, and (C₂H₅O)₃Si(CH₂)₆Si(OC₂H₅)₃.

The content of any other component optionally contained in the surface treatment agent, with respect to the total amount of the surface treatment agent, is preferably 10 mass % or less, and more preferably 1 mass % or less. The content of the specific metal compound, if present in the surface treatment agent, is preferably from 0.01 to 30 mass %, more preferably from 0.01 to 10 mass %, and still more preferably from 0.05 to 5 mass %, with respect to the total amount of the surface treatment agent.

The total content of the specific silane compound and other components (also referred to as “solid concentration”, hereinafter), with respect to the total amount of the surface treatment agent, is preferably from 0.001 to 40 mass %, more preferably from 0.01 to 20 mass %, and still more preferably from 0.1 to 10 mass %. The solid concentration of the surface treatment agent is a value calculated from the mass before heating, and the mass after heating in a convection dryer at 120° C. for 4 hours.

Examples of the surface treatment include dry coating and wet coating.

Examples of the dry coating include techniques such as vacuum deposition, CVD, PVD, and sputtering. The dry coating preferably relies upon vacuum deposition, from the viewpoint of suppressing decomposition of the compound, and convenience of the apparatus. The vacuum deposition may employ a pellet-like material having the compound of the present disclosure impregnated into a metal porous material made of iron, steel, or the like. The pellet-like material having impregnated therein the compound of the present disclosure usable herein is also obtainable by allowing a composition that contains the compound of the present disclosure and a liquid medium to impregnate into a metal porous material made of iron, steel or the like, and then drying off the liquid medium.

Examples of the wet coating include spin coating, wipe coating, spray coating, squeegee coating, dip coating, die coating, inkjet method, flow coating, roll coating, casting, the Langmuir-Blodgett method, and gravure coating.

For improved abrasion resistance of the surface treatment layer, there may be an optional operation for promoting a reaction between the compound having a chain organo(poly)siloxane residue and a reactive silyl group, with the underlayer. Examples of the operation include heating, humidification, and light irradiation.

For example, the base having formed thereon the surface treatment layer may be heated in a moist atmosphere, to promote reaction such as hydrolysis reaction of the hydrolyzable group, reaction between hydroxy group or the like on the surface of the underlayer and the silanol group, and generation of siloxane bond as a result of condensation reaction of the silanol group.

After the surface treatment, any compound that is present in the surface treatment layer and remains chemically unbound to other compound or to the underlayer, may be removed as necessary. Examples of method of removal include flooding of solvent over the surface treatment layer, and wiping with a cloth soaked with the solvent.

### [Underlayer Forming Composition]

The underlayer forming composition of the present disclosure is used for forming an underlayer, in an optical article that includes a base, the underlayer, and a surface treatment layer that contains a compound having a chain group and a reactive silyl group, arranged in this order.

The underlayer forming composition contains a silane compound other than silica.

In one aspect, the underlayer forming composition of the present disclosure is preferably the one used for forming the underlayer, in the optical article that includes the base, the underlayer, and the surface treatment layer that contains the compound having a chain organo(poly)siloxane residue and the reactive silyl group, arranged in this order.

The underlayer forming composition of the present disclosure is usable for forming the underlayer in the optical article of the present disclosure. By forming the underlayer with use of the underlayer forming composition of the present disclosure, the surface treatment layer will have excellent abrasion resistance.

Preferred aspects of the optical article, having the base, the underlayer, and the surface treatment layer that contains a compound having a chain group and a reactive silyl group, arranged in this order, are as described above.

Also preferred aspects of the underlayer forming composition are as described above.

### [Surface Treatment Set]

The surface treatment set of the present disclosure includes an underlayer forming composition used for forming an underlayer, and a surface treatment agent used for forming a surface treatment layer, in an optical article having a base, the underlayer, and the surface treatment layer arranged in this order.

The underlayer forming composition contains a silane compound other than silica, and the surface treatment agent contains a compound having a chain group and a reactive silyl group.

In one aspect, the underlayer forming composition preferably contains a silane compound other than silica, and the surface treatment agent preferably contains a compound having a chain organo(poly)siloxane residue and a reactive silyl group.

The surface treatment set of the present disclosure is usable for forming the underlayer and the surface treatment layer in the optical article of the present disclosure. By forming the underlayer and the surface treatment layer with use of the surface treatment set of the present disclosure, the surface treatment layer will have excellent abrasion resistance.

Preferred aspects of the optical article, having the base, the underlayer, and the surface treatment layer that contains a compound having a chain group and a reactive silyl group, arranged in this order, are as described above.

Also preferred aspects of the underlayer forming composition and the surface treatment agent are as described above.

### EXAMPLES

Hereinafter, the present invention will be described in more detail with reference to Examples, to which the present invention is however by no means limited.

### <Preparation of Underlayer Forming Composition>

In a glass container having a stirrer and a thermometer set thereto, 6 mass % in total in terms of Si equivalent concentration, of compound A and compound B combined according to ratio A and ratio B listed in Table 1 described later, 11.3 mass % of pure water, 0.54 mass % of a 10 mass % aqueous nitric acid solution, and the balance of a solvent (product name “SOLMIX AP-11” (from Nippon Alcohol Sales Co., Ltd.)) for adjusting the total to 100 mass %, were mixed, and the mixture was stirred at 60° C. for one hour.

Next, Solmix AP-11 was further added, to obtain an underlayer forming composition having a Si equivalent concentration of 0.4 mass %.

Details of the compound A and the compound B are as follows.

### -Compound A-

TEOS: Si(OEt)₄, tetraethoxysilane
IS: Si(NCO)₄, tetraisocyanatosilane

### -Compound B-

BTM: (EtO)₃Si—CH₂—Si(OEt)₃, bistriethoxysilylmethane
BTE: (EtO)₃Si—CH₂CH₂—Si(OEt)₃, bistriethoxysilylethane
MTMS: CH₃—Si(OEt)₃, methyltriethoxysilane
MIS: CH₃—Si(NCO)₃, methyltriisocyanatosilane

### <Preparation of Surface Treatment Agent>

In a polypropylene container having a stirrer and a thermometer set therein, 0.05 mass % of a compound listed in Table 1 was added to 99.5 mass % of Solmix AP-11, and the content was stirred at 25° C. for 30 minutes to obtain a surface treatment agent.

Details of the compounds contained in the surface treatment agent are as follows.

### (Preparation of Compound 11)

X-22-1968 (from Shin-Etsu Chemical Co., Ltd.) was used as Compound 11. Compound 11 contains a chain organo(poly)siloxane residue and a reactive silyl group.

### (Synthesis of Compound 12)

Compound 12 was synthesized with reference to Example 1 of WO 2023/017830 A. In Compound 12, n10 was found to have an average value of 19.

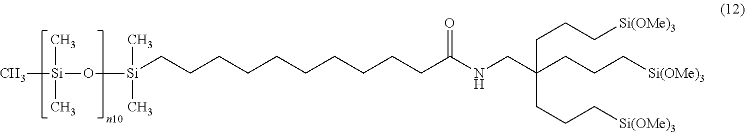

### (Synthesis of Compound 13)

Compound 13 was synthesized with reference to Exemplary Synthesis 1 of JP 2017-119849 A. In Compound 13, n10 was found to have an average value of 24.

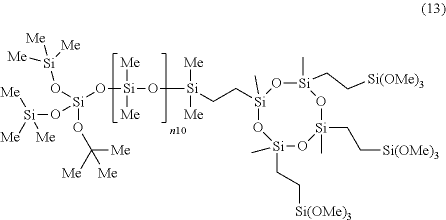

### (Synthesis of Compound 14)

Compound 14 was synthesized with reference to Exemplary Synthesis 4 of WO 2016-068138 A.

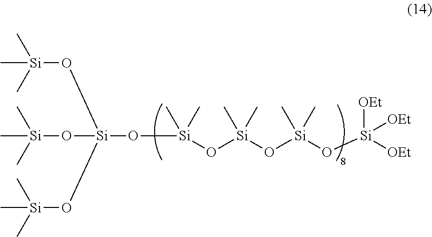

### (Synthesis of Compound 15)

### Synthesis of Compound 15A

Tetrahydrofuran (THE, 101 g) was added to hexamethylcyclotrisiloxane (65 g), and the mixture was stirred at 25° C. for dissolution. Next, a liquid that includes lithium salt of trimethylsilanol (5.1 g) suspended in THF (20 g) was added, and the mixture was stirred at 25° C. for 2 hours. Next, chlorodimethylsilane (10.5 g) was added, and the mixture was stirred at 25° C. for one hour. The product was extracted by adding hexane and water, the solvent and the volatiles were distilled off under reduced pressure, and the residue was subjected to flash column chromatography (eluent: hexane/dichloromethane) with use of silica gel, to obtain 25 g of Compound 15A. In Compound 15A, n10 was found to have an average value of 13. Structure of Compound 15A was confirmed from NMR data below.

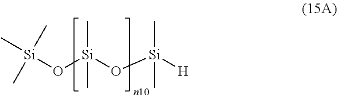

¹H-NMR (400 MHz, CDCl₃) δ:4.63 (hept, J=2.8 Hz, 1H), 0.21-0.08 (m, 6H), 0.07-0.12 (m, 87H).

### Synthesis of Compound 15B

To Compound 15A (2.0 g), dichloromethane (20 g) and 9-bromo-1-nonene (1.0 g) were added, and the mixture was stirred at 25° C. for homogeneity. Next, a toluene solution of platinum/1,3-divinyl-1,1,3,3-tetramethyldisiloxane complex (platinum content: 3 mass %, 4.1 mg) was added, and the mixture was stirred at 25° C. for 2 hours. Next, the volatiles were distilled off under reduced pressure, and the residue was subjected to flash column chromatography (eluent: hexane/dichloromethane) with use of silica gel, to obtain 1.6 g of Compound 15B. In Compound 15B, n10 was found to have an average value of 13. Structure of Compound 15B was confirmed from NMR data below.

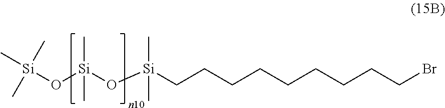

¹H-NMR (400 MHz, CDCl₃) δ:3.41 (td, J=6.9, 1.9 Hz, 2H), 1.99-1.76 (m, 2H), 1.49-1.09 (m, 12H), 0.61-0.42 (m, 2H), 0.33-0.24 (m, 93H).

### Synthesis of Compound 15C

To Compound 15B (1.6 g), THF (20 g), an allylmagnesium chloride solution (2.0 M in THF) (20 mL), and copper(II) chloride (0.02 g) were added, and the mixture was stirred at 50° C. for 2 hours. The product was extracted by adding hydrochloric acid and hexane, a volatiles were distilled off under reduced pressure, and the residue was subjected to flash column chromatography (eluent: hexane/dichloromethane) with use of silica gel, to obtain 1.3 g of Compound 15C. In Compound 15C, n10 was found to have an average value of 13. Structure of Compound 15C was confirmed from NMR data below.

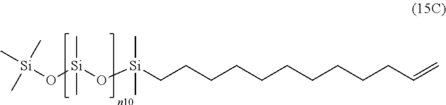

¹H-NMR (400 MHz, CDCl₃) δ:5.95-5.59 (m, 1H), 5.12-4.75 (m, 2H), 2.13-1.89 (m, 2H), 1.64-0.84 (m, 16H), 0.67-0.36 (m, 2H), 0.30-0.41 (m, 93H).

### Synthesis of Compound 15

To compound 15C (1.3 g), dichloromethane (10 g) was added for dissolution. Next, a toluene solution of platinum/1,3-divinyl-1,1,3,3-tetramethyldisiloxane complex (platinum content: 3 mass %, 4.1 mg), aniline (2.6 mg), and trimethoxysilane (0.60 g) were added, and the mixture was stirred at 50° C. for 2 hours. The solvent was distilled off under reduced pressure, to obtain 1.4 g of Compound 15. In Compound 15, n10 was found to have an average value of 13. Structure of Compound 15 was confirmed from NMR data below.

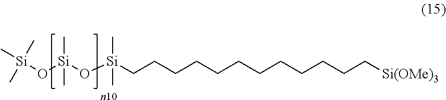

¹H-NMR (400 MHz, CDCl₃) δ:3.57 (s, 9H), 1.98-0.95 (m, 21H), 0.72-0.61 (m, 2H), 0.52 (t, J=7.7 Hz, 2H), 0.26-0.22 (m, 93H).

### (Synthesis of Compound 16)

Compound 16 was synthesized with reference to the method of synthesis of Compound 15. In Compound 16, n10 was found to have an average value of 28.

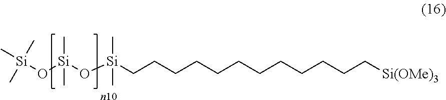

### (Synthesis of Compound 17)

### Synthesis of Compound 17A

To Compound 15A (2.0 g), dichloromethane (20 g) and 18-bromo-1-octadecene (1.0 g) were added, and the mixture was stirred at 25° C. for homogeneity. Next, a toluene solution of platinum/1,3-divinyl-1,1,3,3-tetramethyldisiloxane complex (platinum content: 3 mass %, 4.1 mg) was added, and the mixture was stirred at 25° C. for 2 hours. The volatiles were then distilled off under reduced pressure, and the residue was subjected to flash column chromatography (eluent: hexane/dichloromethane) with use of silica gel, to obtain 1.2 g of Compound 17A. In Compound 17A, n10 was found to have an average value of 13. Structure of Compound 17A was confirmed from NMR data below.

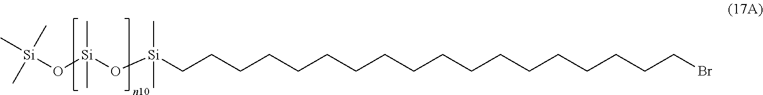

¹H-NMR (400 MHz, CDCl₃) δ:3.41 (t, J=6.9 Hz, 2H), 1.85 (p, J=7.1 Hz, 2H), 1.75-0.95 (m, 30H), 0.53 (s, 2H), 0.34-0.25 (m, 93H).

### Synthesis of Compound 17B

To Compound 17A (1.2 g), THF (20 g), an allylmagnesium chloride solution (2.0 M in THF) (20 mL), and copper(II) chloride (0.02 g) were added, and the mixture was stirred at 50° C. for 2 hours. The product was extracted by adding hydrochloric acid and hexane, a volatiles was distilled off under reduced pressure, and the residue was subjected to flash column chromatography (eluent: hexane/dichloromethane) with use of silica gel, to obtain 1.1 g of Compound 17B. In Compound 17B, n10 was found to have an average value of 13. Structure of Compound 17B was confirmed from NMR data below.

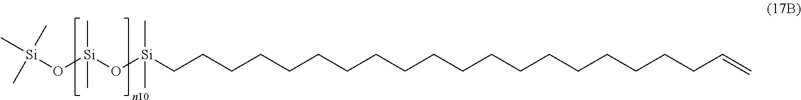

¹H-NMR (400 MHz, CDCl₃) δ:5.74 (ddt, J=16.9, 10.2, 6.7 Hz, 1H), 5.01-4.74 (m, 2H), 2.08-1.84 (m, 2H), 1.75-0.95 (m, 34H), 0.45 (dd, J=9.4, 5.7 Hz, 2H), 0.34-0.25 (m, 93H).

### Synthesis of Compound 17

To Compound 17B (1.1 g), dichloromethane (10 g) was added for dissolution. Next, a toluene solution of platinum/1,3-divinyl-1,1,3,3-tetramethyldisiloxane complex (platinum content: 3 mass %, 4.1 mg), aniline (2.6 mg), and trimethoxysilane (0.60 g) were added, and the mixture was stirred at 50° C. for 2 hours. The solvent was distilled off under reduced pressure, to obtain 1.1 g of Compound 17. In Compound 17, n10 was found to have an average value of 13. Structure of Compound 17 was confirmed from NMR data below.

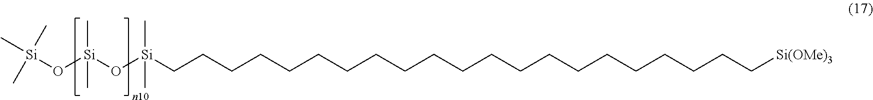

¹H-NMR (400 MHz, CDCl₃) δ:3.50 (s, 9H), 1.75-0.95 (m, 38H), 0.62-0.54 (m, 2H), 0.45 (dd, J=9.4, 5.9 Hz, 2H), 0.34-0.25 (m, 93H).

### (Synthesis of Compound 18)

Compound 18 was synthesized with reference to Exemplary Synthesis 9 of JP 2024-25757 A. In Compound 18, n10 was found to have an average value of 59.

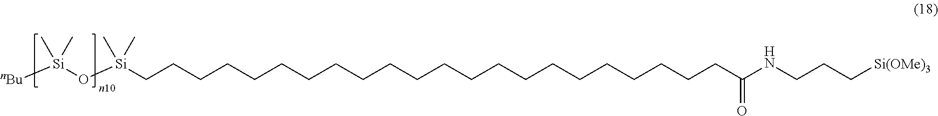

### (Synthesis of Compound 19)

### Synthesis of Compound 19A

Dichloromethane (100 g) and trichloroisocyanuric acid (14 g) were added to 1,1,1,3,5,5,5-heptamethyltrisiloxane (10 g), and the mixture was stirred at 25° C. for 3 hours. Next, the reaction liquid was filtered to remove an insoluble matter, and the filtrate was then distilled to remove the volatiles. Water (20 g), THF (40 g) and triethylamine (10 g) were added to the thus obtained crude liquid, and the mixture was stirred at 25° C. for 2 hours. The product was extracted by adding hexane and water, and a volatiles was distilled off. The thus obtained crude liquid was purified by flash column chromatography (eluent: hexane/ethyl acetate) with use of silica gel, to obtain 8.3 g of Compound 19A. Structure of Compound 19A was confirmed from NMR data below.

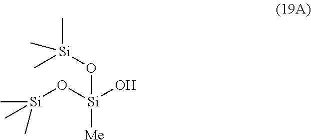

¹H-NMR (400 MHz, CDCl₃) δ:2.41 (q, J=7.2 Hz, 1H), 0.20-0.21 (m, 21H).

### Synthesis of Compound 19B

To Compound 19A (2.0 g), THF (20 g) was added, the mixture was cooled to 0° C., to which a methyl lithium solution (3.1 M in diethoxymethane) (2.7 mL) was added, and the mixture was stirred at 25° C. for 10 minutes. Next, a solution of hexamethylcyclotrisiloxane (5.6 g) dissolved in THF (20 g) was added, and the mixture was stirred at 25° C. for 4 hours. Next, chlorodimethylsilane (2.0 g) was added, and the mixture was stirred at 25° C. for one hour. The product was extracted by adding hexane and water, and volatiles were evaporated off. The thus obtained crude liquid was purified by flash column chromatography (eluent: hexane/dichloromethane) with use of silica gel, to obtain 4.3 g of Compound 19B. In Compound 19B, n10 was found to have an average value of 9. Structure of Compound 19B was confirmed from NMR data below.

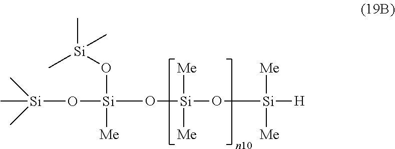

¹H-NMR (400 MHz, CDCl₃) δ:4.63 (p, J=2.8 Hz, 1H), 0.11 (d, J=2.8 Hz, 6H), 0.09-0.12 (m, 75H).

### Synthesis of Compound 19C

To Compound 19B (2.3 g), dichloromethane (20 g) and 18-bromo-1-octadecene (0.75 g) were added, and the mixture was stirred for homogeneity. Next, a toluene solution of platinum/1,3-divinyl-1,1,3,3-tetramethyldisiloxane complex (platinum content: 3 mass %, 4.1 mg) was added, and the mixture was stirred at 25° C. for 2 hours. The volatiles was then distilled off under reduced pressure, and the residue was subjected to flash column chromatography (eluent: hexane/dichloromethane) with use of silica gel, to obtain 1.8 g of Compound 19C. In Compound 19C, n10 was found to have an average value of 9. Structure of Compound 19C was confirmed from NMR data below.

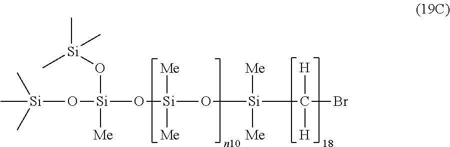

¹H-NMR (400 MHz, CDCl₃) δ:3.33 (t, J=6.9 Hz, 2H), 1.78 (dt, J=14.5, 7.0 Hz, 2H), 1.42-1.08 (m, 30H), 0.45 (t, J=7.7 Hz, 2H), 0.09-0.12 (m, 81H).

### Synthesis of Compound 19D

To Compound 19C (1.8 g), THF (20 g), an allylmagnesium chloride solution (2.0 M in THF) (20 mL) and copper(II) chloride (0.02 g) were added, and the mixture was stirred at 50° C. for 2 hours. The product was extracted by adding hydrochloric acid and hexane, a volatiles was distilled off under reduced pressure, and the residue was subjected to flash column chromatography (eluent: hexane/dichloromethane) with use of silica gel, to obtain 1.5 g of Compound 19D. In Compound 19D, n10 was found to have an average value of 9. Structure of Compound 19D was confirmed from NMR data below.

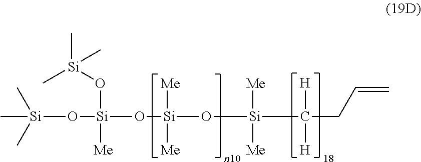

¹H-NMR (400 MHz, CDCl₃) δ:5.74 (ddt, J=17.0, 10.2, 6.7 Hz, 1H), 5.01-4.76 (m, 2H), 2.07-1.87 (m, 2H), 1.41-0.97 (m, 34H), 0.45 (dd, J=9.5, 5.9 Hz, 2H), 0.09-0.12 (m, 81H) . . . .

### Synthesis of Compound 19

To Compound 19D (1.5 g), dichloromethane (10 g) was added for dissolution. Next, a toluene solution of platinum/1,3-divinyl-1,1,3,3-tetramethyldisiloxane complex (platinum content: 3 mass %, 4.1 mg), aniline (2.6 mg), and trimethoxysilane (0.60 g) were added, and the mixture was stirred at 50° C. for 2 hours. The solvent was distilled off under reduced pressure, to obtain 1.6 g of Compound 19. In Compound 19, n10 was found to have an average value of 9. Structure of Compound 19 was confirmed from NMR data below.

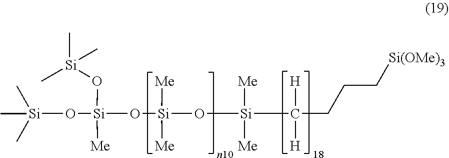

¹H-NMR (400 MHz, CDCl₃) δ:3.49 (s, 9H), 1.81-0.97 (m, 38H), 0.65-0.51 (m, 2H), 0.45 (dd, J=9.8, 5.3 Hz, 2H), 0.09-0.12 (m, 81H).

### (Synthesis of Compound 20)

Compound 20 was synthesized with reference to Exemplary Synthesis 40 of JP 2024-25757 A.

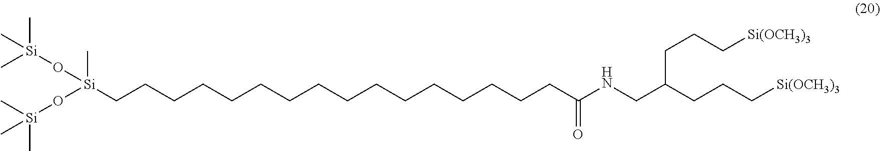

### (Synthesis of Compound 21)

Compound 21 was synthesized with reference to Exemplary Synthesis 26 of JP 2024-25757 A.

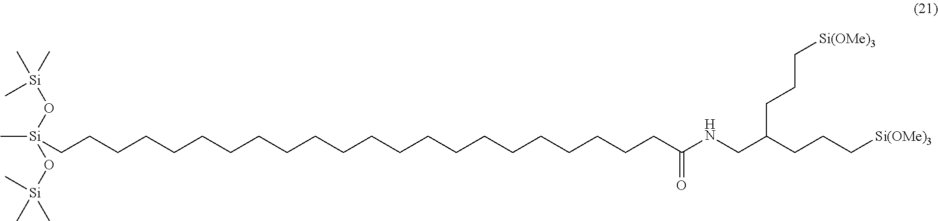

### (Synthesis of Compound 22)

### Synthesis of Compound 22A

THF (40 g) and magnesium (0.9 g) were added to 18-bromo-1-octadecene (10 g), and the mixture was stirred at 60° C. for 2 hours. The reaction liquid was filtered, to obtain 50 g of Compound 22A. The product was titrated with 1,10-phenanthroline, and confirmed to have a concentration of 0.4 M.

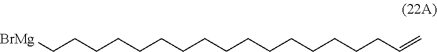

### Synthesis of Compound 22B

THF (20 g) and magnesium (1.1 g) were added to 11-bromo-1-undecene (10 g), and the mixture was stirred at 60° C. for 2 hours. The reaction liquid was filtered, to obtain 30 g of Compound 22B. The product was titrated with 1,10-phenanthroline, and confirmed to have a concentration of 0.8 M.

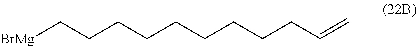

### Synthesis of Compound 22C

THF (10 g), Compound 23A described later (0.4 M) (20 mL), and copper(II) chloride (0.05 g) were added to Compound 22B (1 g), and the mixture was stirred at 60° C. for 24 hours. The product was extracted by adding hydrochloric acid and hexane, a volatiles were distilled off under reduced pressure, and the residue was subjected to flash column chromatography (eluent: hexane/dichloromethane) with use of 10% silver nitrate-impregnated silica gel, to obtain 0.4 g of Compound 22C. Structure of Compound 22C was confirmed from NMR data below.

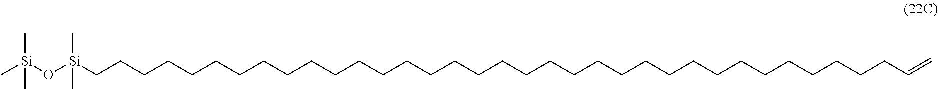 [SMILES: C=CCCCCCCCCCCCCCCCCCCCCCCCCCCCCCCCCCC[Si](C)(C)O[Si](C)(C)C]

¹H-NMR (400 MHz, CDCl₃) δ:5.81 (ddt, J=16.9, 10.2, 6.7 Hz, 1H), 5.22-4.68 (m, 2H), 2.21-1.85 (m, 2H), 1.54-1.00 (m, 64H), 0.50 (t, J=7.1 Hz, 2H), 0.25-0.19 (m, 15H).

### Synthesis of Compound 22

A toluene solution of platinum/1,3-divinyl-1,1,3,3-tetramethyldisiloxane complex (platinum content: 3 mass %, 5 mg), aniline (3 mg), and trimethoxysilane (0.60 g) were added to Compound 22C (0.4 g) dissolved in dichloromethane (10 g), and the mixture was stirred at 50° C. for 2 hours. The solvent was distilled off under reduced pressure, to obtain 0.5 g of Compound 22. Structure of Compound 22 was confirmed from NMR data below.

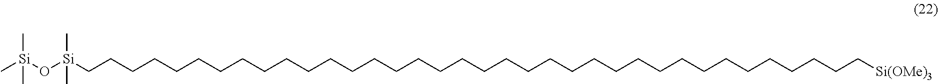

¹H-NMR (400 MHz, CDCl₃) δ:3.57 (s, 9H), 1.54-1.00 (m, 68H), 0.77-0.61 (m, 2H), 0.50 (t, J=7.6 Hz, 2H), 0.25-0.19 (m, 15H).

### (Synthesis of Compound 23)

### Synthesis of Compound 23A

Dichloromethane (10 g), 1,1,1,3,3-pentamethyldisiloxane (15 g), and a toluene solution of platinum/1,3-divinyl-1,1,3,3-tetramethyldisiloxane complex (platinum content: 3 mass %, 50 mg) were added to 18-bromo-1-octadecene (10 g), and the mixture was stirred at 25° C. for 24 hours. The volatiles was then distilled off under reduced pressure, and the residue was subjected to flash column chromatography (eluent: hexane/dichloromethane) with use of silica gel, to obtain 12 g of Compound 23A. Structure of Compound 23A was confirmed from NMR data below.

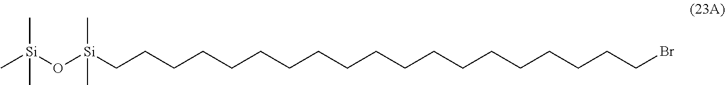 [SMILES: C[Si](C)(C)O[Si](C)(C)CCCCCCCCCCCCCCCCCCCBr]

¹H-NMR (400 MHz, CDCl₃) δ:3.41 (t, J=6.9 Hz, 2H), 1.85 (p, J=7.0 Hz, 2H), 1.49-1.04 (m, 30H), 0.50 (t, J=7.6 Hz, 2H), 0.25-0.19 (m, 15H).

### Synthesis of Compound 23B

THF (10 g), Compound 22B (0.8 M) (10 mL), and copper(II) chloride (0.05 g) were added to Compound 23A (1 g), and the mixture was stirred at 60° C. for 24 hours. The product was extracted by adding hydrochloric acid and hexane, a volatiles was distilled off under reduced pressure, and the residue was subjected to flash column chromatography (eluent: hexane/dichloromethane) with use of 10% silver nitrate-impregnated silica gel, to obtain 0.5 g of Compound 23B. Structure of Compound 23B was confirmed from NMR data below.

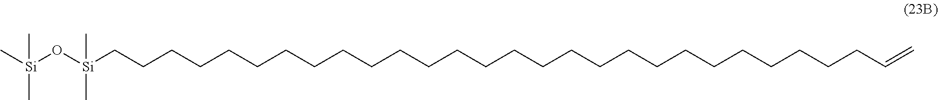 [SMILES: C=CCCCCCCCCCCCCCCCCCCCCCCCCCCC[Si](C)(C)O[Si](C)(C)C]

¹H-NMR (400 MHz, CDCl₃) δ:5.81 (ddt, J=16.9, 10.1, 6.7 Hz, 1H), 5.08-4.82 (m, 2H), 2.13-1.93 (m, 2H), 1.54-1.00 (m, 50H), 0.63-0.41 (m, 2H), 0.25-0.19 (m, 15H),

### Synthesis of Compound 23

A toluene solution of platinum/1,3-divinyl-1,1,3,3-tetramethyldisiloxane complex (platinum content: 3 mass %, 5 mg), aniline (3 mg), and trimethoxysilane (0.60 g) were added to Compound 23B (0.5 g) dissolved in dichloromethane (10 g), and the mixture was stirred at 50° C. for 2 hours. The solvent was distilled off under reduced pressure, to obtain 0.6 g of Compound 23. Structure of Compound 23 was confirmed from NMR data below.

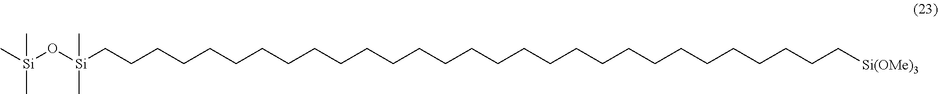

¹H-NMR (400 MHz, CDCl₃) δ:3.57 (s, 9H), 1.54-1.00 (m, 54H), 0.77-0.61 (m, 2H), 0.50 (t, J=7.3 Hz, 2H), 0.25-0.19 (m, 15H).

### (Synthesis of Compound 24)

Compound 24 was synthesized with reference to Exemplary Synthesis 12 of JP 2024-25757 A.

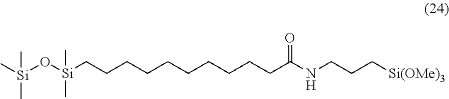

### (Synthesis of Compound 25)

Compound 25 was synthesized with reference to Exemplary Synthesis 9 of JP 2024-25757 A. In Compound 25, n10 was found to have an average value of 59.

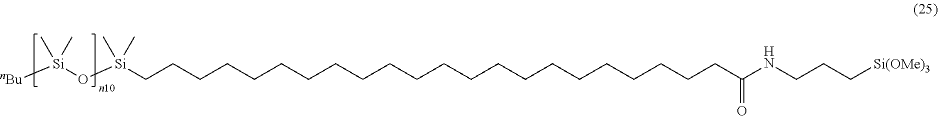

### [Production of Optical Article]

### <Cases 1 to 33, and 36 to 77>

A glass base cleaned by plasma treatment (water contact angle: 5 degrees, 100 mm×100 mm) was used. On the surface of the glass base, 2 mL of the underlayer forming composition was applied by spin coating, and dried at 25° C. for one minute. Next, on the dried film, 0.0074 mL/cm² of a surface treatment agent was applied by spray coating, and annealed at 140° C. for 30 minutes. The work was then held in a thermo-hygrostat set at a temperature of 60° C. and a relative humidity of 90% RH for 16 hours. The surface of the coating film formed by applying the surface treatment agent was wiped with a paper waste impregnated with ethanol, whereby an optical article having the base, the underlayer, and the surface treatment layer arranged in this order was obtained.

### <Case 34>

A glass base cleaned by plasma treatment (water contact angle: 5 degrees, 100 mm×100 mm) was used. On the surface of the glass base, 0.0074 mL/cm² of a surface treatment agent was applied by spray coating, and annealed at 140° C. for 30 minutes. The work was then held in a thermo-hygrostat set at a temperature of 60° C. and a relative humidity of 90% RH for 16 hours. The surface of the surface treatment layer was wiped with a paper waste impregnated with ethanol, whereby an optical article having the base and the surface treatment layer arranged in this order was obtained.

### <Case 35>

A glass base cleaned by plasma treatment (water contact angle: 5 degrees, 100 mm×100 mm) was used. A silicon oxide layer was formed on the surface of the glass base, by the method below.

On a molybdenum boat in a vacuum vapor deposition apparatus (VTR-350M, from ULVAC KIKO, Inc.), 30 g of silicon oxide (from Canon Optron, Inc.) was placed as a vapor deposition material (evaporation source), a glass base was disposed in the vacuum vapor deposition apparatus, and the inside of the vacuum vapor deposition apparatus was evacuated until the pressure reached 5×10⁻³ Pa or below. The boat with silicon oxide placed thereon was heated up to 2,000° C. to cause vacuum deposition onto the glass base, whereby a silicon oxide layer having a thickness of 10 nm was formed.

Next, on the dried film, 0.0074 mL/cm² of a surface treatment agent was applied by spray coating, and annealed at 140° C. for 30 minutes. The work was then held in a thermo-hygrostat set at a temperature of 60° C. and a relative humidity of 90% RH for 16 hours. The surface of the surface treatment layer was wiped with a paper waste impregnated with ethanol, whereby an optical article having the base, the silicon oxide layer, and the surface treatment layer arranged in this order was obtained.

### <Initial Water Contact Angle>

Onto the surface treatment layer of the optical article, 2 μL of pure water was added dropwise. The initial water contact angle was measured with use of a contact angle meter (Model “DM-500”, from Kyowa Interface Science Co., Ltd.). Measurement values from five points on the surface treatment layer were averaged to determine the water contact angle. The water contact angle was calculated by the 20 method. Every measurement was followed by ionizer treatment and air blow treatment.

### <Abrasion Resistance>

Abrasion test was conducted on the surface of the surface treatment layer of the optical article, with use of a triple plane abrasion tester (Model “PA-300A”, from Daiei Kagaku Seiki Mfg. Co., Ltd.), equipped with an indenter (bottom area: 100 mm²) having shirting No. 3 attached thereto, under abrasion conditions including a load of 1,000 g, a rotation speed of 60 rpm, and a stroke length of 40 mm. The abrasion test was conducted while keeping the shirting moistened with 1 mL of JIS-compliant artificial sweat. The water contact angle was measured every ten rubs. The method of measuring the water contact angle is the same as the method of measuring the initial water contact angle.

If the water contact angle was found to be 90 degrees or larger, the abrasion test was further conducted ten times. The abrasion test was terminated when the water contact angle fell below 90 degrees.

The number of rubs the water contact angle was confirmed to remain 90 degrees or above was shown in Table 1.

### <Si-Ka Line Intensity of Surface Treatment Layer>

A sapphire substrate with vapor-deposited silica was prepared. Si-Ka line intensity 1 of the sapphire substrate with vapor-deposited silica was measured by X-ray fluorescence analysis.

On the sapphire substrate with vapor-deposited silica, the underlayer was formed in the same manner as in the production of the optical article. Si-Ka line intensity 2 of the underlayer, formed on the sapphire substrate with vapor-deposited silica, was measured by X-ray fluorescence analysis.

The Si-Ka line intensity of the underlayer was calculated by subtracting the Si-Ka line intensity 1 from the Si-Ka line intensity 2.

Further, on the sapphire substrate with vapor-deposited silica, the underlayer was formed in the same manner as in the production of the optical article, the surface treatment layer was then formed, followed by removal of the excessive portion. Si-Ka line intensity 3 of the film remained after removal of the excessive portion was measured by X-ray fluorescence analysis.

The Si-Ka line intensity of the surface treatment layer was calculated by subtracting the Si-Ka line intensity 2 from the Si-Ka line intensity 3. The unit is kcps (kilocounts per second).

Results of evaluation are shown in Tables 1 to 3. Cases 1 to 33 and 36 to 77 correspond to Examples, and Cases 34 and 35 correspond to Comparative Examples.

In Tables 1 and 2, the column for the specific silane compound contains description regarding corresponding formula, the number of Si atoms, and the number of atoms of the linking group of the specific silane compound contained in the surface treatment agent.

In a case where the specific silane compound is a compound represented by formula (C), the number of Si atoms means the number of Si atoms contained in group H_{C}. In a case where the specific silane compound is a compound represented by formula (E), the number of Si atoms means the number of Si atoms contained in (B¹¹)ᵤ₁.

In a case where the specific silane compound is a compound represented by formula (C), the number of atoms of the linking group means the number of atoms contained in the main chain of A¹¹. In a case where the specific silane compound is a compound represented by formula (E), the number of atoms of the linking group means the number of atoms contained in the main chain of A¹³.

TABLE 1

| | | | | | | Evaluation | | | Specific silane compound | | |
|---|---|---|---|---|---|---|---|---|---|---|---|
| | | | | | | | Initial | | | | Number |
| | | | | | | Si-Ka | water | | | | of atoms |
| | Surface | Underlayer | | | | line | contact | Number | | Number | in |
| | treatment | Compound | Compound | Ratio | Ratio | intensity | angle | of rubs | | of Si | linking |
| Example | agent | A | B | A | B | (kcps) | (degree) | (times) | Formula | atoms | group |
| 1 | Compound | TEOS | BTM | 0.5 | 0.1 | 3.4 | 105 | 180 | (C) | 60 | 2 |
| | 11 | | | | | | | | | | |
| 2 | Compound | TEOS | BTM | 0.5 | 0.08 | 3.7 | 105 | 250 | (C) | 60 | 2 |
| | 11 | | | | | | | | | | |
| 3 | Compound | TEOS | BTM | 0.5 | 0.05 | 4.0 | 105 | 330 | (C) | 60 | 2 |
| | 11 | | | | | | | | | | |
| 4 | Compound | TEOS | BTM | 0.5 | 0.03 | 3.8 | 105 | 290 | (C) | 60 | 2 |
| | 11 | | | | | | | | | | |
| 5 | Compound | TEOS | BTM | 0.5 | 0.01 | 3.6 | 105 | 220 | (C) | 60 | 2 |
| | 11 | | | | | | | | | | |
| 6 | Compound | TEOS | BTM | 0.5 | 0.005 | 3.1 | 105 | 120 | (C) | 60 | 2 |
| | 11 | | | | | | | | | | |
| 7 | Compound | TEOS | BTE | 1 | 0.1 | 3.0 | 105 | 100 | (C) | 60 | 2 |
| | 11 | | | | | | | | | | |
| 8 | Compound | TEOS | BTE | 1 | 0.08 | 3.1 | 105 | 120 | (C) | 60 | 2 |
| | 11 | | | | | | | | | | |
| 9 | Compound | TEOS | BTE | 1 | 0.05 | 3.3 | 105 | 160 | (C) | 60 | 2 |
| | 11 | | | | | | | | | | |
| 10 | Compound | TEOS | BTE | 1 | 0.03 | 3.6 | 105 | 200 | (C) | 60 | 2 |
| | 11 | | | | | | | | | | |
| 11 | Compound | TEOS | BTE | 1 | 0.01 | 3.3 | 105 | 150 | (C) | 60 | 2 |
| | 11 | | | | | | | | | | |
| 12 | Compound | TEOS | BTE | 1 | 0.005 | 3.0 | 105 | 100 | (C) | 60 | 2 |
| | 11 | | | | | | | | | | |
| 13 | Compound | TEOS | MTMS | 1 | 0.1 | 2.9 | 105 | 80 | (C) | 60 | 2 |
| | 11 | | | | | | | | | | |
| 14 | Compound | TEOS | MTMS | 1 | 0.08 | 3.0 | 105 | 100 | (C) | 60 | 2 |
| | 11 | | | | | | | | | | |
| 15 | Compound | TEOS | MTMS | 1 | 0.05 | 3.4 | 105 | 180 | (C) | 60 | ? |
| | 11 | | | | | | | | | | |
| 16 | Compound | TEOS | MTMS | 1 | 0.03 | 3.6 | 105 | 220 | (C) | 60 | 2 |
| | 11 | | | | | | | | | | |
| 17 | Compound | TEOS | MTMS | 1 | 0.01 | 3.3 | 105 | 160 | (C) | 60 | 2 |
| | 11 | | | | | | | | | | |
| 18 | Compound | TEOS | MTMS | 1 | 0.005 | 3.0 | 105 | 90 | (C) | 60 | 2 |
| | 11 | | | | | | | | | | |
| 19 | Compound | IS | MIS | 1 | 0.1 | 2.9 | 105 | 80 | (C) | 60 | 2 |
| | 11 | | | | | | | | | | |
| 20 | Compound | IS | MIS | 1 | 0.08 | 3.0 | 105 | 100 | (C) | 60 | 2 |
| | 11 | | | | | | | | | | |
| 21 | Compound | IS | MIS | 1 | 0.05 | 3.3 | 105 | 150 | (C) | 60 | 2 |
| | 11 | | | | | | | | | | |
| 22 | Compound | IS | MIS | 1 | 0.03 | 3.4 | 105 | 180 | (C) | 60 | 2 |
| | 11 | | | | | | | | | | |
| 23 | Compound | IS | MIS | 1 | 0.01 | 3.1 | 105 | 120 | (C) | 60 | 2 |
| | 11 | | | | | | | | | | |
| 24 | Compound | IS | — | 1 | 0.005 | 3.0 | 105 | 90 | (C) | 60 | 2 |
| | 11 | | | | | | | | | | |
| 25 | Compound | TEOS | — | — | 0 | 2.0 | 104 | 60 | (C) | 60 | 2 |
| | 11 | | | | | | | | | | |
| 26 | Compound | IS | MIS | — | 0 | 2.0 | 104 | 60 | (C) | 60 | 2 |
| | 11 | | | | | | | | | | |
| 27 | Compound | IS | MIS | 1 | 0.2 | 1.9 | 104 | 50 | (C) | 60 | 2 |
| | 11 | | | | | | | | | | |
| 28 | Compound | TEOS | BTM | 0.5 | 0.2 | 2.0 | 104 | 60 | (C) | 60 | 2 |
| | 11 | | | | | | | | | | |
| 29 | Compound | TEOS | BTE | 1 | 0.2 | 1.9 | 104 | 50 | (C) | 60 | 2 |
| | 11 | | | | | | | | | | |
| 30 | Compound | TEOS | MTMS | 1 | 0.2 | 1.9 | 104 | 50 | (C) | 60 | 2 |
| | 11 | | | | | | | | | | |
| 31 | Compound | TEOS | BTM | 0.5 | 0.001 | 2.1 | 104 | 60 | (C) | 60 | 2 |
| | 11 | | | | | | | | | | |

TABLE 2

| | | | | | | Evaluation | | | Specific silane compound | | |
|---|---|---|---|---|---|---|---|---|---|---|---|
| | | | | | | | Initial | | | | Number |
| | | | | | | Si-Ka | water | | | | of atoms |
| | Surface | Underlayer | | | | line | contact | Number | | Number | in |
| | treatment | Compound | Compound | Ratio | Ratio | intensity | angle | of rubs | | of Si | linking |
| Example | agent | A | B | A | B | (kcps) | (degree) | (times) | Formula | atoms | group |
| 32 | Compound | TEOS | BTM | 0.5 | 0.05 | 3.0 | 104 | 300 | (C) | 21 | 17 |
| | 12 | | | | | | | | | | |
| 33 | Compound | TEOS | BTM | 0.5 | 0.05 | 2.3 | 103 | 250 | (C) | 33 | 4 |
| | 13 | | | | | | | | | | |
| 34 | Compound | — | — | — | — | 1.5 | 103 | 33 | (C) | 60 | 2 |
| | 11 | | | | | | | | | | |
| 35 | Compound | Vapor- | — | — | — | 1.6 | 103 | 35 | (C) | 60 | 2 |
| | 11 | deposited | | | | | | | | | |
| | | silica | | | | | | | | | |
| 36 | Compound | TEOS | BTM | 0.5 | 0.1 | 2.1 | 105 | 170 | (C) | 28 | 0 |
| | 14 | | | | | | | | | | |
| 37 | Compound | TEOS | BTM | 0.5 | 0.08 | 2.2 | 105 | 240 | (C) | 28 | 0 |
| | 14 | | | | | | | | | | |
| 38 | Compound | TEOS | BTM | 0.5 | 0.05 | 2.3 | 105 | 280 | (C) | 28 | 0 |
| | 14 | | | | | | | | | | |
| 39 | Compound | TEOS | BTM | 0.5 | 0.03 | 2.2 | 105 | 250 | (C) | 28 | 0 |
| | 14 | | | | | | | | | | |
| 40 | Compound | TEOS | BTM | 0.5 | 0.01 | 2.0 | 105 | 200 | (C) | 28 | 0 |
| | 14 | | | | | | | | | | |
| 41 | Compound | TEOS | BTM | 0.5 | 0.005 | 1.9 | 104 | 110 | (C) | 28 | 0 |
| | 14 | | | | | | | | | | |
| 42 | Compound | TEOS | BTM | 0.5 | 0.1 | 2.1 | 105 | 100 | (C) | 15 | 12 |
| | 15 | | | | | | | | | | |
| 43 | Compound | TEOS | BTM | 0.5 | 0.08 | 2.2 | 105 | 110 | (C) | 15 | 12 |
| | 15 | | | | | | | | | | |
| 44 | Compound | TEOS | BTM | 0.5 | 0.05 | 2.3 | 105 | 120 | (C) | 15 | 12 |
| | 15 | | | | | | | | | | |
| 45 | Compound | TEOS | BTM | 0.5 | 0.03 | 2.2 | 105 | 110 | (C) | 15 | 12 |
| | 15 | | | | | | | | | | |
| 46 | Compound | TEOS | BTM | 0.5 | 0.01 | 2.0 | 105 | 100 | (C) | 15 | 12 |
| | 15 | | | | | | | | | | |
| 47 | Compound | TEOS | BTM | 0.5 | 0.005 | 1.9 | 104 | 90 | (C) | 15 | 12 |
| | 15 | | | | | | | | | | |
| 48 | Compound | TEOS | BTM | 0.5 | 0.1 | 2.1 | 105 | 160 | (C) | 30 | 12 |
| | 16 | | | | | | | | | | |
| 49 | Compound | TEOS | BTM | 0.5 | 0.08 | 2.2 | 105 | 230 | (C) | 30 | 12 |
| | 16 | | | | | | | | | | |
| 50 | Compound | TEOS | BTM | 0.5 | 0.05 | 2.3 | 105 | 250 | (C) | 30 | 12 |
| | 16 | | | | | | | | | | |
| 51 | Compound | TEOS | BTM | 0.5 | 0.03 | 2.2 | 105 | 240 | (C) | 30 | 12 |
| | 16 | | | | | | | | | | |
| 52 | Compound | TEOS | BTM | 0.5 | 0.01 | 2.0 | 105 | 190 | (C) | 30 | 12 |
| | 16 | | | | | | | | | | |
| 53 | Compound | TEOS | BTM | 0.5 | 0.005 | 1.9 | 105 | 100 | (C) | 30 | 12 |
| | 16 | | | | | | | | | | |
| 54 | Compound | TEOS | BTM | 0.5 | 0.1 | 3.6 | 104 | 110 | (C) | 60 | 27 |
| | 16 | | | | | | | | | | |
| 55 | Compound | TEOS | BTM | 0.5 | 0.08 | 3.6 | 105 | 110 | (C) | 60 | 27 |
| | 18 | | | | | | | | | | |
| 56 | Compound | TEOS | BTM | 0.5 | 0.05 | 3.9 | 105 | 120 | (C) | 60 | 27 |
| | 18 | | | | | | | | | | |
| 57 | Compound | TEOS | BTM | 0.5 | 0.03 | 3.7 | 105 | 110 | (C) | 60 | 27 |
| | 18 | | | | | | | | | | |
| 58 | Compound | TEOS | BTM | 0.5 | 0.01 | 3.5 | 105 | 100 | (C) | 60 | 27 |
| | 18 | | | | | | | | | | |
| 59 | Compound | TEOS | BTM | 0.5 | 0.005 | 3.0 | 105 | 90 | (C) | 60 | 27 |
| | 18 | | | | | | | | | | |

TABLE 3

| | | | Evaluation | | | Specific silane compound | | |
|---|---|---|---|---|---|---|---|---|
| | | | | Initial | | | | Number |
| | | | Si-Ka | water | | | | of |
| | Surface | | line | contact | Number | | Number | atoms in |
| | treatment | Underlayer | intensity | angle | of rubs | | of Si | linking |
| Example | agent | Compound A | (kcps) | (degree) | (times) | Formula | atoms | group |
| 60 | Compound 17 | TEOS | — | 105 | 1,000 | (C) | 15 | 21 |
| 61 | Compound 17 | IS | — | 105 | 800 | (C) | 15 | 21 |
| 62 | Compound 19 | TEOS | — | 105 | 1,000 | (C) | 13 | 21 |
| 63 | Compound 19 | IS | — | 105 | 800 | (C) | 13 | 21 |
| 64 | Compound 20 | TEOS | — | 105 | 1,500 | (E) | 3 | 23 |
| 65 | Compound 20 | IS | — | 105 | 1,000 | (E) | 3 | 23 |
| 66 | Compound 21 | TEOS | — | 105 | 1,500 | (E) | 3 | 29 |
| 67 | Compound 21 | IS | — | 105 | 1,000 | (E) | 3 | 29 |
| 68 | Compound 22 | TEOS | — | 105 | 1,500 | (E) | 2 | 36 |
| 69 | Compound 22 | IS | — | 105 | 1,000 | (E) | 2 | 36 |
| 70 | Compound 23 | TEOS | — | 105 | 1,500 | (E) | 2 | 29 |
| 71 | Compound 23 | IS | — | 105 | 1,000 | (E) | 2 | 29 |
| 72 | Compound 24 | TEOS | — | 105 | 1,500 | (E) | 2 | 15 |
| 73 | Compound 24 | IS | — | 105 | 1,000 | (E) | 2 | 15 |
| 74 | Compound 15 | TEOS | — | 105 | 200 | (C) | 15 | 12 |
| 75 | Compound 15 | IS | — | 105 | 180 | (C) | 15 | 12 |
| 76 | Compound 25 | TEOS | — | 105 | 120 | (C) | 60 | 27 |
| 77 | Compound 25 | IS | — | 105 | 110 | (C) | 60 | 27 |
| 25 | Compound 11 | TEOS | 2.0 | 104 | 60 | (C) | 60 | 2 |
| 26 | Compound 11 | IS | 2.0 | 104 | 60 | (C) | 60 | 2 |
| 35 | Compound 11 | Vapor- | 1.6 | 103 | 35 | (C) | 60 | 2 |
| | | deposited silica | | | | | | |

As shown in Tables 1 to 3, the articles of Cases 1 to 33, and 36 to 77 were found to be superior to the articles of Cases 34 and 35, in terms of abrasion resistance.

In particular, Cases 2 to 4 were found to demonstrate high Si-Ka intensity, and more excellent abrasion resistance.

### INDUSTRIAL APPLICABILITY

The optical article of the present disclosure is excellent in abrasion resistance. Examples of the optical article include display devices such as touch panel display, and optical element. For example, the optical article is applicable to optical components such as car navigation, mobile phone, smartphone, digital camera, digital video camera, PDA, portable audio player, car audio, game machine, medical instrument including stomach camera, copying machine, PC, display (for example, liquid crystal display, organic EL display, plasma display, or touch panel display), touch panel, protective film, and antireflection film.

### (Supplement)

The present disclosure includes the following aspects.

<1>

An optical article that includes a base, an underlayer, and a surface treatment layer arranged in this order,
wherein the underlayer is a layer formed with use of an underlayer forming composition that contains a silane compound other than silica, and
the surface treatment layer is a layer formed with use of a surface treatment agent that contains a compound having a chain organo(poly)siloxane residue and a reactive silyl group.
   <2>

The optical article according to <1>, wherein the silane compound contains at least one compound A selected from the group consisting of a compound represented by formula (1A¹) below, and a compound having a structure represented by formula (1A²) below:

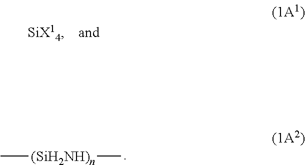

In formula (1A¹), each X¹ independently represents alkoxy group, isocyanato group, halogen atom, carboxy group, or hydroxy group.

In formula (1A²), n represents an integer with which the compound will have a number average molecular weight of from 3,000 to 100,000.

<3>

The optical article according to <2>, wherein the silane compound further contains
at least one species selected from the group consisting of a compound represented by formula (2B¹) below, a compound represented by formula (2B²) below, a compound represented by formula (2C¹) below, a compound represented by formula (2C²) below, and a compound having a structure represented by formula (2D) below:

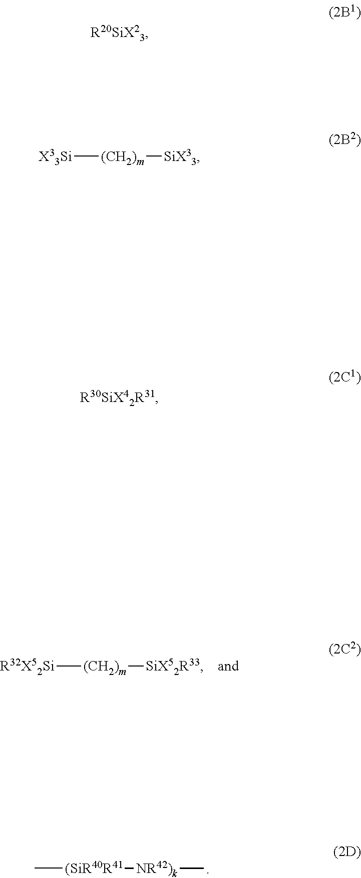

In formulae (2B¹), (2B²), (2C¹), (2C²), and (2D),
each of R²⁰, R³⁰, R³¹, R³², R³³, R⁴⁰, and R⁴¹ independently represents an alkyl group;
each R⁴² independently represents a hydrogen atom or an alkyl group;
each of X², X³, X⁴, and X⁵ independently represents alkoxy group, isocyanato group, halogen atom, carboxy group, or hydroxy group; and
each m independently represents an integer of 1 or larger.

In formula (2D), k represents an integer with which the compound will have a number average molecular weight of from 3,000 to 100,000.

<4>

The optical article according to 3>, wherein the silane compound contains the compound A, as well as, at least one compound B selected from the group consisting of the compound represented by formula (2B¹), and the compound represented by formula (2B²), and
the compound B has a ratio of the number of carbon atoms contained in the alkyl group or in an alkylene chain, with respect to the number of silicon atoms, of 1 or less.
   <5>

The optical article according to <4>, wherein a ratio of the number of carbon atoms contained in the alkyl group or in the alkylene chain in the compound B, with respect to the total number of silicon atoms in the compound A and the compound B, is from 0.005 to 0.1.

<6>

The optical article according to any one of <1> to <5>, wherein the base is glass.

<7>

The optical article according to any one of <1> to <6>, being a display or a touch panel.

<8>

An underlayer forming composition that contains a silane compound other than silica, used for forming an underlayer, in an optical article that includes a base, the underlayer, and a surface treatment layer that contains a compound having a chain organo(poly)siloxane residue and a reactive silyl group, arranged in this order.

<9>

The underlayer forming composition according to <8>, wherein the silane compound contains at least one compound A selected from the group consisting of a compound represented by formula (1A¹) below, and a compound having a structure represented by formula (1A²) below:

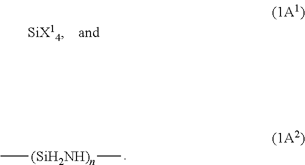

In formula (1A¹), each X¹ independently represents alkoxy group, isocyanato group, halogen atom, carboxy group, or hydroxy group.

In formula (1A²), n represents an integer with which the compound will have a number average molecular weight of from 3,000 to 100,000.

<10>

The underlayer forming composition according to <9>, wherein the silane compound further contains at least one species selected from the group consisting of a compound represented by formula (2B¹) below, a compound represented by formula (2B²) below, a compound represented by formula (2C¹) below, a compound represented by formula (2C²) below, and a compound having a structure represented by formula (2D) below

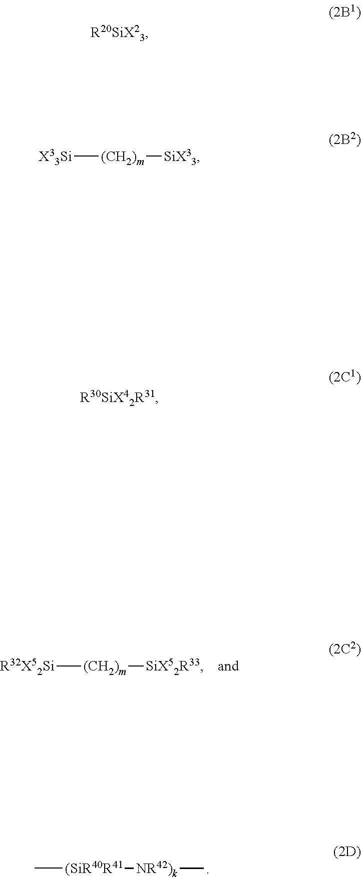

In formulae (2B¹), (2B²), (2C¹), (2C²), and (2D),
each of R²⁰, R³⁰, R³¹, R³², R³³, R⁴⁰, and R⁴¹ independently represents an alkyl group;
each R⁴² independently represents a hydrogen atom or an alkyl group;
each of X², X³, X⁴, and X⁵ independently represents alkoxy group, isocyanato group, halogen atom, carboxy group, or hydroxy group; and
each m independently represents an integer of 1 or larger.

In formula (2D), k represents an integer with which the compound will have an average molar mass of from 3,000 to 100,000.

<11>

The underlayer forming composition according to <10>, wherein the silane compound contains the compound A, as well as, at least one compound B selected from the group consisting of the compound represented by formula (2B¹), and the compound represented by formula (2B²) below, and
the compound B has a ratio of the number of carbon atoms contained in the alkyl group or in an alkylene chain, with respect to the number of silicon atoms, of 1 or less.
   <12>

The underlayer forming composition according to <11>, wherein a ratio of the number of carbon atoms contained in the alkyl group or in the alkylene chain in the compound B, with respect to the total number of silicon atoms in the compound A and the compound B, is from 0.005 to 0.1.

<13>

A surface treatment set that includes an underlayer forming composition used for forming an underlayer, and a surface treatment agent used for forming a surface treatment layer, in an optical article having a base, the underlayer, and the surface treatment layer arranged in this order,
the underlayer forming composition contains a silane compound other than silica, and
the surface treatment agent contains a compound having a chain organo(poly)siloxane residue and a reactive silyl group.
   <14>

The surface treatment set according to <13>, wherein the silane compound contains at least one compound A selected from the group consisting of a compound represented by formula (1A¹) below, and a compound having a structure represented by formula (1A²) below:

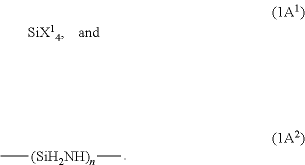

In formula (1A¹), each X¹ independently represents alkoxy group, isocyanato group, halogen atom, carboxy group, or hydroxy group.

In formula (1A²), n represents an integer with which the compound will have an average molar mass of from 3,000 to 100,000.

<15>

The surface treatment set according to <14>, wherein the silane compound further contains at least one species selected from the group consisting of a compound represented by formula (2B¹) below, a compound represented by formula (2B²) below, a compound represented by formula (2C¹) below, a compound represented by formula (2C²) below, and a compound having a structure represented by formula (2D) below:

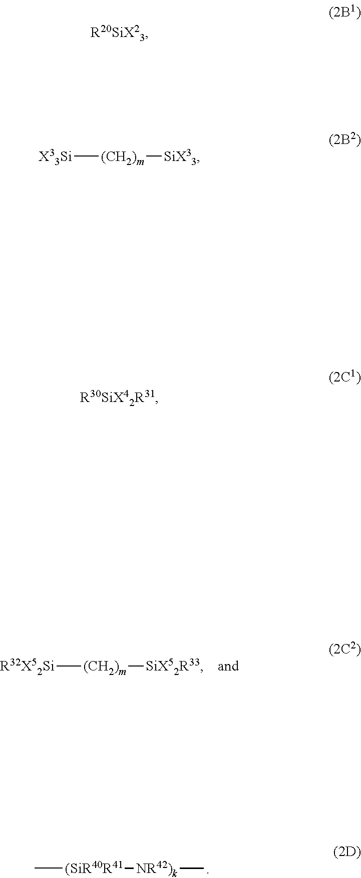

In formulae (2B¹), (2B²), (2C¹), (2C²), and (2D), each of R²⁰, R³⁰, R³¹, R³², R³³, R⁴⁰, and R⁴¹ independently represents an alkyl group;
each R⁴² independently represents a hydrogen atom or an alkyl group;
each of X², X³, X⁴, and X⁵ independently represents alkoxy group, isocyanato group, halogen atom, carboxy group, or hydroxy group; and
each m independently represents an integer of 1 or larger.

In formula (2D), k represents an integer with which the compound will have an average molar mass of from 3,000 to 100,000.

<16>

The surface treatment set according to <14> or <15>, wherein the silane compound contains the compound A, as well as, at least one compound B selected from the group consisting of the compound represented by formula (2B¹), and the compound represented by formula (2B²), and
the compound B has a ratio of the number of carbon atoms contained in the alkyl group or in an alkylene chain, with respect to the number of silicon atoms, of 1 or less.
   <17>

The surface treatment set according to <16>, wherein a ratio of the number of carbon atoms contained in the alkyl group or in the alkylene chain in the compound B, with respect to the total number of silicon atoms in the compound A and the compound B, is from 0.005 to 0.1.

The disclosure of Japanese Patent Application No. 2023-174763 filed on Oct. 6, 2023 is incorporated herein by reference in its entirety. All documents, patent applications, and technical standards described in this specification are incorporated herein by reference to the same extent as if each document, patent application, and technical standard were specifically and individually indicated to be incorporated by reference.

1. An optical article, comprising a base, an underlayer, and a surface treatment layer arranged in this order,
the underlayer being a layer formed of an underlayer forming composition that contains a silane compound other than silica, and
the surface treatment layer being a layer formed of a surface treatment agent that contains a compound having a chain group and a reactive silyl group.

2. The optical article according to claim 1, wherein the compound having a chain group and a reactive silyl group is a compound having a chain organo(poly)siloxane residue and a reactive silyl group.

3. The optical article according to claim 1, wherein the silane compound contains at least one compound A selected from the group consisting of a compound represented by the following formula (1A¹), and a compound having a structure represented by the following formula (1A²): 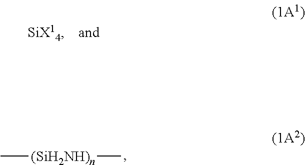
wherein, in formula (1A¹), each X¹ independently represents an alkoxy group, an isocyanato group, a halogen atom, a carboxy group, or a hydroxy group, and
in formula (1A²), n represents an integer with which the compound will have a number average molecular weight of from 3,000 to 100,000.

4. The optical article according to claim 3, wherein the silane compound further contains
at least one compound selected from the group consisting of a compound represented by the following formula (2B¹), a compound represented by the following formula (2B²) below, a compound represented by the following formula (2C¹), a compound represented by the following formula (2C²), and a compound having a structure represented by the following formula (2D): 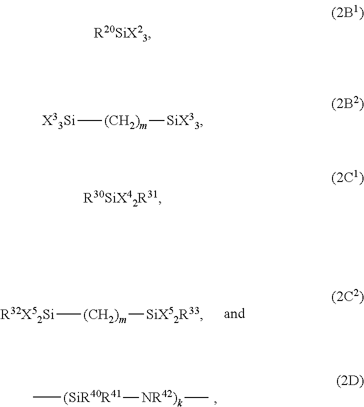
wherein, in formulae (2B¹), (2B²), (2C¹), (2C²), and (2D),
each of R²⁰, R³⁰, R³¹, R³², R³³, R⁴⁰, and R⁴¹ independently represents an alkyl group;
each R⁴² independently represents a hydrogen atom or an alkyl group;
each of X², X³, X⁴, and X⁵ independently represents an alkoxy group, an isocyanato group, a halogen atom, a carboxy group, or a hydroxy group;
each m independently represents an integer of 1 or larger; and
k in formula (2D) represents an integer with which the compound will have a number average molecular weight of from 3,000 to 100,000.

5. The optical article according to claim 4, wherein:
the silane compound contains the compound A, and at least one compound B selected from the group consisting of the compound represented by formula (2B¹) and the compound represented by formula (2B²), and
the compound B has a ratio of a number of carbon atoms contained in the alkyl group or in an alkylene chain, with respect to a number of silicon atoms, of 1 or less.

6. The optical article according to claim 5, wherein a ratio of the number of carbon atoms contained in the alkyl group or in the alkylene chain in the compound B, with respect to a total number of silicon atoms in the compound A and the compound B, is from 0.005 to 0.1.

7. The optical article according to claim 1, wherein the base is glass.

8. The optical article according to claim 1, being a display or a touch panel.

9. An underlayer forming composition, comprising a silane compound other than silica, the composition being used for forming an underlayer in an optical article that comprises a base, the underlayer, and a surface treatment layer that contains a compound having a chain group and a reactive silyl group, arranged in this order.

10. The underlayer forming composition according to claim 9, wherein the compound having a chain group and a reactive silyl group is a compound having a chain organo(poly)siloxane residue and a reactive silyl group.

11. The underlayer forming composition according to claim 9, wherein the silane compound contains at least one compound A selected from the group consisting of a compound represented by the following formula (1A¹), and a compound having a structure represented by the following formula (1A²): 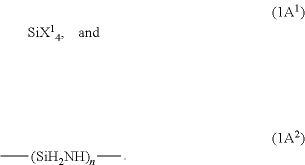
wherein, in formula (1A¹), each X¹ independently represents an alkoxy group, an isocyanato group, a halogen atom, a carboxy group, or a hydroxy group, and
in formula (1A²), n represents an integer with which the compound will have a number average molecular weight of from 3,000 to 100,000.

12. The underlayer forming composition according to claim 11, wherein the silane compound further contains at least one compound selected from the group consisting of a compound represented by the following formula (2B¹), a compound represented by the following formula (2B²), a compound represented by the following formula (2C¹), a compound represented by the following formula (2C²), and a compound having a structure represented by the following formula (2D): 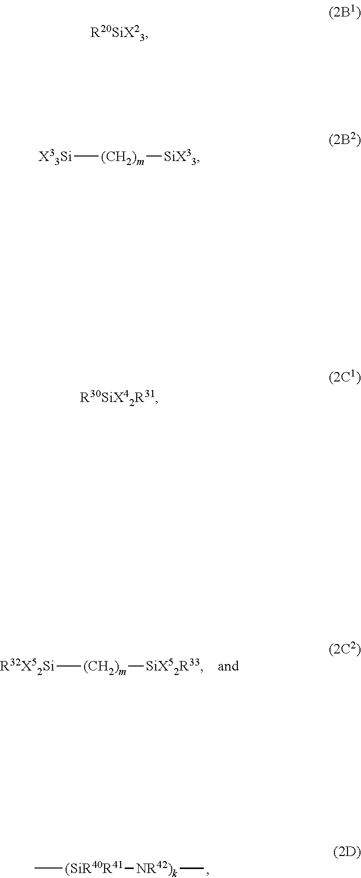
wherein, in formulae (2B¹), (2B²), (2C¹), (2C²), and (2D),
each of R²⁰, R³⁰, R³¹, R³², R³³, R⁴⁰, and R⁴¹ independently represents an alkyl group;
each R⁴² independently represents a hydrogen atom or an alkyl group;
each of X², X³, X⁴, and X⁵ independently represents an alkoxy group, an isocyanato group, a halogen atom, a carboxy group, or a hydroxy group;
each m independently represents an integer of 1 or larger; and
k in formula (2D) represents an integer with which the compound will have an average molar mass of from 3,000 to 100,000.

13. The underlayer forming composition according to claim 12, wherein:
the silane compound contains the compound A, and at least one compound B selected from the group consisting of the compound represented by formula (2B¹) and the compound represented by formula (2B²), and
the compound B has a ratio of a number of carbon atoms contained in the alkyl group or in an alkylene chain, with respect to a number of silicon atoms, of 1 or less.

14. The underlayer forming composition according to claim 13, wherein a ratio of the number of carbon atoms contained in the alkyl group or in the alkylene chain in the compound B, with respect to a total number of silicon atoms in the compound A and the compound B, is from 0.005 to 0.1.

15. A surface treatment set, comprising an underlayer forming composition used for forming an underlayer, and a surface treatment agent used for forming a surface treatment layer, in an optical article having a base, the underlayer, and the surface treatment layer arranged in this order,
the underlayer forming composition comprising a silane compound other than silica, and
the surface treatment agent comprising a compound having a chain group and a reactive silyl group.

16. The surface treatment set according to claim 15, wherein the compound having a chain group and a reactive silyl group is a compound having a chain organo(poly)siloxane residue and a reactive silyl group.

17. The surface treatment set according to claim 15, wherein the silane compound contains at least one compound A selected from the group consisting of a compound represented by the following formula (1A¹), and a compound having a structure represented by the following formula (1A²): 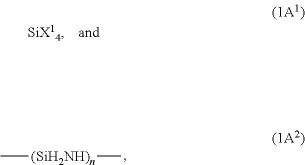
wherein, in formula (1A¹), each X¹ independently represents an alkoxy group, an isocyanato group, a halogen atom, a carboxy group, or a hydroxy group, and
in formula (1A²), n represents an integer with which the compound will have an average molar mass of from 3,000 to 100,000.

18. The surface treatment set according to claim 17, wherein the silane compound further contains at least one compound selected from the group consisting of a compound represented by the following formula (2B¹), a compound represented by the following formula (2B²), a compound represented by the following formula (2C¹), a compound represented by the following formula (2C²), and a compound having a structure represented by the following formula (2D): 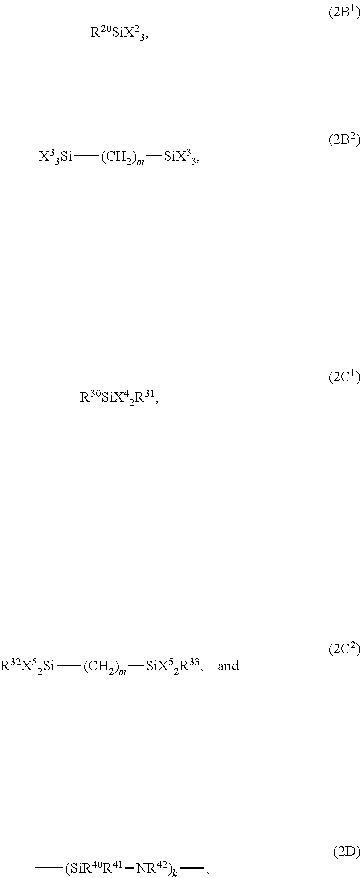
wherein, in formulae (2B¹), (2B²), (2C¹), (2C²), and (2D),
each of R²⁰, R³⁰, R³¹, R³², R³³, R⁴⁰, and R⁴¹ independently represents an alkyl group;
each R⁴² independently represents a hydrogen atom or an alkyl group;
each of X², X³, X⁴, and X⁵ independently represents an alkoxy group, an isocyanato group, a halogen atom, a carboxy group, or a hydroxy group;
each m independently represents an integer of 1 or larger; and
k in formula (2D) represents an integer with which the compound will have an average molar mass of from 3,000 to 100,000.

19. The surface treatment set according to claim 18, wherein:
the silane compound contains the compound A, and at least one compound B selected from the group consisting of the compound represented by formula (2B¹) and the compound represented by formula (2B²), and
the compound B has a ratio of a number of carbon atoms contained in the alkyl group or in an alkylene chain, with respect to a number of silicon atoms, of 1 or less.

20. The surface treatment set according to claim 19, wherein a ratio of the number of carbon atoms contained in the alkyl group or in the alkylene chain in the compound B, with respect to a total number of silicon atoms in the compound A and the compound B, is from 0.005 to 0.1.
